(19) United States
(12) Patent Application Publication
(10) Pub. No.: US 2021/0198148 A1
(43) Pub. Date: Jul. 1, 2021

(54) COMPOSITE GYPSUM BOARD FORMED FROM HIGH-SALT STUCCO AND RELATED METHODS

(71) Applicant: United States Gypsum Company, Chicago, IL (US)

(72) Inventors: Qinghua Li, Rolling Meadows, IL (US); Mark K. Hemphill, Hawthorn Woods, IL (US); Brian J. Christ, Burlington, IA (US); Curtis B. Loring, Chicago, IL (US)

(73) Assignee: United States Gypsum Company, Chicago, IL (US)

(21) Appl. No.: 16/904,779

(22) Filed: Jun. 18, 2020

Related U.S. Application Data
(60) Provisional application No. 62/953,764, filed on Dec. 26, 2019.

(51) Int. Cl. C04B 28/14; B32B 13/08; B32B 43/00; B32B 38/00

(52) U.S. Cl. CPC C04B 28/14; B32B 13/08; C04B 2111/0062; B32B 38/0036; B32B 43/003

(57) ABSTRACT

Disclosed are a composite gypsum board and a method of preparing gypsum board. The board contains at least one set gypsum layer sandwiched between face and back cover sheets. The set gypsum layer is formed from at least stucco and water. The stucco material generally includes a high salt impurity content, for example, when the stucco is calcined from certain sources of low-quality synthetic gypsum. For example, in some embodiments, the salts are chloride salts, e.g., sodium chloride (NaCl), potassium chloride (KCl), magnesium chloride (MgCl₂), and/or calcium chloride (CaCl₂). The board and methods improve the bond between the gypsum layer(s) and at least one of the cover sheets (e.g., the back cover sheet). Also provided are methods and systems relating to drying gypsum board.

### CROSS-REFERENCE TO RELATED APPLICATION

This patent application claims the benefit of priority to U.S. Provisional Patent Application No. 62/953,764, filed on Dec. 26, 2019, and entitled, “Composite Gypsum Board Formed from High-Salt Stucco and Related Methods,” which is incorporated by reference in its entirety herein.

### BACKGROUND OF THE INVENTION

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum in the form of calcium sulfate hemihydrate and/or calcium sulfate anhydrite) and then rehydrated to form set gypsum in a desired shape (e.g., as a board). During manufacture of the board, the stucco, water, and other ingredients as appropriate are mixed in a mixer. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

Gypsum (calcium sulfate dihydrate and any impurities) suitable for use in wallboard may be obtained from both natural sources and synthetic sources, followed by further processing.

Natural gypsum may be used by calcining its calcium sulfate dihydrate to produce the hemihydrate form. Gypsum from natural sources is a naturally occurring mineral and can be mined in rock form. Naturally occurring Gypsum is a mineral that is typically found in old salt-lake beds, volcanic deposits, and clay beds. When it is mined, raw gypsum is generally found in the dihydrate form Gypsum is also known as calcium sulfate dihydrate, terra alba or landplaster. This material is also produced as a by-product in various industrial processes. For example, synthetic gypsum is a byproduct of flue gas desulfurization processes from power plants. In gypsum, there are approximately two molecules of water associated with each molecule of calcium sulfate.

Plaster of Paris is also known as calcined gypsum, stucco, calcium sulfate hemihydrate, calcium sulfate half-hydrate or calcium sulfate hemihydrate.

When calcium sulfate dihydrate from either source is heated sufficiently, in a process called calcining or calcination, the water of hydration is at least partially driven off and there can be formed either calcium sulfate hemihydrate (CaSO₄.½H₂O) (typically provided in the material commonly referred to as “stucco”) or calcium sulfate anhydrite (CaSO₄) depending on the temperature and duration of exposure. As used herein, the terms “stucco” and “calcined gypsum” refer to both the hemihydrate and anhydrite forms of calcium sulfate that may be contained therein. Calcination of the gypsum to produce the hemihydrate form takes place by the following equation:

CaSO₄.2H₂O→CaSO₄.0.5H₂O+1.5H₂O

Calcined gypsum is capable of reacting with water to form calcium sulfate dihydrate, which is a rigid product and is referred to herein as “set gypsum.”

Gypsum may also be obtained synthetically (referred to as “syngyp” in the art) as a by-product of industrial processes such as flue gas desulfurization from power plants, for example. Natural or synthetic gypsum can be calcined at high temperatures, typically above 150° C., to form stucco (i.e., calcined gypsum in the form of calcium sulfate hemihydrate and/or calcium sulfate anhydrite), which may undergo subsequent rehydration to form set gypsum in a desired shape, such as a board.

Synthetic gypsum obtained from power plants is usually suitable for use in gypsum panels intended for construction projects. Synthetic gypsum is a byproduct of flue gas desulfurization processes from power plants (also known as desulphurisation gypsum or desulphogyspum or DSG). In particular, flue gas including sulfur dioxide is wet scrubbed with lime or limestone, which produces calcium sulfite in the following reaction.

CaCO₃+SO₂→CaSO₃+CO₂

The calcium sulfite is then converted to calcium sulfate in the following reaction.

CaSO₃+2H₂O+½O₂→CaSO₄.2H₂O

The hemihydrate form may then be produced by calcination in a similar manner to that used for natural gypsum.

However, many conventional coal-fired power plants are being shut down in favor of more environmentally friendly sources of energy. The shutdown of coal-fired power plants has created a growing shortage of synthetic gypsum suitable for producing gypsum panels. Lower quality synthetic gypsum is available from power plants and other sources, but this alternatively sourced gypsum often contains fairly high concentrations of extraneous salts, particularly magnesium or sodium salts, more particularly magnesium chloride and sodium chloride. Small amounts of potassium chloride and calcium chloride may also be present in alternatively sourced synthetic gypsum. The extraneous salts can be problematic due to their tendency to decrease adhesion between the board core and the cover sheets, particularly a back paper cover sheet.

It will be appreciated that this background description has been created by the inventors to aid the reader, and is neither a reference to prior art nor an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### BRIEF SUMMARY OF THE INVENTION

The invention provides gypsum board that exhibits improved adhesion between a gypsum layer and a cover sheet of the board, as well as related methods and systems. The invention has particular applicability with boards formed from stucco containing a high content of salt impurities. Generally, stucco is formed by calcining gypsum from natural or synthetic sources. In nature, it is a common abundant mineral that can be mined from the earth. The synthetic form of gypsum can be derived as a byproduct from flue gas desulfurization (FGD) processes associated with coal-fired electric power plants that burn high sulfur coals. In the power plants, sulfur dioxide emissions are removed through a wet scrubbing process. A limestone slurry injection results in precipitation of synthetic gypsum following fly ash removal. For example, some forms of synthetic gypsum contain the high content of salt impurities, which then remain in the stucco formed as calcined gypsum. The salt impurities in the synthetic gypsum can result from, for example high salt coals. These salt impurities have been found to deleteriously affect bonding between a cover sheet (e.g., formed from paper) and a gypsum layer (e.g., the board core) in the board.

Thus, in one aspect, the invention provides a gypsum board comprising a set gypsum core disposed between a face cover sheet and a back cover sheet. The set gypsum core is formed from a first slurry comprising water, stucco, and a high salt impurity content, as well as optional ingredients discussed herein. The board comprises at least one (i.e., one, two, three, or four) of the following items (1)-(4). (1) At least one of the cover sheets, preferably at least the back cover sheet, is perforated. (2) At least one of the cover sheets, preferably at least the back cover sheet, is high absorption paper. (3) Starch is provided between the set gypsum core and at least one of the cover sheets, preferably between at least the back cover sheet and the set gypsum core. (4) Skim coat starch is provided. The board core prepared from the first slurry is disposed between the two cover sheets and has first and second faces. The board core can optionally contain board core starch. A back skim coat layer and a face skim coat layer, each of which defines first and second skim coat faces, are provided. The skim coats are formed from second and third slurries, respectively, which slurries can be of the same or different composition. The second and third slurries comprise at least water and stucco. At least one of the second and third slurries contains skim coat starch. The back skim coat layer is disposed in bonding relation to the first core face, and the first face of the face skim coat layer is in bonding relation with the second face of the board core. The second face of the back skim coat layer faces the back cover sheet. The second face of the face skim coat layer faces the face cover sheet. The skim coat starch enhances the bond between the board core and the cover sheet adjacent to the skim coat prepared using skim coat starch, e.g., preferably at least the back skim coat layer.

In another aspect, the invention provides a method of making a gypsum board. At least water and stucco containing a high salt impurity content are mixed to form a first slurry. At least water and stucco are mixed to form second and third slurries, which can be the same or different. The second slurry is applied in a bonding relation to a face cover sheet to form a skim coat layer, the skim coat layer having a first face and a second face, wherein the first face of the skim coat layer faces the face cover sheet. The first slurry is applied in a bonding relation to the skim coat layer to form a board core having a first face and a second face, the first face of the board core facing the second face of the skim coat layer. A back cover sheet is applied in bonding relation to the second face of the board core face to form a board precursor. A third slurry comprising water, the stucco, and the skim coat starch is applied onto a first surface of the back cover sheet to form a second skim coat. When applied over the core, the second skim coat is disposed between the second cover sheet and the board core. The board precursor is dried in a kiln to form a board. The method further comprises at least one (i.e., one, two, three, four, or five) of the following items (1)-(5). (1) At least one of the cover sheets, preferably the back cover sheet is perforated. (2) At least one of the cover sheets, preferably the back cover sheet, is high absorption paper. (3) Starch is applied so that it is disposed between the set gypsum core and at least one of the cover sheets, preferably between at least the back cover sheet and the set gypsum core. (4) Skim coat starch is included in the second and/or third slurries to enhance the bond between the board core and the face and/or back cover sheet respectively. (5) The drying process involves using a kiln that contains at least one in-kiln radio-frequency moisture sensor therein. At least one burner, which can be equipped with a burner output, can be used to provide heat in the kiln. The in-kiln moisture sensor is in communication with a controller outside of the kiln to produce an in-kiln moisture reading. The drying further comprises measuring moisture content in the board upstream of the kiln using an upstream radio-frequency moisture sensor and an upstream sensor that is less influenced by high salt concentration in the slurry (e.g., a microwave sensor) as compared with the radio-frequency moisture sensor. The upstream sensors are in communication with the controller to produce a first upstream moisture reading and a second upstream moisture reading, respectively. The first and second moisture readings from the upstream moisture sensors are correlated. The in-kiln radio-frequency moisture sensor is biased when a delta exists between the first and second moisture readings to correct for any errors in the in-kiln moisture reading (as indicated by the delta between the upstream sensor readings). In some embodiments, the drying further comprises measuring moisture content in the board downstream of the kiln using a downstream radio-frequency moisture sensor and a downstream sensor that is less influenced by high salt concentration in the slurry as compared with the radio-frequency moisture sensor. The downstream radio-frequency sensor and other sensor less influenced by high salt concentration are in communication with the controller to produce a first downstream moisture reading and a second downstream moisture reading, respectively. The downstream moisture readings are correlated. Moisture set points and/or bias can be adjusted (automatically or manually) so that the air flow and/or burner output changes in relationship to any error produced by the radio frequency sensor to result in properly dried board.

In another aspect, the invention provides a method of making a gypsum board. The method comprises mixing at least water, stucco, and foam to form a first slurry. The first slurry is disposed between a face cover sheet and a back cover sheet to form a board precursor. The board precursor is cut into segments. The board in a kiln containing at least one in-kiln radio-frequency moisture sensor therein, the in-kiln moisture sensor in communication with a controller outside of the kiln to produce an in-kiln moisture reading. The moisture content in the board upstream of the kiln is assessed using an upstream radio-frequency moisture sensor and an upstream sensor that is less influenced by high salt concentration in the slurry as compared with the radio-frequency moisture sensor. The upstream sensors are in communication with the controller to produce a first upstream moisture reading and a second upstream moisture reading, respectively. The moisture readings from the upstream radio-frequency moisture sensor and the upstream sensor that is less influenced by high salt concentration in the slurry are correlated as compared with the radio-frequency moisture sensor. The in-kiln radio-frequency moisture sensor(s) are biased when a delta exists between the first and second moisture readings to correct for any errors in the in-kiln moisture reading. In some embodiments, the method further comprises measuring moisture content in the board downstream of the kiln using a downstream radio-frequency moisture sensor and a downstream sensor that is less influenced by high salt concentration in the slurry as compared with the radio-frequency moisture sensor. The downstream radio-frequency and other less influenced by salt sensor are in communication with the controller to produce a first downstream moisture reading and a second downstream moisture reading, respectively. The moisture readings from the downstream radio-frequency moisture sensor and the downstream sensor that is less influenced by high salt concentration in the slurry as compared with the radio-frequency moisture sensor are correlated. The kiln is associated with burner firing rate and/or air flow modification apparatus to adjust for heating in the kiln. The burner firing rate and/or air extraction apparatus are used to adjust the temperature in the kiln to reduce heating therein when there is a delta between the moisture readings of the first downstream moisture sensor and the second downstream moisture sensor.

In another aspect the invention provides a method of drying a board precursor during manufacture of the board. The method comprises providing a board precursor containing a core layer(s) formed from stucco, water, and a high salt impurity content. The board precursor is cut into segments. The segments are dried in a kiln containing at least one in-kiln radio-frequency moisture sensor therein. The in-kiln moisture sensor is in communication with a controller outside of the kiln to produce an in-kiln moisture reading. The moisture content in the board precursor is measured upstream of the kiln using an upstream radio-frequency moisture sensor and an upstream sensor that is less influenced by high salt concentration in the slurry as compared with the radio-frequency moisture sensor. The upstream sensors are in communication with the controller to produce a first upstream moisture reading and a second upstream moisture reading, respectively. The moisture readings from the upstream radio-frequency moisture sensor and the upstream sensor that is less influenced by high salt concentration in the slurry are correlated as compared with the radio-frequency moisture sensor. The in-kiln radio-frequency moisture sensor is biased when a delta exists between the first and second moisture readings to correct for any errors in the in-kiln moisture reading. In some embodiments, the method further comprises measuring moisture content in the board downstream of the kiln using a downstream radio-frequency moisture sensor and a downstream sensor that is less influenced by high salt concentration in the slurry as compared with the radio-frequency moisture sensor. The downstream radio-frequency and sensor less influenced by high salt concentration are in communication with the controller to produce a first downstream moisture reading and a second downstream moisture reading, respectively. The moisture readings from the downstream radio-frequency moisture sensor and the downstream sensor that is less influenced by high salt concentration in the slurry as compared with the radio-frequency moisture sensor are correlated. In some embodiments, a burner output and/or air extraction apparatus associated with the kiln are provided. The burner output and/or air apparatus are used to adjust the temperature in the kiln to reduce heating therein when there is a discrepancy between the two downstream moisture readings.

In another aspect, the invention provides a system for drying a board segment. The system comprises a kiln containing at least one heat source and in-kiln radio-frequency moisture sensor therein. A controller is provided outside of the kiln. An upstream radio-frequency moisture sensor and an upstream sensor that is less influenced by high salt concentration in the slurry as compared with the radio-frequency moisture sensor are provided. The upstream radio-frequency and microwave sensors are in communication with the controller to produce a first upstream moisture reading and a second upstream moisture reading, respectively. In some embodiments, the system further comprises a burner output and/or air extraction apparatus associated with the kiln. The set point and/or air extraction apparatus are in communication with the controller. In some embodiments, the system further comprises a downstream radio-frequency moisture sensor and a downstream sensor that is less influenced by high salt concentration in the slurry as compared with the radio-frequency moisture sensor. The downstream sensors are in communication with the controller to produce a first downstream moisture reading and a second downstream moisture reading, respectively. The burner output and/or air apparatus can be used to adjust the temperature in the kiln to reduce heating therein.

### BRIEF DESCRIPTION OF THE SEVERAL VIEWS OF THE DRAWING(S)

FIG. 1 shows a cross-sectional view of a gypsum board of the invention, in which a board core layer (gypsum core) is sandwiched between a front cover sheet and a back cover sheet, with the back cover sheet comprising a plurality of perforations extending therethrough.

FIG. 2 shows a top (axial) view of the gypsum board of FIG. 1, in which the arrangement of the plurality of perforations in the back cover sheet can be better seen.

FIG. 3 shows a cross-sectional view of a gypsum board of the invention, in which a board core (gypsum core) is sandwiched between a front paper cover sheet and a back cover sheet, at least one of which is coated with a starch layer.

FIG. 4 shows a top (axial) view of the gypsum board of FIG. 3, in which the arrangement of the plurality of perforations in the back cover sheet can be better seen.

FIG. 5 shows a perspective view of a gypsum board of the present invention attached to one side of a metal stud wall suitable in the wall system of the present invention.

FIG. 6A is a schematic illustration (not drawn to scale) of a cross-section of a wallboard with skim coats in accordance with embodiments of the invention.

FIG. 6B is a schematic illustration (not drawn to scale) of a cross-section of a wallboard with a skim coat in accordance with embodiments of the invention.

FIG. 7 is a schematic illustration of aspects of a line showing the drying process in accordance with embodiments of the description.

FIG. 8 shows a perspective view of a gypsum board of the present invention attached to one side of a metal stud wall suitable for use in an illustrative wall system of the present invention.

FIG. 9 shows a photograph of a back cover sheet that has a plurality of perforations extending therethrough.

FIGS. 10-12 show photographs demonstrating the effect of various salts upon adhesion to the board core layer in 12 inch×12 inch×½ inch gypsum boards having and lacking perforations within the back cover sheet.

FIG. 13 shows photographs comparing a board of the present invention having a perforated cover sheet with a board having a non-perforated cover sheet to show the effect of perforation on 12 inch×12 inch×½ inch gypsum board containing 30 ppm Cl⁻ from NaCl per million parts calcium sulfate hemihydrate.

FIG. 14 shows photographs showing the effect of diluted starch solution on 12 inch×12 inch×½ inch gypsum board containing 1200 ppm Cl⁻ from MgCl₂ per million parts calcium sulfate hemihydrate.

FIG. 15 shows photographs showing the effect of diluted starch solution on 12 inch×12 inch×½ inch gypsum board containing 2100 ppm Cl⁻ from MgCl₂ per million parts calcium sulfate hemihydrate.

FIG. 16 shows photographs showing the effect of diluted starch solution and perforation on 12 inch×12 inch×½ inch gypsum board containing 2000 ppm Cl⁻ from NaCl per million parts calcium sulfate hemihydrate.

FIG. 17 shows photographs showing the effect of diluted starch solution on 12 inch×12 inch×½ inch gypsum board containing 30 ppm Cl⁻ from NaCl per million parts calcium sulfate hemihydrate.

FIG. 18 are photographs of two boards after bond testing as discussed in Example 3.

FIG. 19 are photographs of three boards after bond testing as discussed in Example 3.

FIG. 20 are photographs of three boards after bond testing as discussed in Example 3.

FIG. 21 are photographs of three boards after bond testing as discussed in Example 3.

FIG. 22 are photographs of three boards after bond testing as discussed in Example 4.

FIG. 23 are photographs of three boards after bond testing as discussed in Example 4.

FIGS. 24A and 24B are graphs of percent moisture (x-axis) versus actual percent moisture (y-axis) as discussed in Example 5.

### DETAILED DESCRIPTION OF THE INVENTION

The invention is predicated, at least in part, on enhancing adhesion between a gypsum layer and a cover sheet (e.g., composed of paper). The gypsum board is formed to include gypsum layers disposed between two cover sheets (face and back cover sheets). The gypsum layers generally include a core layer, as well as a skim coat layer between a first major surface of the core and a cover sheet. In some embodiments, there is a second skim coat layer between a second major surface of the core and a second cover sheet opposite to the first cover sheet, which arrangement is understood in the art. Embodiments of the invention are particularly useful for gypsum boards where the set gypsum layer(s) is formed from a stucco slurry containing appreciable quantities of extraneous salts. For example, in some embodiments, the salts are chloride salts, e.g., sodium chloride (NaCl), potassium chloride (KCl), magnesium chloride (MgCl₂), and/or calcium chloride (CaCl₂).

Such salts can be found, for example, in stucco slurries where the stucco is derived from a low quality synthetic gypsum. In this regard, normally, a board manufacturing facility is sourced with gypsum that is then calcined to form stucco. The stucco is then reacted with water to form the gypsum (i.e., calcium sulfate dihydrate) layer of desired dimensions. If the low quality synthetic gypsum contains the appreciable quantities of salt impurities, such salts have been found to remain with the stucco after calcining and hence are present in the stucco slurry. In some embodiments, the stucco slurry comprises high qualities of the salts, e.g., at least about 150 ppm chloride anion per 1,000,000 parts by weight of said calcium sulfate hemihydrate, such as about 150 ppm to about 2000 ppm chloride anion per 1,000,000 parts by weight of said calcium sulfate hemihydrate. The presence of the salt impurities in appreciable amounts has been found to interfere with adhesion between the gypsum layer(s) and the cover sheet(s).

The gypsum layer(s) for the board is prepared by mixing at least stucco, water, and optional additives as desired. The gypsum layer(s) are sandwiched between face and back cover sheets. One or more gypsum layers can form the primary gypsum layers in the form of a board core which has two opposing primary surfaces. Gypsum layers in the form of thin skim coats can be disposed on either primary surface of the core. The sandwich structure is formed as a continuous ribbon at a wet end (near the primary mixer) of a manufacturing line. The continuous ribbon forms a board precursor, which sets at least in part by reaction of water and stucco as it is transported on a conveyor to be cut into segments and then dried in a kiln. Primary gypsum layer(s) form the board core, which is prepared from a first slurry, while the skim coats can be prepared from second and third slurries, which can be the same or different from each other.

To enhance cover sheet-gypsum layer bonding, the invention provides ingredients and techniques for enhancing bond in the presence of high content of salt impurities in the first slurry (and optionally the second and/or third slurries). In embodiments of the invention, at least one, and preferably at least two, of the following bond-facilitating items (1)-(5) are adopted. (1) At least one of the cover sheets, preferably the back cover sheet is perforated. (2) At least one of the cover sheets, preferably the back cover sheet, is high absorption paper. (3) Starch is applied between the set gypsum core and at least one of the cover sheets, preferably at least between the back cover sheet and the set gypsum core. (4) Skim coat starch is included in the second and/or third slurries to enhance the bond between the board core and the face and/or back cover sheet respectively, the skim coat starch enhancing the bond between the board core and the face and/or back cover sheets, respectively. (5) The drying includes applying heat in a chamber (kiln) and further comprises measuring moisture content in the board upstream of the kiln using an upstream radio-frequency moisture sensor and an upstream sensor that is less influenced by high salt concentration in the slurry as compared with the radio-frequency moisture sensor. The kiln contains at least one in-kiln radio-frequency moisture sensor therein, the in-kiln moisture sensor in communication with a controller outside of the kiln to produce an in-kiln moisture reading. The upstream sensors are in communication with the controller to produce a first upstream moisture reading and a second upstream moisture reading, respectively. The moisture readings from the upstream radio-frequency moisture sensor and the upstream sensor that is less influenced by high salt concentration in the slurry as compared with the radio-frequency moisture sensor are correlated. The in-kiln radio-frequency moisture sensor is biased when a delta exists between the first and second moisture readings to correct for any errors in the in-kiln moisture reading. In some embodiments, the moisture content in the board downstream of the kiln is measured using a downstream radio-frequency moisture sensor and a downstream sensor that is less influenced by high salt concentration in the slurry as compared with the radio-frequency moisture sensor. The downstream sensors are in communication with the controller to produce a first downstream moisture reading and a second downstream moisture reading, respectively. The moisture readings from the downstream radio-frequency moisture sensor and the downstream sensor that is less influenced by high salt concentration in the slurry as compared with the radio-frequency moisture sensor are correlated. Where there is a discrepancy between the readings, the burner output and/or air controlling apparatus are used to adjust the temperature in the kiln (e.g., to reduce extent of heating therein). In some embodiments, three of items (1)-(5) are adopted. In some embodiments, four of items (1)-(5) are adopted. In some embodiments, all five of items (1)-(5) are adopted. Also provided are related gypsum board products, as well as other methods and systems.

The cover sheets can be fibrous or non-fibrous. In some embodiments, they may be formed from paper, fibrous mat or other type of material (e.g., foil, plastic, glass mat, non-woven material such as blend of cellulosic and inorganic filler, etc.).

The face and back cover sheets can have any suitable basis weight and thickness. Generally, the thickness of the face and back cover sheet (e.g., composed of paper) is determined by the (e.g., paper) weight. For example, in some embodiments, the face and back cover sheets can have a basis weight of from about 10 lb/msf to about 55 lb/msf, e.g., from about 20 lb/msf to about 55 lb/msf, from about 20 lb/msf to about 50 lb/msf, from about 20 lb/msf to about 40 lb/msf, from about 30 lb/msf to about 55 lb/msf, from about 30 lb/msf to about 50 lb/msf, from about 30 lb/msf to about 40 lb/msf, etc. However, in some embodiments, the presence of the intermediate sheet allows for the use of lower weight cover sheets, which thereby reduces expense and/or allows for lower weight board. For example, in some embodiments, one or both of the face and back cover sheets have a weight of from about 15 lb/MSF to about 35 lb/msf, such as from about 20 lb/MSF to about 33 lb/msf, from about 20 lb/MSF to about 31 lb/msf, from about 20 lb/MSF to about 29 lb/msf, from about 20 lb/MSF to about 27 lb/msf, from about 15 lb/MSF to about 31 lb/msf, etc. Boards at such weights can have a nominal thickness of about 0.005 inch to about 0.015 inch thick, e.g., 0.007 to about 0.03 inch (e.g., about 0.01 inch).

In some embodiments, the back cover sheet is perforated, as described in U.S. patent application Ser. No. 16/401,675, incorporated herein by reference. Surprisingly, perforation of the back cover sheet of a gypsum board may improve its adhesion to a board core layer containing high amounts of extraneous salts. The board core layer may be made from an aqueous slurry of stucco containing calcium sulfate hemihydrate and high amounts of extraneous salts, particularly chloride salts. One or both of the cover sheets may be paper cover sheets, which may be the same or different paper materials. Optionally, the front cover sheet of a gypsum board may be perforated as well, with similar advantages being possible. Further optionally, various additives may be present in the board core layer or a gypsum slurry used to form the board core layer. The board core layer may further comprise one or more high-density regions (layers) in contact with the inner surface of the front cover sheet or the back cover sheet and coated thereon. The one or more high-density regions may be in contact with a low-density interior of the board core layer.

Without being bound by any theory or mechanism, it is believed that the perforations within the back cover sheet, provide a conduit for outward migration of chloride salts released from the board core layer that would otherwise detrimentally aggregate at the interface between the board core layer and the cover sheets. Instead, when the perforations are present, the chloride ions and their counter ion (e.g., Na⁺, K⁺, Mg²⁺ and/or Ca²⁺) may migrate at least partially through the perforations and potentially leave the gypsum board environment. Alternately, the salts may precipitate within or just outside the perforations on the outer surface of the back cover sheet. Due to the salt precipitate the outside of perforations, the “net salt” between paper and core is reduced, therefore, less salt is present the interface, resulting in a good paper-to-core bond. In either case, improved adhesion between the board core layer and the cover sheet may result.

When the back cover sheet of a gypsum board is perforated in the manner described herein, the gypsum boards may benefit from improved adhesion between the board core layer and the cover sheet(s), relative to a gypsum board which is the same but for lacking perforation of the cover sheet(s). Accordingly, the present invention provides gypsum boards containing significant quantities of extraneous salts in a board core layer and methods for producing such gypsum boards using a gypsum source containing significant quantities of the extraneous salts. Thus, perforation of at least one of the cover sheets of a gypsum board with a plurality of perforations, particularly the back cover sheet, may allow lower quality gypsum sources containing excessive extraneous salts, particularly chloride salts, to be used in forming the gypsum board. Such gypsum sources may otherwise be unsuitable for forming a gypsum board with sufficient adhesion between the board core layer and the cover sheets. Advantageously, the present invention addresses this issue.

In some embodiments, the back and front cover sheets are made of paper. However, the paper materials for each cover sheet may be the same or different. According to embodiments of the present invention, only the back cover sheet of the gypsum board contains a plurality of perforations extending therethrough. The back cover sheet is made of perforated paper.

Various paper grades can be used in gypsum panels, including Manila grade paper with a smooth calendared finish is often used as the facer paper cover sheet, and Newsline paper with a rougher finish is often used as the backer paper cover sheet. Typically, both paper grades are multi-ply with at least one liner ply and several filler plies. However, if desired, at least one paper cover sheet or both paper cover sheets may be made of single-ply paper.

As mentioned above, the back cover sheet can contain a plurality of perforations in some embodiments. The plurality of perforations may be arranged in the back cover sheet in any suitable manner. Typically, the perforations are arranged in a pattern, such as a regular grid or array of perforations (see FIG. 2, for example). Other patterned arrangements of perforations also reside within the scope of the present disclosure, and the particular arrangement of perforations shown in FIG. 2 should not be considered limiting. Illustrative equipment for perforating one or more of the cover sheets in gypsum board in a manner consistent with the present disclosure is described in U.S. Patent Application Publication 2018/0065336, which is incorporated herein by reference in its entirety.

The perforations in the cover sheet are present at a shape, size, and perforation density suitable to support drying and/or increased adhesion in the gypsum board.

Typically, the perforations have a substantially circular shape. It is to be appreciated, however, that the perforations may have alternative geometric shapes such as oval, triangular, square, rectangular, or the like. Any combination of circular and non-circular perforations may be present, depending on the requirements for a particular application. Any combination of non-circular perforations may be present.

Each of the perforations within the cover sheet(s), particularly the back cover sheet may define an opening having a size that ranges from about 0.005 inches to about 0.1 inches in its largest transverse dimension, preferably from about 0.01 inches to about 0.1 inches in size, and more preferably from about 0.01 inches to about 0.02 inches in size. The term “largest transverse dimension” represents the largest dimension measured across each perforation within the plane of the cover sheet(s). For circular perforations, the largest transverse dimension represents diameter of a circular opening.

The perforations within the back cover sheet are typically the same size and shape. However, the perforations may be a mixture of perforation sizes and/or shapes. The perforation sizes, whether the same or different, may reside within any of the ranges specified above. Moreover, when at least some of the perforations have different shapes, a first plurality of perforations having a first shape and a first size and a second plurality of perforations having a different shape and/or a different size may be present. For example, a first plurality of perforations and a second plurality of perforations may have different shapes but substantially the same size.

The perforation coverage density refers to the number of perforations per unit area in the back cover sheet. The perforations present within the back cover sheet are present in a suitable perforation coverage density to promote effective board core layer adhesion. The perforation density within the cover sheet(s) may be about 5 to about 50 perforations/in², preferably about 12 to about 25 perforations/in², for example about 10 to about 15 perforations/in², or for example about 15 to about 20 perforations/in². Typically, the perforations are about 0.1 to about 10%, more typically about 0.5 to about 5% of the surface of the back cover sheet.

In some embodiments, at least one of the cover sheets (e.g., the back cover sheet) is a high absorption paper, which absorbs more water than conventional paper, as described in U.S. Patent Application 62/939,264, incorporated herein by reference. When high salt stucco is used, the salt migrates to surface of a paper cover sheet, between plies of the paper cover sheet, and the interface between the paper cover sheet and the board core, thereby resulting in poor adhesion and potentially delamination. While not wishing to be bound by any particular theory, it is believed that the use of high absorption paper increases the amount of salt impurities migrating to the outer side of the cover paper and correspondingly reduces the amount of salt migrating to the cover sheet-core interface. It is further believed that, during the drying process in the kiln, when the water evaporates from the surface of board, the high absorption paper tends to absorb water and evaporate water faster than conventional paper, resulting in more salt migrating to the outer side of the paper.

The high absorption paper can have any suitable weight and thickness. Generally, the weight of paper is determined by basis weight, which refers to the weight per unit area. This can be expressed as pounds per 1000 sq. ft. as paper weight. In some embodiments, the high absorption paper has a basis weight of from about 30 lb/MSF to about 70 lb/MSF, such as from about 42 lb/MSF to about 60 lb/MSF, e.g., from about 45 lb/MSF to about 55 lb/MSF. In some embodiments, the high absorption paper has a caliper of from about 7 mils to about 20 mils, e.g., from about 10 mils to about 15 mils (such as about 12 mils). The surface water absorption over 60 seconds, expressed in g/m², measured by Cobb Test. The test determines, on the surface of 100 cm² of paper, how many grams of water is absorbed based on the Cobb test. The procedural standards for the Cobb Test are explained in TAPPI T 441.

The high absorption paper can have any suitable water absorptivity higher than that of conventional paper. The bond side Cobb value refers to the inner side of the paper that is in contact with the gypsum slurry, while the liner side Cobb refers to the outer side of the paper which is not in contact with the slurry, where the Cobb values are measured according to TAPPI standards as set forth in the TAPPI T441 test procedure. For example, in some embodiments, the high absorption paper has a bond side Cobb value of at least about 1.8 g/100 cm², e.g., from about 1.8 g/100 cm² to about 3 g/100 cm², such as from about 1.8 g/100 cm² to about 2.9 g/100 cm², from about 1.8 g/100 cm² to about 2.7 g/100 cm², from about 1.8 g/100 cm² to about 2.5 g/100 cm², from about 2 g/100 cm² to about 3 g/100 cm², from about 2 g/100 cm² to about 2.9 g/100 cm², from about 2 g/100 cm² to about 2.7 g/100 cm², from about 2 g/100 cm² to about 2.5 g/100 cm², from about 2.1 g/100 cm² to about 3 g/100 cm², from about 2.1 g/100 cm² to about 2.9 g/100 cm², from about 2.1 g/100 cm² to about 2.7 g/100 cm², from about 2.1 g/100 cm² to about 2.5 g/100 cm², from about 2.2 g/100 cm² to about 3 g/100 cm², from about 2 g/100 cm² to about 2.9 g/100 cm², from about 2.2 g/100 cm² to about 2.7 g/100 cm², or from about 2.2 g/100 cm² to about 2.5 g/100 cm², from about 2.4 g/100 cm² to about 3 g/100 cm², from about 2.4 g/100 cm² to about 2.9 g/100 cm², from about 2.4 g/100 cm² to about 2.7 g/100 cm², etc.

In some embodiments, the high absorption paper has a liner side Cobb value of at least about 0.5 g/100 cm², e.g., from about 0.5 g/100 cm² to about 1.5 g/100 cm², such as from about 0.5 g/100 cm² to about 1.2 g/100 cm², from about 0.7 g/100 cm² to about 1.5 g/100 cm², from about 0.7 g/100 cm² to about 1.2 g/100 cm², from about 0.9 g/100 cm² to about 1.5 g/100 cm², from about 0.9 g/100 cm² to about 1.2 g/100 cm², etc. Examples of high absorption paper include Newsline Hi-Abs and News SHW HiAbs from USG. Newsline Hi Abs has a basis weight of from about 45 lb/MSF to about 48 lb/MSF. Newsline SHW Hi Abs is a super heavy high absorption paper, having a basis weight of from about 53 to about 63.5 lb/MSF.

In some embodiments, a starch layer is disposed on the inner surface(s) of the cover sheet(s), as described in U.S. patent application Ser. No. 16/401,719, incorporated herein by reference. Surprisingly, the presence of the starch layer can improve adhesion to a board core made from aqueous slurry of stucco containing calcium sulfate hemihydrate and high amounts of extraneous salts. Preferably the starch layer is a continuous starch layer disposed upon the entire inner surface of the back cover sheet. Optionally another starch layer is also disposed upon the entire inner surface of the front cover sheet. One or both of the cover sheets may be paper cover sheets, which may be the same or different paper materials. Optionally, additional starch and/or other additives may be present in the board core or aqueous gypsum slurry used to form the board core.

The board core may comprise a less dense region (layer) and further comprise one or more high-density regions (layers) in contact with the inner surface of the front paper cover sheet or the back paper cover sheet or a starch layer coated thereon.

Thus, a starch layer coated upon at least one of the cover sheets may allow lower quality gypsum sources containing excessive extraneous salts to be used in forming a gypsum board.

Preferably, the board can include a face skim coat and/or a back skim coat. In preferred embodiments, the skim coat layers generally have higher density and are very thin relative to the set gypsum core. In some embodiments, the layer(s) forming the set gypsum core is the largest contributor to thickness of the gypsum layers cumulatively, and to the board as a whole. In some embodiments, the set gypsum core makes up a substantial thickness (e.g., at least about 90%, at least about 92%, at least about 95%, or at least about 97%) of the total thickness of all the gypsum layers. In some embodiments, the face and/or back skim coat layer has a dry thickness of from about 0.125 inches (⅛ inch) to about 0.016 inches ( 1/64 inch). In preferred embodiments, at least one skim coat layer has a thickness of from about 0.08 inches to about 0.02 inches, such as from about 0.08 inches to about 0.03 inches, from about 0.07 inches to about 0.02 inches, from about 0.07 inches to about 0.03 inches, from about 0.06 inches to about 0.02 inches, from about 0.06 inches to about 0.03 inches, from about 0.05 inches to about 0.02 inches, from about 0.05 inches to about 0.03 inches, from about 0.04 inches to about 0.02 inches, or from about 0.04 inches to about 0.03 inches.

In some embodiments, one or both skim coats can be prepared from a slurry containing skim coat starch, as described in U.S. Patent Application 62/930,965, filed Nov. 5, 2019, incorporated herein by reference. Surprisingly and unexpectedly, including skim coat starch in the very thin back skim coat has been found to further provide enhanced bonding between the core and the back cover sheet. While not wishing to be found by any particular theory, the presence of the skim coat starch in the thin skim coat is effective for enhancing cover sheet-gypsum core bonding because it is believed the starch acts as glue to bind the paper fibers and gypsum crystals in the core tightly.

In preferred embodiments, the starch is a native starch and is included in the skim coat layer between the board core and the back paper cover sheet. In this manner, the invention allows for improved adhesion even when the board core and/or other gypsum layers are formed from stucco derived from low quality synthetic gypsum, e.g., containing undesirable extraneous salts, including chloride salts such as NaCl, KCl, MgCl₂, and/or CaCl₂, which previously were found to interfere with paper-core bonding.

Thus, in some embodiments, the primary slurry used for forming the gypsum board core can contain core starch while the back skim coat layer and optionally the face skim coat layer are formed from slurry that contains skim coat starch. In some embodiments, the skim coat starch is provided in a higher relative concentration in the slurry for forming the skim coat layer as compared with the amount of core starch in the slurry for forming the board core. As discussed herein, the skim coat starch surprisingly and unexpectedly enhances the adhesion of its corresponding (adjacent) cover sheet even in the presence of unwanted salt impurities. In some embodiments, the core starch is not believed to be effective in aiding adhesion of the cover sheet when salt impurities are present.

The core starch is provided for strength enhancement as discussed in, e.g., U.S. Pat. Nos. 9,540,810, 9,828,441, and 10,399,899, and U.S. application Ser. No. 15/934,088. In some embodiments, a migrating starch as known in the art can be additionally included in the core slurry. Migrating starches normally have smaller chain lengths (e.g., due to acid- or enzyme-modification) and migrate to the core-cover sheet interface for further bond enhancement without appreciable effect on core strength.

In preferred embodiments, the core starch is in the form of a pregelatinized starch, e.g., having a viscosity of from about 20 centipoise to about 700 (such as from about 20 centipoise to about 300 centipoise or from about 30 centipoise to about 200 centipoise) when the viscosity is measured while the starch is subjected to conditions according to the VMA method. In some embodiments, the core starch is a native starch. In some embodiments, the core starch includes an uncooked starch having (i) a hot water viscosity of from about 20 BU to about 300 BU according to the hot water viscosity assay (HWVA method), and/or (ii) a mid-range peak viscosity of from about 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute. In some embodiments, the core starch includes a migrating starch having a molecular weight of about 6,000 Daltons or less.

In some embodiments, skim coat starch is included in at least one skim coat layer (and optionally in both skim coat layers in some embodiments). The starch used in making the skim coat layer is effective to enhance bonding between the core and the cover sheet to which it is adjacent, as compared with boards made without the starch in the slurry for forming the skim coat layer(s). In preferred embodiments, the starch is a native starch. In some embodiments, the skim coat starch includes an uncooked starch having (i) a hot water viscosity of from about 20 BU to about 300 BU according to the hot water viscosity assay (HWVA method), and/or (ii) a mid-range peak viscosity of from about 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute. Alternatively, if desired, the skim coat starch can be in the form of a pregelatinized starch, e.g., having a viscosity of from about 20 centipoise to about 700 (such as from about 20 centipoise to about 300 centipoise or from about 30 centipoise to about 200 centipoise) when the viscosity is measured while the starch is subjected to conditions according to the VMA method. In some embodiments, the skim coat starch includes a migrating starch having a molecular weight of about 6,000 Daltons or less. The HWVA method is set forth in, e.g., U.S. Patent Publication 2019/0023612 A1, while the VMA method is set forth in, e.g., U.S. Patent Publication 2012/0113124, which methodologies are hereby incorporated by reference.

In some embodiments, the skim coat starch is present in at least one of the skim coat layers, preferably at least the skim coat layer adjacent to the back paper, in an amount of from about 0.3% to about 8.0% by weight of the stucco, e.g., from about 1.0% to about 4.0% by weight of the stucco, in the second and/or third slurries. In some embodiments, the skim coat starch is included in the second skim coat layer adjacent the back cover sheet, but the slurry for making the first skim coat layer adjacent the face cover sheet is formed from the same slurry for making the core, e.g., such that it contains core starch. The total skim coat starch usage in the second and/or third slurry is higher than the core starch usage in the first slurry. In preferred embodiments, usage of core starch is from about 0.1 to about 1.5 wt. % by weight of stucco, while the usage of skim coat starch is from about 1.5 to about 4.0 wt. % by weight of the stucco. In some embodiments, the core starch is a pregelatinized starch and the skim coat starch is an uncooked starch, with a migrating starch additionally being optional in the core starch and/or the skim coat starch.

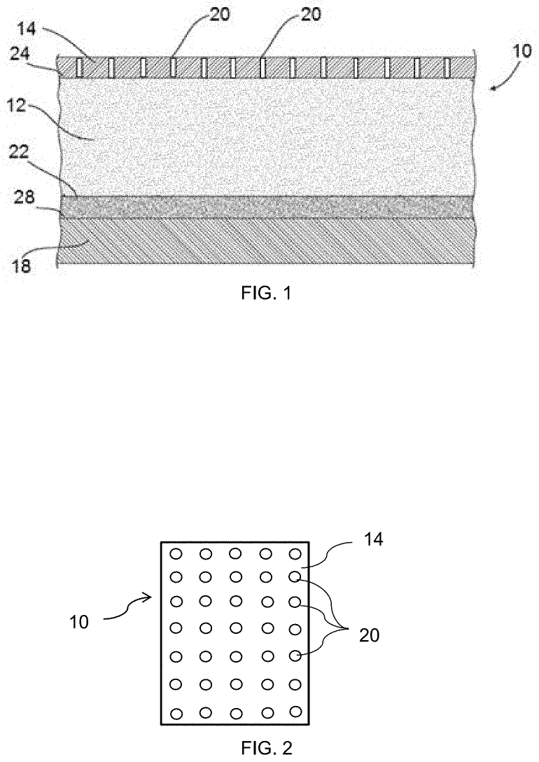

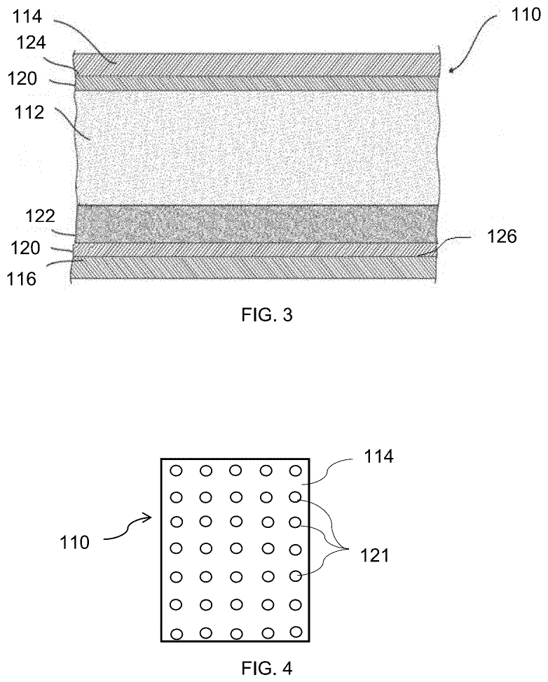

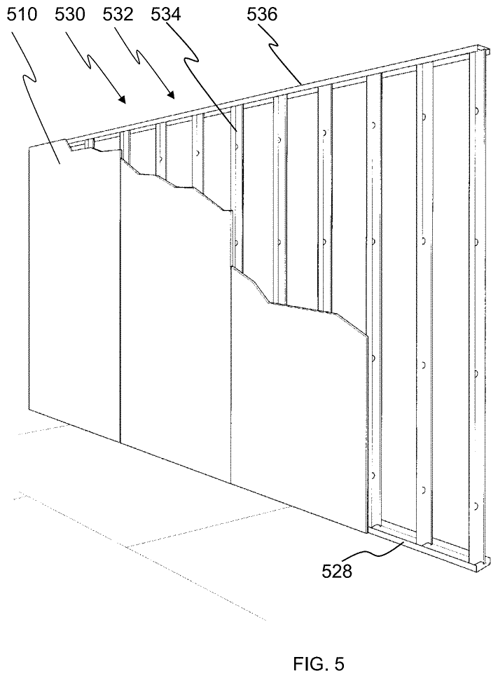

FIG. 1 depicts an embodiment of a cross-sectional view of the wallboard panel (gypsum board) 10 of the invention in which a gypsum core (board core layer) 12 (for example 0.5 inch thick) is sandwiched between a backer paper cover sheet (back cover sheet) 14 and a facer paper cover sheet (front cover sheet) 18, which may each be single-ply or multi-ply paper. The backer paper cover sheet (back cover sheet) 14 has perforations 20. The inner surface of the backer paper cover sheet 14 creates a bond side 24 of the backer paper cover sheet 14 which faces the gypsum core 12. The inner surface of the facer paper cover sheet 18 creates a bond side 28 which faces the gypsum core 12. The outer surface of the backer paper cover sheet 14 faces wall framing of a room after the wallboard panel 10 is installed as an interior wall. The outer surface of the facer paper cover sheet 18 faces inside of a room after the wallboard panel 10 is installed as an interior wall.

Backer paper cover sheet (back cover sheet) 14 contains a plurality of perforations 20 extending therethrough according to the present invention. FIG. 2 shows a top (axial) view of the wallboard panel 10, in which an illustrative configuration of perforations 20 may be seen within backer paper cover sheet 14. As depicted, the perforations 20 are patterned in a regular array of columns and rows. It is to be appreciated that other patterned arrangements of perforations 20 also reside within the scope of the invention, and the depicted number, spacing and coverage density of the perforations 20 should not be considered limiting.

The perforations 20 within the backer paper cover sheet 14 surprisingly increase the bonding performance between the gypsum core 12 and the backer paper cover sheet 14. The improved bonding performance can be particularly evident when the gypsum used to form the gypsum core 12 has a high salt concentration.

An optional thin, dense gypsum layer (low-density region) 22 lies between the gypsum core 12 and the facer paper cover sheet 18 to contact the gypsum core 12 and the facer paper cover sheet 18. Thus, thin, dense gypsum layer 22 is interposed between the gypsum core 12 and the facer paper cover sheet 18. Another optional thin, dense gypsum layer (not shown) may be interposed between and contact the gypsum core 12 and the backer paper cover sheet 14. Generally, the gypsum core 12 and the thin, dense gypsum layer 22 have the same composition and are contiguous with one another. Collectively, the gypsum core 12 and the thin, dense gypsum layer 22 may define the interior of gypsum board 10, with the gypsum core 12 being a low-density region or layer and the thin, dense gypsum layer 22 being a relatively higher-density region or layer. Typically, the aqueous gypsum slurry used to form the gypsum core 12 has been foamed. Thus, the low-density region may be formed from a gypsum slurry in a foamed state. In contrast, the aqueous gypsum slurry used for forming the thin, dense gypsum layer 22 has not been foamed. Thus, the high-density region may be in formed from a gypsum slurry that is not foamed. Thus, the thin, dense gypsum layer 22 is relatively denser than the rest of gypsum core 12.

Thus, the high-density region may have a lower porosity associated therewith than does the low-density region. Typically, the thin, dense gypsum layer 22 is applied to an inner surface of a selected cover sheet. If present, the thin, dense gypsum layer 22 is interposed between the cover sheet and the low-density region (gypsum core 12).

One or more chloride salts in a specified amount may be present in the gypsum core 12 according to the present disclosure. If a high-density region (thin, dense gypsum layer 22) is included, the one or more chloride salts may also be present therein. Generally, the one or more chloride salts may be selected from the group consisting of NaCl, KCl, MgCl₂, CaCl₂ and any combination thereof.

The concentration of the chloride anion in the aqueous slurry used to make the board core 12 and, if present, the high-density region (thin, dense gypsum layer 22) may range from about 500 ppm to about 3000 ppm, typically from about 500 ppm to about 2000 ppm per 1,000,000 parts by weight calcium sulfate hemihydrate, more typically from about 500 ppm to about 1500 ppm, per 1,000,000 parts by weight calcium sulfate hemihydrate.

Due to salt passing through the perforations some of the salt from the original aqueous gypsum slurry may not remain in the core 12 and, if present, the high-density region (thin, dense gypsum layer 22), but it may be in the pore of perforation or outside of the paper sheet.

FIG. 3 depicts the wallboard panel 110 of an embodiment of the invention in which a gypsum core 112 (for example about 0.5 inch thick) is sandwiched between a backer paper cover sheet (back cover sheet) 114 and a facer paper cover sheet (front cover sheet) 116, which may each be single-ply or multi-ply paper. The inner surface of the backer paper cover sheet 114 creates a bond side 124 of the backer paper cover sheet 114 which faces the gypsum core. The inner surface of the facer paper cover sheet 116 creates a bond side 126 which faces the gypsum core 112. The outer surface of the backer paper cover sheet 114 faces wall framing (see FIG. 5) of a room after the wallboard panel 110 is installed as an interior wall. The outer surface of the facer paper cover sheet 116 faces inside of a room after the wallboard panel 110 is installed as an interior wall.

A starch layer 120 lies on the backer sheet 114 bond side 124. An optional starch layer 120 lies on the facer paper cover sheet 116 bond side 126. An optional thin, dense gypsum layer 122 lies between the gypsum core 112 and the facer paper cover sheet 116 to contact the gypsum core 112 and the facer paper cover sheet 116. If the thin, dense gypsum layer 122 is present then the starch layer 120 is between the thin, dense gypsum layer 122 and the facer paper cover sheet 116. Another optional thin, dense gypsum layer (not shown) may lay between the gypsum core 112 and the backer paper cover sheet 114. Generally, the gypsum core 112 and the thin, dense gypsum layer 122 have the same composition and are contiguous with one another. However, the core slurry (aqueous slurry) used for forming gypsum core 112 has been foamed and the aqueous slurry used for forming the thin, dense gypsum layer 122 has not been foamed so the thin, dense gypsum layer slurry is denser than the core slurry.

The starch layer 120 surprisingly increases the bonding performance between the gypsum core 112 and the backer sheet 114. The improved bonding performance can be particularly evident when the gypsum has a high salt concentration.

The starch layer is disposed upon the back paper in an amount ranging between about 0.5-15 lbs/MSF, preferably about 0.5-5 lbs/MSF, more preferably about 1-2 lbs/MSF (MSF=1000 square feet). The starch is used as a binding agent and can be native (uncooked) starch, pre-gelled starch, or a combination of native starch and pre-gelled starch.

Generally, the relatively low-density interior region (gypsum core 112) and relatively high-density region (thin, dense gypsum layer 122) have the same composition and are contiguous with one another. However, low-density interior region may be formed from a gypsum slurry in a foamed state, whereas high-density region may be in formed from a gypsum slurry that is not foamed so that a denser layer forms. That is, the high-density region may have a lower porosity associated therewith than does the low-density interior region. Typically, the thin, dense gypsum layer 122 is applied to an inner surface of a selected cover sheet. If the high-density region is also present on the selected cover sheet, then the starch layer 120 is between the cover sheet and the high-density region (thin, dense gypsum layer 122).

One or more chloride salts may be present in board core 112 of the present disclosure. If a high-density region (thin, dense gypsum layer 122) is included, the one or more chloride salts may also be present therein. Generally, the one or more chloride salts include any chloride salts from the stucco or other ingredient used to make the aqueous slurry for making the board.

The concentration of the chloride anion in the aqueous slurry used to make the board core 112 and, if present, the high-density region (thin, dense gypsum layer 122) may range from about 500 ppm to about 3000 ppm, typically from about 1000 ppm to about 3000 ppm, more typically from about 2000 ppm to about 3000 ppm, per 1,000,000 parts by weight calcium sulfate hemihydrate.

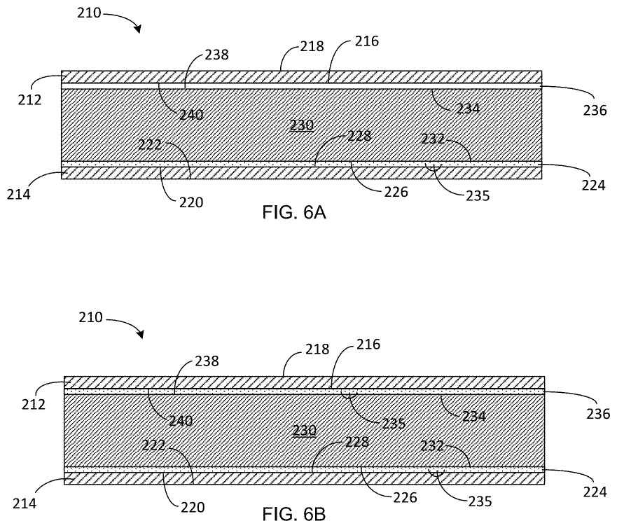

To illustrate, FIGS. 6A-6B schematically depict embodiments of the invention where a composite gypsum board 210 is shown. The board 210 comprises a face cover sheet 212 and a back cover sheet 214. The face cover sheet 212 has a first face 216 and a second face 218, which is generally the surface visible when the board 210 is installed. The back cover sheet 214 has a first face 220 and a second face 222 that is generally the outer surface of the board 210 that is inwardly facing studs, joists or the like when installed.

A back skim coat layer 224 has a first face 226 and a second face 228 that faces the first face 220 of the back cover sheet 214. A board core 230 is disposed between the two cover sheets 212 and 214. In general, skim coat layers are gypsum layers that are relatively denser and thinner than the board core 230. The board core 230 has a first face 232 and a second face 234. The first face 232 of the board core 230 faces the first face 220 of the back cover sheet 214. The back skim coat layer 224 includes skim coat starch 235 (depicted as dots in FIGS. 6A-6B) for enhancing adhesion of the core 230 to the cover sheet 214. As shown in FIGS. 6A-6B, a face skim coat layer 236 is preferably provided between the face cover sheet 212 and board core 230.

If included, the face skim coat layer 236 has a first surface 238 facing the board core 230, and a second surface 240 facing the face cover sheet 212, as seen in FIGS. 6A-6B. When the face skim coat layer 236 is present, in some embodiments it is formed from the same slurry used to form the board core, e.g., such that it contains core starch and not skim coat starch, as shown in FIG. 6A. Alternatively, the face skim coat layer 236 is formed from a slurry containing skim coat starch 235 in some embodiments, as seen in FIG. 6B.

In a wall assembly, the board can be affixed to a substrate, typically studs in a framing construction. In the wall assembly, the back surface of the board (i.e., the outer surface of the back cover sheet) faces inward toward the studs while the face surface of the board (i.e., the outer surface of the face cover sheet) is visible when the board is hanging when installed in use. FIG. 5 is a perspective view of a typical building wall system 530 that may be employed in a wall system of the present invention. FIG. 5 shows stud wall “skeleton” 532 which includes a plurality of studs 534, an upper track 536, a lower track 538. Gypsum boards 510 may be secured in any known manner to one or both sides of the studs 534 to close the wall and form the interior surface or surfaces of the wall or a ceiling.

The stucco slurry used in making the set gypsum layer(s) of the board contains stucco, e.g., in the form of calcium sulfate alpha hemihydrate, calcium sulfate beta hemihydrate, and/or calcium sulfate anhydrite. In addition to the stucco, water, and core starch, the stucco slurry can contain commonly known optional additive such as foaming agents, polyphosphates, dispersants, accelerators, retarders, etc. The board core is preferably formed from an agent that contributes to its lower density, preferably foaming agents, although in some embodiments low density filler (e.g., perlite, low density aggregate or the like) can be employed. Various foaming agent regimes are well known in the art. Foaming agent can be included to form an air void distribution within a crystalline matrix of set gypsum. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. In some embodiments, the foaming agent comprises an alkyl sulfate surfactant.

Many commercially known foaming agents are available and can be used in accordance with embodiments of the disclosure, such as the HYONIC line (e.g., 25AS) of soap products from GEO Specialty Chemicals, Ambler, Pa. Other commercially available soaps include the Polystep B25, from Stepan Company, Northfield, Ill. The foaming agents described herein can be used alone or in combination with other foaming agents. The foam can be pregenerated and then added to the stucco slurry. The pregeneration can occur by inserting air into the aqueous foaming agent. Methods and apparatus for generating foam are well known. See, e.g., U.S. Pat. Nos. 4,518,652; 2,080,009; and 2,017,022.

In some embodiments, the foaming agent comprises, consists of, or consists essentially of at least one alkyl sulfate, at least one alkyl ether sulfate, or any combination thereof but is essentially free of an olefin (e.g., olefin sulfate) and/or alkyne. Essentially free of olefin or alkyne means that the foaming agent contains either (i) 0 wt. % based on the weight of stucco, or no olefin and/or alkyne, or (ii) an ineffective or (iii) an immaterial amount of olefin and/or alkyne. An example of an ineffective amount is an amount below the threshold amount to achieve the intended purpose of using olefin and/or alkyne foaming agent, as one of ordinary skill in the art will appreciate. An immaterial amount may be, e.g., below about 0.001 wt. %, such as below about 0.0005 wt. %, below about 0.001 wt. %, below about 0.00001 wt. %, etc., based on the weight of stucco, as one of ordinary skill in the art will appreciate.

Some types of unstable soaps, in accordance with embodiments of the disclosure, are alkyl sulfate surfactants with varying chain length and varying cations. Suitable chain lengths, can be, for example, C₈-C₁₂, e.g., C₈-C₁₀, or C₁₀-C₁₂. Suitable cations include, for example, sodium, ammonium, magnesium, or potassium. Examples of unstable soaps include, for example, sodium dodecyl sulfate, magnesium dodecyl sulfate, sodium decyl sulfate, ammonium dodecyl sulfate, potassium dodecyl sulfate, potassium decyl sulfate, sodium octyl sulfate, magnesium decyl sulfate, ammonium decyl sulfate, blends thereof, and any combination thereof.

Some types of stable soaps, in accordance with embodiments of the disclosure, are alkoxylated (e.g., ethoxylated) alkyl sulfate surfactants with varying (generally longer) chain length and varying cations. Suitable chain lengths can be, for example, C₁₀-C₁₄, e.g., C₁₂-C₁₄, or C₁₀-C₁₂. Suitable cations include, for example, sodium, ammonium, magnesium, or potassium. Examples of stable soaps include, for example, sodium laureth sulfate, potassium laureth sulfate, magnesium laureth sulfate, ammonium laureth sulfate, blends thereof, and any combination thereof. In some embodiments, any combination of stable and unstable soaps from these lists can be used.

Examples of combinations of foaming agents and their addition in preparation of foamed gypsum products are disclosed in U.S. Pat. No. 5,643,510, herein incorporated by reference. For example, a first foaming agent which forms a stable foam and a second foaming agent which forms an unstable foam can be combined. In some embodiments, the first foaming agent is a soap, e.g., with an alkoxylated alkyl sulfate soap with an alkyl chain length of 8-12 carbon atoms and an alkoxy (e.g., ethoxy) group chain length of 1-4 units. The second foaming agent is optionally an unalkoxylated (e.g., unethoxylated) alkyl sulfate soap with an alkyl chain length of 6-20 carbon atoms, e.g., 6-18 or 6-16 carbon atoms. Regulating the respective amounts of these two soaps, in accordance with some embodiments, is believed to allow for control of the board foam structure until about 100% stable soap or about 100% unstable soap is reached.

In some embodiments, a fatty alcohol optionally can be included with the foaming agent, e.g., in a pre-mix to prepare the foam, as described in U.S. Patent Publications US 2017/0096369 A1, US 2017/0096366 A1, and US 2017/0152177 A1. This can result in an improvement in the stability of the foam, thereby allowing better control of foam (air) void size and distribution. The fatty alcohol can be any suitable aliphatic fatty alcohol. It will be understood that, as defined herein throughout, “aliphatic” refers to alkyl, alkenyl, or alkynyl, and can be substituted or unsubstituted, branched or unbranched, and saturated or unsaturated, and in relation to some embodiments, is denoted by the carbon chains set forth herein, e.g., Cₓ-C_{y}, where x and y are integers. The term aliphatic thus also refers to chains with heteroatom substitution that preserves the hydrophobicity of the group. The fatty alcohol can be a single compound, or can be a combination of two or more compounds. In some embodiments, the optional fatty alcohol is a C₆-C₂₀ fatty alcohol (e.g., C₆-C₁₈, C₆-C₁₁₆, C₆-C₁₄, C₆-C₁₂, C₆-C₁₀, C₆-C₈, C₈-C₁₆, C₈-C₁₄, C₈-C₁₂, C₈-C₁₀, C₁₀-C₁₆, C₁₀-C₁₄, C₁₀-C₁₂, C₁₂-C₁₆, C₁₂-C₁₄, or C₁₄-C₁₆ aliphatic fatty alcohol, etc.). Examples include octanol, nonanol, decanol, undecanol, dodecanol, or any combination thereof.

In some embodiments, the optional foam stabilizing agent comprises the fatty alcohol and is essentially free of fatty acid alkyloamides or carboxylic acid taurides. In some embodiments, the optional foam stabilizing agent is essentially free of a glycol, although glycols can be included in some embodiments, e.g., to allow for higher surfactant content. Essentially free of any of the aforementioned ingredients means that the foam stabilizer contains either (i) 0 wt. % based on the weight of any of these ingredients, or (ii) an ineffective or (iii) an immaterial amount of any of these ingredients. An example of an ineffective amount is an amount below the threshold amount to achieve the intended purpose of using any of these ingredients, as one of ordinary skill in the art will appreciate. An immaterial amount may be, e.g., below about 0.0001 wt. %, such as below about 0.00005 wt. %, below about 0.00001 wt. %, below about 0.000001 wt. %, etc., based on the weight of stucco, as one of ordinary skill in the art will appreciate.

It has been found that suitable void distribution and wall thickness (independently) can be effective to enhance strength, especially in lower density board (e.g., below about 35 pcf). See, e.g., US 2007/0048490 and US 2008/0090068. Evaporative water voids, generally having voids of about 5 μm or less in diameter, also contribute to the total void distribution along with the aforementioned air (foam) voids. In some embodiments, the volume ratio of voids with a pore size greater than about 5 microns to the voids with a pore size of about 5 microns or less, is from about 0.5:1 to about 9:1, such as, for example, from about 0.7:1 to about 9:1, from about 0.8:1 to about 9:1, from about 1.4:1 to about 9:1, from about 1.8:1 to about 9:1, from about 2.3:1 to about 9:1, from about 0.7:1 to about 6:1, from about 1.4:1 to about 6:1, from about 1.8:1 to about 6:1, from about 0.7:1 to about 4:1, from about 1.4:1 to about 4:1, from about 1.8:1 to about 4:1, from about 0.5:1 to about 2.3:1, from about 0.7:1 to about 2.3:1, from about 0.8:1 to about 2.3:1, from about 1.4:1 to about 2.3:1, from about 1.8:1 to about 2.3:1, etc.

As used herein, a void size is calculated from the largest diameter of an individual void in the core. The largest diameter is the same as the Feret diameter. The largest diameter of each defined void can be obtained from an image of a sample. Images can be taken using any suitable technique, such as scanning electron microscopy (SEM), which provides two-dimensional images. A large number of pore sizes of voids can be measured in an SEM image, such that the randomness of the cross sections (pores) of the voids can provide the average diameter. Taking measurements of voids in multiple images randomly situated throughout the core of a sample can improve this calculation. Additionally, building a three-dimensional stereological model of the core based on several two-dimensional SEM images can also improve the calculation of the void sizes. Another technique is X-ray CT-scanning analysis (XMT), which provides a three-dimensional image. Another technique is optical microscopy, where light contrasting can be used to assist in determining, e.g., the depth of voids. The voids can be measured either manually or by using image analysis software, e.g., ImageJ, developed by NIH. One of ordinary skill in the art will appreciate that manual determination of void sizes and distribution from the images can be determined by visual observation of dimensions of each void. The sample can be obtained by sectioning a gypsum board.

The foaming agent can be included in the stucco slurry in any suitable amount, e.g., depending on the desired density. A solution of foaming agent is prepared at, for example, about 0.5% (w/w). Proper amount of air is mixed with the proper amount of the solution of foaming agent, and added into slurry. Depending on the amount of air required, the concentration of the solution of the foaming agent can vary from about 0.1% to about 1% (w/w). Since the skim coat layers have a higher density, the slurry for forming the skim coat layers can be made with less (or no) foam.

The fatty alcohol can be present, if included, in the stucco slurry in any suitable amount. In some embodiments, the fatty alcohol is present in the core slurry in an amount of from about 0.0001% to about 0.03% by weight of the stucco, e.g., from about 0.0001% to about 0.025% by weight of the stucco, from about 0.0001% to about 0.02% by weight of the stucco, or from about 0.0001% to about 0.01% by weight of the stucco. Since the slurries for the skim coat layers can have less or no foam, the fatty alcohol is not required in the skim coat layers, or else can be included in a lower amount, such as from about 0.0001% to about 0.004% by weight of the stucco, e.g., from about 0.00001% to about 0.003% by weight of the stucco, from about 0.00001% to about 0.0015% by weight of the stucco, or from about 0.00001% to about 0.001% by weight of the stucco.

In some embodiments, it has been found that the chloride salts can act as an accelerator, so the usage of retarder will be increased. Secondly, if the salts are from divalent or trivalent chloride salts, such as magnesium chloride (MgCl₂), calcium chloride (CaCl₂)), or aluminum chloride (AlCl₃), the magnesium, calcium, or aluminum cations will be chelated by the retarder, resulting in the consumption of the retarder. Therefore, more retarder will be needed from divalent or trivalent salts than from monovalent salt.

In some embodiments, the stucco slurry optionally contains boric acid. Surprisingly and unexpectedly, the presence of the boric acid can enhance bonding between the gypsum layer and at least one cover sheet even when the gypsum layer is made from stucco containing a high content of salt impurities. While not wishing to be bound by any particular theory, it is believed that the addition of boric acid prevents the over-calcination of surface gypsum in the kiln. It is also believed to inhibit mold formation caused by the high salt concentration on the surface of the board. In some embodiments, the boric acid is present in an amount of from about 0.01% to about 0.5% by weight of the stucco. In some embodiments, the boric acid can be present in an amount of about 0.01% to about 0.3%, or about 0.05% to about 0.3% by weight of the stucco.

Other ingredients as known in the art can also be included in the board core slurry, including, for example, accelerators, retarders, etc. Accelerator can be in various forms (e.g., wet gypsum accelerator, heat resistant accelerator, and climate stabilized accelerator). See, e.g., U.S. Pat. Nos. 3,573,947 and 6,409,825. In some embodiments where accelerator and/or retarder are included, the accelerator and/or retarder each can be in the stucco slurry in an amount on a solid basis of, such as, from about 0% to about 10% by weight of the stucco (e.g., about 0.1% to about 10%), such as, for example, from about 0% to about 5% by weight of the stucco (e.g., about 0.1% to about 5%).

In addition, the gypsum layer(s) can be further formed from at least one dispersant to enhance fluidity in some embodiments. The dispersants may be included in a dry form with other dry ingredients and/or in a liquid form with other liquid ingredients in stucco slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin. Lignosulfonates are water-soluble anionic polyelectrolyte polymers, byproducts from the production of wood pulp using sulfite pulping. One example of a lignin useful in the practice of principles of embodiments of the present disclosure is Marasperse C-21 available from Reed Lignin Inc.

Lower molecular weight dispersants are generally preferred. For naphthalenesulfonate dispersants, in some embodiments, they are selected to have molecular weights from about 3,000 to about 10,000 (e.g., about 8,000 to about 10,000). In some embodiments, higher water demand naphthalenesulfonates can be used, e.g., having molecular weights above 10,000. As another illustration, for PCE211 type dispersants, in some embodiments, the molecular weight can be from about 20,000 to about 60,000, which exhibit less retardation than dispersants having molecular weight above 60,000.

One example of a naphthalenesulfonate is DILOFLO, available from GEO Specialty Chemicals. DILOFLO is a 45% naphthalenesulfonate solution in water, although other aqueous solutions, for example, in the range of about 35% to about 55% by weight solids content, are also readily available. Naphthalenesulfonates can be used in dry solid or powder form, such as LOMAR D, available from GEO Specialty Chemicals, for example. Another example of naphthalenesulfonate is DAXAD, available from GEO Specialty Chemicals, Ambler, Pa.

If included, the dispersant can be provided in any suitable amount. In some embodiments, for example, the dispersant can be present in the stucco slurry in an amount, for example, from about 0% to about 0.5%, e.g., from about 0.01% to about 0.7%, e.g., from about 0.01% to about 0.4% by weight of the stucco, from about 0.1% to about 0.2%, etc.

In some embodiments, the gypsum layer(s) can be further formed from at least one phosphate-containing compound, if desired, to enhance green strength, dimensional stability, and/or sag resistance. For example, phosphate-containing components useful in some embodiments include water-soluble components and can be in the form of an ion, a salt, or an acid, namely, condensed phosphoric acids, each of which comprises two or more phosphoric acid units; salts or ions of condensed phosphates, each of which comprises two or more phosphate units; and monobasic salts or monovalent ions of orthophosphates as well as water-soluble acyclic polyphosphate salt. See, e.g., U.S. Pat. Nos. 6,342,284; 6,632,550; 6,815,049; and 6,822,033.

Phosphate compositions if added in some embodiments can enhance green strength, resistance to permanent deformation (e.g., sag), dimensional stability, etc. Green strength refers to the strength of the board while still wet during manufacture. Due to the rigors of the manufacturing process, without sufficient green strength, a board precursor can become damaged on a manufacturing line.

Trimetaphosphate compounds can be used, including, for example, sodium trimetaphosphate, potassium trimetaphosphate, lithium trimetaphosphate, and ammonium trimetaphosphate. Sodium trimetaphosphate (STMP) is preferred, although other phosphates may be suitable, including for example sodium tetrametaphosphate, sodium hexametaphosphate having from about 6 to about 27 repeating phosphate units and having the molecular formula Naₙ₊₂PₙO₃ₙ₊₁ wherein n=6-27, tetrapotassium pyrophosphate having the molecular formula K₄P₂O₇, trisodium dipotassium tripolyphosphate having the molecular formula Na₃K₂P₃O₁₀, sodium tripolyphosphate having the molecular formula Na₅P₃O₁₀, tetrasodium pyrophosphate having the molecular formula Na₄P₂O₇, aluminum trimetaphosphate having the molecular formula Al(PO₃)₃, sodium acid pyrophosphate having the molecular formula Na₂H₂P₂O₇, ammonium polyphosphate having 1,000-3,000 repeating phosphate units and having the molecular formula (NH₄)ₙ₊₂PₙO₃ₙ₊₁ wherein n=1,000-3,000, or polyphosphoric acid having two or more repeating phosphoric acid units and having the molecular formula Hₙ₊₂PₙO₃ₙ₊₁ wherein n is two or more.

If included, the polyphosphate can be present in any suitable amount. To illustrate, in some embodiments, the polyphosphate can be present in the slurry in an amount, for example, from about 0.1% to about 1%, e.g., about 0.2% to about 0.4% by weight of the stucco, from about 0% to about 0.5%, e.g., from about 0% to about 0.2% by weight of the stucco. Thus, the dispersant and polyphosphate optionally can be in any suitable amount in the stucco slurry.

If desired, in some embodiments, components for fire and/or water resistance can also be optionally included in the gypsum slurry. Examples include, for instance, siloxanes (water resistance); fiber; heat sink additives such as aluminum trihydrite (ATH), magnesium hydroxide or the like; and/or high expansion particles (e.g., expandable to about 300% or more of original volume when heated for about one hour at 1560° F.). Further disclosure on such additives may be found in U.S. Pat. No. 8,323,785. High expansion vermiculite may be included, although other fire resistant materials can be included. If present, fire or water resistance additives can be included in any suitable amount as desired depending, e.g., on fire rating, and like performance parameters. For example, if included, the fire or water resistance additives can be individually present in an amount from about 0.5% to about 10% by weight of the stucco, such as from about 1% to about 10%, about 1% to about 8%, about 2% to about 10%, about 2% to about 8%, or the like. If included, the siloxane may desirably be introduced in the form of an emulsion. The slurry may then be shaped and dried under conditions which promote the polymerization of the siloxane to form a highly cross-linked silicone resin. A catalyst which promotes the polymerization of the siloxane to form a highly cross-linked silicone resin can be added to the gypsum slurry. Solventless methyl hydrogen siloxane fluid can be used as the siloxane. This product is a siloxane fluid containing no water or solvents. It is contemplated that about 0.3% to about 1.0% of the siloxane may be used if desired, based on the weight of the dry ingredients. For example, if desired, about 0.4% to about 0.8% siloxane may be present in the gypsum slurry based on the dry stucco weight. There may also be an absence of any one or more of these components for fire and/or water resistance. For example, there may be an absence of siloxane.

In such fire-resistant embodiments, clay is preferably included in the stucco slurry. It is believed that the presence of the clay in fire-resistant board prepared with high level of chloride greatly reduces thermal shrinkage during fire. Any suitable clay can be used, e.g., kaolin clay. In some embodiments, the clay is present in an amount of from about 1% to about 10% by weight of the stucco. In some embodiments, the clay can be present in an amount of from about 1% to about 5% by weight of the stucco.

The board core can have any suitable density useful in contributing to a desired total composite board density, such as, for example, a core density of from about 16 pcf (about 260 kg/m³) to about 40 pcf, e.g., from about 18 pcf to about 40 pcf, 18 pcf to about 38 pcf, 18 pcf to about 36 pcf, 18 pcf to about 32 pcf, 20 pcf to about 40 pcf, 20 pcf to about 36 pcf, 20 pcf to about 32 pcf, 22 pcf to about 40 pcf, 22 pcf to about 36 pcf, 22 pcf to about 32 pcf, 26 pcf to about 40 pcf, 26 pcf to about 36 pcf, or 26 pcf to about 32 pcf. In some embodiments, the board core has an even lower density, e.g., about 30 pcf or less, about 29 pcf (about 460 kg/m³) or less, about 28 pcf or less, about 27 pcf (about 430 kg/m³) or less, about 26 pcf or less, etc. For example, in some embodiments, the core density is from about 12 pcf (about 190 kg/m³) to about 30 pcf, from about 14 pcf (about 220 kg/m³) to about 30 pcf, 16 pcf to about 30 pcf, 16 pcf to about 28 pcf, 16 pcf to about 26 pcf, 16 pcf to about 22 pcf (about 350 kg/m³), 18 pcf to about 30 pcf, 18 pcf to about 28 pcf, 18 pcf to about 26 pcf, 18 pcf to about 24 pcf, 20 pcf to about 30 pcf, 20 pcf to about 28 pcf, 20 pcf to about 26 pcf, 20 pcf to about 24 pcf, 22 pcf to about 28 pcf, etc.

In some embodiments, composite board made according to the disclosure meets test protocols according to ASTM Standard C473-10. For example, in some embodiments, when the board is cast at a thickness of ½ inch, the dry board has a nail pull resistance of at least about 67 lb_{f} (pounds force) as determined according to ASTM C473-10 (method B), e.g., at least about 68 lb_{f}, at least about 70 lb_{f}, at least about 72 lb_{f}, at least about 74 lb_{f}, at least about 75 lb_{f}, at least about 76 lb_{f}, at least about 77 lb_{f}, etc. In various embodiments, the nail pull resistance can be from about 67 lb_{f} to about 100 lb_{f}, from about 67 lb_{f} to about 95 lb_{f}, from about 67 lb_{f} to about 90 lb_{f}, from about 67 lb_{f} to about 85 lb_{f}, from about 67 lb_{f} to about 80 lb_{f}, from about 67 lb_{f} to about 75 lb_{f}, from about 68 lb_{f} to about 100 lb_{f}, from about 68 lb_{f} to about 95 lb_{f}, from about 68 lb_{f} to about 90 lb_{f}, from about 68 lb_{f} to about 85 lb_{f}, from about 68 lb_{f} to about 80 lb_{f}, from about 70 lb_{f} to about 100 lb_{f}, from about 70 lb_{f} to about 95 lb_{f}, from about 70 lb_{f} to about 90 lb_{f}, from about 70 lb_{f} to about 85 lb_{f}, from about 70 lb_{f} to about 80 lb_{f}, from about 72 lb_{f} to about 100 lb_{f}, from about 72 lb_{f} to about 95 lb_{f}, from about 72 lb_{f} to about 90 lb_{f}, from about 72 lb_{f} to about 85 lb_{f}, from about 72 lb_{f} to about 80 lb_{f}, from about 72 lb_{f} to about 77 lb_{f}, from about 72 lb_{f} to about 75 lb_{f}, from about 75 lb_{f} to about 100 lb_{f}, from about 75 lb_{f} to about 95 lb_{f}, from about 75 lb_{f} to about 90 lb_{f}, from about 75 lb_{f} to about 85 lb_{f}, from about 75 lb_{f} to about 80 lb_{f}, from about 75 lb_{f} to about 77 lb_{f}, from about 77 lb_{f} to about 100 lb_{f}, from about 77 lb_{f} to about 95 lb_{f}, from about 77 lb_{f} to about 90 lb_{f}, from about 77 lb_{f} to about 85 lb_{f}, or from about 77 lb_{f} to about 80 lb_{f}.

In some embodiments, the composite gypsum board can have an average core hardness of at least about 11 lb_{f}, e.g., at least about 12 lb_{f}, at least about 13 lb_{f}, at least about 14 lb_{f}, at least about 15 lb_{f}, at least about 16 lb_{f}, at least about 17 lb_{f}, at least about 18 lb_{f}, at least about 19 lb_{f}, at least about 20 lb_{f}, at least about 21 lb_{f}, or at least about 22 lb_{f}, as determined according to ASTM C₄₇₃-10, method B. In some embodiments, board can have a core hardness of from about 11 lb_{f} to about 25 lb_{f}, e.g., from about 11 lb_{f} to about 22 lb_{f}, from about 11 lb_{f} to about 21 lb_{f}, from about 11 lb_{f} to about 20 lb_{f}, from about 11 lb_{f} to about 19 lb_{f}, from about 11 lb_{f} to about 18 lb_{f}, from about 11 lb_{f} to about 17 lb_{f}, from about 11 lb_{f} to about 16 lb_{f}, from about 11 lb_{f} to about 15 lb_{f}, from about 11 lb_{f} to about 14 lb_{f}, from about 11 lb_{f} to about 13 lb_{f}, from about 11 lb_{f} to about 12 lb_{f}, from about 12 lb_{f} to about 25 lb_{f}, from about 12 lb_{f} to about 22 lb_{f}, from about 12 lb_{f} to about 21 lb_{f}, from about 12 lb_{f} to about 20 lb_{f}, from about 12 lb_{f} to about 19 lb_{f}, from about 12 lb_{f} to about 18 lb_{f}, from about 12 lb_{f} to about 17 lb_{f}, from about 12 lb_{f} to about 16 lb_{f}, from about 12 lb_{f} to about 15 lb_{f}, from about 12 lb_{f} to about 14 lb_{f}, from about 12 lb_{f} to about 13 lb_{f}, from about 13 lb_{f} to about 25 lb_{f}, from about 13 lb_{f} to about 22 lb_{f}, from about 13 lb_{f} to about 21 lb_{f}, from about 13 lb_{f} to about 20 lb_{f}, from about 13 lb_{f} to about 19 lb_{f}, from about 13 lb_{f} to about 18 lb_{f}, from about 13 lb_{f} to about 17 lb_{f}, from about 13 lb_{f} to about 16 lb_{f}, from about 13 lb_{f} to about 15 lb_{f}, from about 13 lb_{f} to about 14 lb_{f}, from about 14 lb_{f} to about 25 lb_{f}, from about 14 lb_{f} to about 22 lb_{f}, from about 14 lb_{f} to about 21 lb_{f}, from about 14 lb_{f} to about 20 lb_{f}, from about 14 lb_{f} to about 19 lb_{f}, from about 14 lb_{f} to about 18 lb_{f}, from about 14 lb_{f} to about 17 lb_{f}, from about 14 lb_{f} to about 16 lb_{f}, from about 14 lb_{f} to about 15 lb_{f}, from about 15 lb_{f} to about 25 lb_{f}, from about 15 lb_{f} to about 22 lb_{f}, from about 15 lb_{f} to about 21 lb_{f}, from about 15 lb_{f} to about 20 lb_{f}, from about 15 lb_{f} to about 19 lb_{f}, from about 15 lb_{f} to about 18 lb_{f}, from about 15 lb_{f} to about 17 lb_{f}, from about 15 lb_{f} to about 16 lb_{f}, from about 16 lb_{f} to about 25 lb_{f}, from about 16 lb_{f} to about 22 lb_{f}, from about 16 lb_{f} to about 21 lb_{f}, from about 16 lb_{f} to about 20 lb_{f}, from about 16 lb_{f} to about 19 lb_{f}, from about 16 lb_{f} to about 18 lb_{f}, from about 16 lb_{f} to about 17 lb_{f}, from about 17 lb_{f} to about 25 lb_{f}, from about 17 lb_{f} to about 22 lb_{f}, from about 17 lb_{f} to about 21 lb_{f}, from about 17 lb_{f} to about 20 lb_{f}, from about 17 lb_{f} to about 19 lb_{f}, from about 17 lb_{f} to about 18 lb_{f}, from about 18 lb_{f} to about 25 lb_{f}, from about 18 lb_{f} to about 22 lb_{f}, from about 18 lb_{f} to about 21 lb_{f}, from about 18 lb_{f} to about 20 lb_{f}, from about 18 lb_{f} to about 19 lb_{f}, from about 19 lb_{f} to about 25 lb_{f}, from about 19 lb_{f} to about 22 lb_{f}, from about 19 lb_{f} to about 21 lb_{f}, from about 19 lb_{f} to about 20 lb_{f}, from about 21 lb_{f} to about 25 lb_{f}, from about 21 lb_{f} to about 22 lb_{f}, or from about 22 lb_{f} to about 25 lb_{f}.

With respect to flexural strength, in some embodiments, when cast in a board of ½ inch thickness, the dry board has a flexural strength of at least about 36 lb_{f} in a machine direction (e.g., at least about 38 lb_{f}, at least about 40 lb_{f}, etc.) and/or at least about 107 lb_{f} (e.g., at least about 110 lb_{f}, at least about 112 lb_{f}, etc.) in a cross-machine direction as determined according to the ASTM standard C473-10. In various embodiments, the board can have a flexural strength in a machine direction of from about 36 lb_{f} to about 60 lb_{f}, e.g., from about 36 lb_{f} to about 55 lb_{f}, from about 36 lb_{f} to about 50 lb_{f}, from about 36 lb_{f} to about 45 lb_{f}, from about 36 lb_{f} to about 40 lb_{f}, from about 36 lb_{f} to about 38 lb_{f}, from about 38 lb_{f} to about 60 lb_{f}, from about 38 lb_{f} to about 55 lb_{f}, from about 38 lb_{f} to about 50 lb_{f}, from about 38 lb_{f} to about 45 lb_{f}, from about 38 lb_{f} to about 40 lb_{f}, from about 40 lb_{f} to about 60 lb_{f}, from about 40 lb_{f} to about 55 lb_{f}, from about 40 lb_{f} to about 50 lb_{f}, or from about 40 lb_{f} to about 45 lb_{f}. In various embodiments, the board can have a flexural strength in a cross-machine direction of from about 107 lb_{f} to about 130 lb_{f}, e.g., from about 107 lb_{f} to about 125 lb_{f}, from about 107 lb_{f} to about 120 lb_{f}, from about 107 lb_{f} to about 115 lb_{f}, from about 107 lb_{f} to about 112 lb_{f}, from about 107 lb_{f} to about 110 lb_{f}, from about 110 lb_{f} to about 130 lb_{f}, from about 110 lb_{f} to about 125 lb_{f}, from about 110 lb_{f} to about 120 lb_{f}, from about 110 lb_{f} to about 115 lb_{f}, from about 110 lb_{f} to about 112 lb_{f}, from about 112 lb_{f} to about 130 lb_{f}, from about 112 lb_{f} to about 125 lb_{f}, from about 112 lb_{f} to about 120 lb_{f}, or from about 112 lb_{f} to about 115 lb_{f}.

Advantageously, in various embodiments at various board densities as described herein, the dry composite gypsum board can have a compressive strength of at least about 170 psi (1,170 kPa), e.g., from about 170 psi to about 1,000 psi (6,900 kPa), from about 170 psi to about 900 psi (6,200 kPa), from about 170 psi to about 800 psi (5,500 kPa), from about 170 psi to about 700 psi (4,800 kPa), from about 170 psi to about 600 psi (4,100 kPa), from about 170 psi to about 500 psi (3,450 kPa), from about 170 psi to about 450 psi (3,100 kPa), from about 170 psi to about 400 psi (2,760 kPa), from about 170 psi to about 350 psi (2,410 kPa), from about 170 psi to about 300 psi (2,070 kPa), or from about 170 psi to about 250 psi (1,720 kPa). In some embodiments, the board has a compressive strength of at least about 450 psi (3,100 kPa), at least about 500 psi (3,450 kPa), at least about 550 psi (3,800 kPa), at least about 600 psi (4,100 kPa), at least about 650 psi (4,500 kPa), at least about 700 psi (4,800 kPa), at least about 750 psi (5,200 kPa), at least about 800 psi (5,500 kPa), at least about 850 psi (5,850 kPa), at least about 900 psi (6,200 kPa), at least about 950 psi (6,550 kPa), or at least about 1,000 psi (6,900 kPa). In addition, in some embodiments, the compressive strength can be bound by any two of the foregoing points. For example, the compressive strength can be between about 450 psi and about 1,000 psi (e.g., between about 500 psi and about 900 psi, between about 600 psi and about 800 psi, etc.). The compressive strength as used herein is measured using a materials testing system commercially available as ATS machine model 1610, from Applied Test Systems in Butler, Pa. The load is applied continuously and without a shock at speed of 1 inch/min.

Gypsum board according to embodiments of the invention can be made on typical gypsum wallboard manufacturing lines. For example, board manufacturing techniques are described in, for example, U.S. Pat. No. 7,364,676, U.S. Patent Application Publication 2010/0247937, and U.S. patent application Ser. No. 16/581,070. Briefly, the process typically involves discharging a cover sheet onto a moving conveyor. Since gypsum board is normally formed “face down,” this cover sheet is the “face” cover sheet in such embodiments. Face and/or back skim coats as known in the art can be included as desired.

In some embodiments, one or both skim coat layers has an average dry core hardness that is at least about 1.5 times greater than the average dry core hardness of the board core, wherein the average core hardness is measured according to ASTM C-473-07, e.g., at least about 2 times greater, 2.5 times greater, 3 times greater, 3.5 times greater, 4 times greater, 4.5 times greater, etc., wherein each of these ranges can have any mathematically appropriate upper limit, such as, for example, 8, 7, 6, 5, 4, 3, or 2.

The slurries for forming the board core and for forming the skim coat layer can be formed in any suitable manner. For example, one mixer can be used to develop both slurry streams. The mixer can be e.g., in the form of “pin mixers” or “pin-less mixers” as desired where the raw materials are agitated. Alternatively, two or more separate mixers can be used. The multiple mixers can be in series or unconnected. Examples of mixers are described in European Patent 1 637 302 B1, European Patent 2 929 996 B1, European Patent Application 3 342 571 A1, and U.S. Patent Application 2017/0008192 A1. If desired for efficiency, the mixer used for the skim coat layer(s) can have a smaller mixing volume capacity in some embodiments since the amount of slurry needed to be applied for the skim coat layer is less than the amount of slurry that is applied to form the board core. The “main” mixer (i.e., for forming the board core slurry) comprises a main body and a discharge conduit (e.g., a gate-canister-boot arrangement as known in the art, or a modified outlet design (MOD) arrangement as described in U.S. Pat. Nos. 6,494,609 and 6,874,930). Foaming agent and/or core starch can be added in the discharge conduit of the mixer (e.g., in the gate as described, for example, in U.S. Pat. Nos. 5,683,635 and 6,494,609).

In embodiments where skim coat starch is used, in a two mixer system, the appropriate starch can be tailored in each mixer. Where a single mixer is used, any suitable arrangement can be used. For example, a skim coat stream can exit through a port and outlet in the main body of the mixer, i.e., upstream of the discharge conduit. The skim coat outlet is provided with one or more inlets to allow for introduction of the skim coat starch and any other desired ingredients that vary from the board core slurry exiting the discharge conduit of the mixer. Where the foaming agent is inserted in the discharge conduit, the amount of foaming agent will be reduced or avoided in the skim coat stream since it is removed upstream of where the foaming agent is added, thereby allowing for an increased density in the skim coat layer as desired. If foaming agent is present in the skim coat stream, it can be beaten out by techniques known in the art. In preferred embodiments, the back skim coat layer is formed from the skim coat stream. The face skim coat layer also can be formed from the skim coat stream if desired. In some embodiments, however, the face skim coat layer can be formed from the slurry stream exiting the discharge conduit, which stream is also used to form the board core. Any foam therein can be beaten out if desired to increase the density of the face skim coat layer relative to the board core.

In some embodiments, it will be understood that the discharge conduit can include a slurry distributor with either a single feed inlet or multiple feed inlets, such as those described in U.S. Patent Application Publication 2012/0168527 A1 (application Ser. No. 13/341,016) and U.S. Patent Application Publication 2012/0170403 A1 (application Ser. No. 13/341,209), for example. In those embodiments, using a slurry distributor with multiple feed inlets, the discharge conduit can include a suitable flow splitter, such as those described in U.S. Patent Application Publication 2012/0170403 A1.

Board is formed in a sandwich structure, normally concurrently and continuously, as will be understood in the art. The face cover sheet travels as a continuous ribbon on a moving conveyor. After being discharged from its mixer, a face skim coat layer slurry is applied to the (e.g., moving) face cover sheet. Also, hard edges, as known in the art, can be formed, e.g., from the same slurry stream forming the skim coat layer (e.g., the face and/or back skim coat layer) for convenience, if desired.

The board core slurry is then applied over the skim coat layer and covered with a second cover sheet (typically the “back” cover sheet) to form a wet assembly in the form of a sandwich structure that is a board precursor to the final product. The back (bottom) cover sheet can bear a back skim coat layer, which can optionally contain the skim coat starch as described herein to enhance bonding between the back paper and the board core. The back skim coat layer can be formed from the same or different gypsum slurry as for the face skim coat layer. In some embodiments, the skim coat layer is applied on the back side of the board, i.e., in bonding relation to the bottom (back) cover sheet but no skim coat layer is applied between the core and the top cover sheet.

The back cover sheet (back paper facer sheet) may be perforated before the back cover sheet is contacted with the gypsum slurry. The back cover sheet may be sourced/acquired from a manufacturer with the perforations already present, or the perforations may be introduced just prior to contacting the back cover sheet with the gypsum slurry. As such, the perforations do not extend into the board core layer or the gypsum slurry prior to setting. For example, the plurality of perforations may be introduced using a suitable wallboard perforation apparatus, such as that described in U.S. Patent Application Publication 2018/0065336. It is to be appreciated that any suitable wallboard perforation apparatus may be used, however.

In some embodiments, a starch layer is present on at least one cover sheet, particularly upon the back cover sheet, to increase adhesion thereto. The starch layer may be pre-coated to the inner surface of at least one of the front paper cover sheet and the back cover sheet. In the alternative the methods may further comprise applying the starch layer to the inner surface of at least one of the front paper cover sheet and the back cover sheet. The starch may be applied to the inner surface(s) as a continuous starch layer, as defined above. More particularly, the starch may be applied to the inner surface(s) of the front paper cover sheet and/or the back paper cover sheet in an amount from about 0.5-15 lbs./MSF, preferably about 0.5-5 lbs./MSF, more preferably about 1 lb/MSF to about 2 lbs/MSF. Suitable methods for applying the starch layer upon either the back paper cover sheet or the front paper cover sheet may include, for example, spraying, painting, inkjet printing, stenciling, stencil printing, roller coating, dip coating (immersion), or the like.

In some embodiments, the face paper (which is face down at the wet end of the board machine) can be made to be slightly wider than the width of the final board product since the edges of the paper can be folded up and over the edges of the board to meet the back paper (face up at the wet end of the board machine) to form a board envelope. For example, for nominal 48 inch wide board, the face paper can have a width of about 50 inches or more (e.g., from about 50 to about 52 inches, such as about 50.375 inches). Correspondingly, in some embodiments, the back paper can be made to be narrower than the width of the board. Thus, for nominal 48 inch wide board, the back paper can have a width of less than about 48 inches (e.g., from about 46.5 inches to about 47.5 inches, such as about 47.125 inches).

The wet assembly thereby provided is conveyed to a forming station where the product is sized to a desired thickness (e.g., via forming plate), and to one or more knife sections where it is cut to a desired length. The wet assembly is allowed to harden to form the interlocking crystalline matrix of set gypsum, and excess water is removed using a drying process (e.g., by transporting the assembly through a kiln).

It also is common in the manufacture of gypsum board to use vibration in order to eliminate large voids or air pockets from the deposited slurry. Each of the above steps, as well as processes and equipment for performing such steps, are known in the art.

It has been found that the presence of high concentrations of salt impurities in the stucco slurry can lead to complications in the drying process. As noted herein, after the ribbon of board precursor is significantly set, it is cut into segments and dried in a kiln. The kiln normally is equipped with one or more moisture sensors, which communicate with a programmable logic controller to provide a moisture reading (e.g., by percentage of moisture). The moisture value is then used to adjust the degree of heating in the kiln, e.g., automatically through the programmable logic controller or manually by a board line operator. However, it has been found that a high salt impurity concentration in the stucco can cause the sensors to produce false moisture readings, generally higher than the true moisture value. This can lead to over-heating the board (e.g., by excessive duration and/or temperature in the kiln).

Over-drying the board can lead to board quality problems such as splitting and can further exacerbate poor bond between the primary gypsum layer(s) and one or both cover sheets of the board. When the board is heated too much, a portion of the set gypsum can undesirably calcine to re-form calcium sulfate hemihydrate adjacent to one or both cover sheets, which can cause the cover sheet to split away from the primary gypsum layer(s). Thus, while achieving good bond between the cover sheets and the gypsum layers in the presence of the salt impurities is difficult, over-heating the board when driving off excess water compounds this difficulty.

In some embodiments, to compensate and adjust for the presence of the salt impurities in the stucco slurry, additional moisture sensors are provided upstream and/or downstream of the kiln. The sensors are in communication with a programmable logic controller (often referred to in the art as a PLC). The moisture values between the two upstream sensors and/or the moisture values between the two downstream sensors can be correlated to determine whether there is a delta between either or both of the sets of readings. If a delta is found, heating inside the kiln can be adjusted manually or automatically by the controller to avoid over-drying. The drying process according to some embodiments of the invention therefore allows for determining whether an elevated salt content is present in the board precursor such that it interferes with the moisture readings of in-kiln sensors, and also allows for adjustments in drying to correct for any errors caused by the salt content.

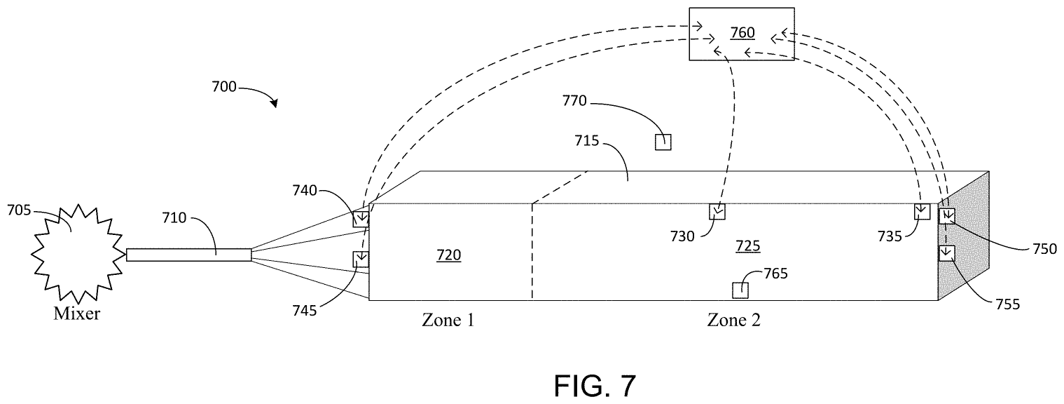

For example, FIG. 7 schematically illustrates one embodiment of suitable arrangement. A manufacturing line 700 contains a mixer 705 at the wet end of the line. After the stucco slurries for the board core and skim coat layer(s), respectively, are laid down between the cover sheets to form a continuous ribbon of board precursor, the ribbon travels down the line on a conveyor 710 and is cut into segments, e.g., at a knife.

A kiln 715 contains as many drying zones as desired, e.g., with one or more heat source such as a burner therein. Two drying zones 720 and 725 are represented in FIG. 7. However, the kiln 715 can alternatively contain one zone, or more than two zones as desired (e.g., up to 24-36 or more zones as desired). Each zone can be individually tailored to a desired heating environment if desired. The kiln 715 contains two in-kiln moisture sensors 730 and 735, both located within zone 725. The in-kiln moisture sensors 730 and 735 are selected to be able to withstand the demanding heating environment in the kiln 715. For example, the in-kiln moisture sensors 730 and 735 can be in the form of radio-frequency sensors that are durable enough to handle the heating environment in the kiln 715 but are susceptible to false moisture readings when a high salt concentration is present in the stucco slurry used for making the gypsum layers.

An upstream radio-frequency moisture sensor 740 and upstream sensor that is less influenced by high salt concentrations 745 (as compared with the radio-frequency sensor) are arranged to measure moisture content immediately before the cut ribbon passes into the kiln 715. A downstream radio-frequency moisture sensor 750 and downstream sensor 755 that is less influenced by high salt concentration are optionally provided and arranged to measure moisture content immediately in the cut ribbon after it passes through the kiln 715. Each sensor 730, 735, 740, 745, 750, and 755 is in communication with a programmable logic controller 760, which can be equipped with known memory hardware as desired. Signals can be sent back and forth between controller 760 and the sensors 730, 735, 740, 745, 750, and 755. The controller 760 is also used to make adjustments with various controls in the kiln, e.g., to adjust heat for the drying process.

The inventors have found that the in-kiln radio-frequency moisture sensors 730 and 735 can be influenced by salt impurity content associated with the stucco such that inaccurate moisture readings can be produced. For example, the sensors 730 and 735 can inaccurately identify more moisture than is actually present, thereby leading to over-drying and a decrease in quality of board generated in the manufacturing process, as well as an increase in the incidence of unsatisfactory, defective, or culled board. To adjust for the false moisture readings from the in-kiln radio-frequency sensors 730 and 735, the upstream sensors 740 and 745 and/or the downstream sensors 750 and 755 are deployed to operate with the controller 760 to make adjustments to the heating in the kiln 715.

The upstream radio-frequency sensor 740 may also be influenced by the high salt content associated with the stucco, if present, but the other upstream sensor is selected to be less influenced by salt. Thus, the respective moisture readings produced by the upstream sensors 740 and 745 can be correlated, e.g., manually or by controller 760 to determine whether there is any delta (difference) between them. If the values are correlated without any discrepancy, this indicates that the content of salt impurities in the board is negligible and no adjustments are required. In that case, heating in the kiln 715 can proceed using the raw values for moisture produced by the in-kiln sensors 730 and 735.

If, however, there is a delta between the moisture values produced by upstream sensors 740 and 745, that indicates that salt impurities are present and the moisture values produced by the radio-frequency sensor 740 can be tainted such that the in-kiln radio-frequency sensors 730 and 735 will be inaccurate. To compensate, the controller 760 can be used to bias the moisture values produced by sensors 730 and 735 such that the heating control regime communicating with controller 760 can be adjusted to the correct heating parameters and avoid improper drying (e.g., over-drying).

Similarly, moisture readings produced by the downstream sensors 750 and 755 are correlated. If there is no discrepancy between the respective temperature readings, no adjustment is required. But, where there is a difference between the moisture readings, thereby indicating corruption in moisture values due to high salt content, adjustments to the heating regime in communication with controller 760 can be made. In this regard, the kiln 715 has air flow controlling apparatus 765 and burner output 770 that can be modified to adjust the internal temperature in one or more zones of the kiln 715. The burner output 770 uses a scale, e.g., from 0-100 where 100 is the maximum burner output and 0 indicates off. The output 770 drives the burner to change fuel and combustion air to increase or decrease heat.

For example, if there is a delta in the moisture readings produced by downstream sensors 750 and 755, the controller 760 or human line operator can extract more hot air from the kiln to thereby reduce drying temperature and/or reduce temperature set points to decrease heat in the kiln 715. Thus, if present, both downstream sensors 750 and 755 send a moisture reading to the controller 760, which can calculate whether there is a difference. If needed, the controller 760 can change a moisture set point accordingly. The change in the moisture set point can change either air extraction or burner output to change temperature in the kiln 715. These calculations and adjustments can also be made manually in some embodiments.

Radio-frequency moisture sensors can create a dielectric reading. Such sensors can be made to withstand the temperatures within the kiln 715. Suitable radio-frequency sensors are commercially available from, for example, Sensortech Systems, Oxnard, Calif. The sensors that are less influenced by high salt content (e.g., associated with the stucco) can be in the form of microwave or X-ray technology, etc. These types of sensors may not be able to withstand the rigors of the heating environment within the kiln. Preferred sensors that are less influenced by salt content are microwave sensors. While not wishing to be bound by any particular theory, it is believed that microwave based sensors measure vibration of water molecules and are not as susceptible to being corrupted by the presence of high levels of salt. Microwave based sensors are commercially available, for example, from TEWS, Hamburg, Germany.

The invention is further illustrated by the following exemplary clauses. However, the invention is not limited by the following clauses.

Clause 1. A gypsum board, method of making a gypsum board, method of drying board, or system for drying a board, as described herein.

Clause 2. A gypsum board comprising: a board core layer comprising set gypsum; a front paper cover sheet having an outer surface and an inner surface, the inner surface contacting a first face of the board core layer; and a back paper cover sheet having an outer surface and an inner surface, the inner surface contacting a second face of the board core layer; wherein the board core layer is disposed between the front paper cover sheet and the back paper cover sheet, and the back perforated paper cover sheet comprises a plurality of perforations extending therethrough; and wherein the board core layer resulted from setting of an aqueous slurry comprising water and stucco between the first cover sheet and the second cover sheet, wherein the stucco comprises calcium sulfate hemihydrate, and the aqueous slurry comprises: at least 60 weight percent of said calcium sulfate hemihydrate on a dry basis, about 500 ppm to about 3000 ppm chloride anion per 1,000,000 parts by weight of said calcium sulfate hemihydrate, and the water at a weight ratio of water to the calcium sulfate hemihydrate of 0.2:1 to 1.2:1.

Clause 3. The gypsum board of clause 2, wherein the front cover sheet is a front paper cover sheet and the back cover sheet is a back paper cover sheet.

Clause 4. The gypsum board of clauses 2 or 3, wherein the plurality of perforations are arranged in a pattern.

Clause 5. The gypsum board of any one of clauses 2-4, wherein the plurality of perforations have a substantially circular shape.

Clause 6. The gypsum board of any one of clauses 2-5, wherein each perforation defines an opening ranging from about 0.005 inches to about 0.1 inches in size.

Clause 7. The gypsum board of any one of clauses 2-6, wherein each perforation defines an opening ranging from about 0.01 inches to about 0.02 inches in size.

Clause 8. The gypsum board of any one of clauses 2-7, wherein the back cover sheet has a perforation coverage density ranging from about 5 perforations/in² to about 50 perforations/in².

Clause 9. The gypsum board of any one of clauses 2-8, wherein the back cover sheet has a perforation coverage density ranging from about 12 perforations/in² to about 25 perforations/in².

Clause 10. The gypsum board of any one of clauses 2-9, wherein the board core layer comprises a low-density region and at least one high-density region, the at least one high-density region being interposed as a layer between the low-density region and the front cover sheet or the back cover sheet.

Clause 11. The gypsum board of clause 10, wherein the low-density region is sandwiched between a first high-density region disposed as a first layer contacting the front cover sheet and a second high-density region disposed as a second layer contacting the back cover sheet.

Clause 12. The gypsum board of clause 10, wherein the low-density region is formed from a foamed gypsum slurry and comprises a plurality of voids therein.

Clause 13. The gypsum board of any one of clauses 2-12, wherein the set gypsum is formed from synthetic gypsum comprising one or more chloride salts and said chloride salts provide at least a portion of said chloride anions.

Clause 14. The gypsum board of clause 13, wherein the aqueous slurry has about 1000 ppm to about 3000 ppm said chloride anion per 1,000,000 parts by weight of said calcium sulfate hemihydrate.

Clause 15. A gypsum board comprising: a board core layer comprising set gypsum, a front paper cover sheet having an outer surface and an inner surface, the inner surface contacting a first face of the board core; and a back paper cover sheet having an outer surface and an inner surface, the inner surface contacting a second face of the board core; wherein the inner surface of at least one of the front paper cover sheet and the back paper cover sheet is coated with a starch layer; wherein the core layer is between the first cover sheet and the second cover sheet, wherein the core layer resulted from setting, between the front paper cover sheet and the back cover sheet, an aqueous slurry comprising a mixture of water and stucco, wherein the stucco comprises calcium sulfate hemihydrate, wherein the aqueous slurry comprises: at least 60 weight percent said calcium sulfate hemihydrate on a dry basis, about 500 ppm to about 3000 ppm chloride anion per 1,000,000 parts by weight said calcium sulfate hemihydrate, and said water at a weight ratio of water to the calcium sulfate hemihydrate of 0.2:1 to 1.2:1.

Clause 16. The gypsum board of clause 15, wherein the starch layer is a continuous starch layer on the entire inner surface of at least one of the front paper cover sheet and the back cover sheet.

Clause 17. The gypsum board of clauses 15 or 16, wherein the starch layer comprises uncooked starch.

Clause 18. The gypsum board of any one of clauses 15-17, wherein the starch layer comprises a mixture of uncooked starch and cooked starch.

Clause 19. The gypsum board of any one of clauses 15-18, wherein the aqueous slurry comprises about 1000 ppm to about 3000 ppm chloride anion per 1,000,000 parts by weight said calcium sulfate hemihydrate.

Clause 20. The gypsum board of any one of clauses 15-19, wherein the starch layer is coated on the inner surface of the back cover sheet.

Clause 21. The gypsum board of any one of clauses 15-20, wherein the starch layer is coated on the inner surface of the front paper cover sheet and the inner surface of the back cover sheet.

Clause 22. The gypsum board of any one of clauses 15-21, wherein the front paper cover sheet is a front paper cover sheet and the back paper cover sheet is a back paper cover sheet.

Clause 23. The gypsum board of any one of clauses 15-22, wherein the board core comprises a low-density region and at least one high-density region, the at least one high-density region being interposed as a layer between the low-density region and the front paper cover sheet or the back cover sheet.

Clause 24. The gypsum board of clause 23, wherein the low-density region is sandwiched between a first high-density region disposed as a first layer contacting the front paper cover sheet or a starch layer coated thereon and a second high-density region disposed as a second layer contacting the back paper cover sheet or a starch layer coated thereon.

Clause 25. The gypsum board of clause 23, wherein the low-density region is formed from a foamed gypsum slurry and comprises a plurality of voids therein.

Clause 26. The gypsum board of any one of clauses 15-25, wherein the starch layer is coated on the inner surface in an amount from about 0.5 lb/MSF to about 15 lbs/MSF.

Clause 27. The gypsum board of any one of clauses 15-26, wherein the set gypsum is formed from synthetic gypsum comprising the one or more chloride salts.

Clause 28. A composite gypsum board comprising: (a) a board core comprising set gypsum formed from a first slurry comprising water and stucco containing a high salt impurity content, the core defining first and second core faces; (b) a skim coat layer defining first and second skim coat faces, the skim coat formed from a second slurry comprising water, the stucco, and a skim coat starch, the skim coat disposed in bonding relation to the first core face; (c) a back cover sheet, the first face of the skim coat layer facing the back cover sheet, and the second face of the skim coat layer facing the board core, wherein the skim coat starch enhances the bond between the board core and the back cover sheet.

Clause 29. The composite gypsum board of clause 28, wherein the board further comprises a face cover sheet, the second face of the board core facing the face cover sheet.

Clause 30. The composite gypsum board of clause 29, wherein the board further comprises: a second skim coat layer defining first and second faces, the second skim coat layer formed from a third slurry comprising water, the stucco, and, the skim coat starch, the first face of the second skim coat layer facing the second face of the board core, and the second face of the second skim coat layer facing the second cover sheet, wherein the skim coat starch enhances the bond between the board core and the face cover sheet, and the second and third slurries can be the same or different.

Clause 31. The composite gypsum board of any one of clauses 28-30, wherein the first and/or second skim coat layer has a dry thickness of from about 0.125 inches (⅛ inch) to about 0.016 inches ( 1/64 inch), such as from about 0.08 inches ( 1/12 inch) to about 0.03 inches ( 1/32 inch).

Clause 32. The composite gypsum board of any one of clauses 28-31, wherein the skim coat starch is present in an amount of from about 0.3% to about 8.0% by weight of the stucco, e.g., from about 1.0% to about 4.0% by weight of the stucco, in the second and/or third slurries.

Clause 33. The composite gypsum board of any one of clauses 28-32, wherein the high salt impurity comprises at least about 150 ppm chloride anion per 1,000,000 parts by weight of said calcium sulfate hemihydrate.

Clause 34. The composite gypsum board of any one of clauses 28-33, wherein the salt impurity comprises a chloride salt, such as sodium chloride, magnesium chloride, or calcium chloride.

Clause 35. The composite gypsum board of any one of clauses 28-34, wherein the first slurry comprises core starch comprising a pregelatinized starch and/or a migrating starch having a molecular weight of about 6,000 Daltons or less.

Clause 36. The composite gypsum board of any one of clauses 28-35, wherein the skim coat starch includes an uncooked starch having (i) a hot water viscosity of from about 20 BU to about 300 BU according to the hot water viscosity assay (HWVA method), and/or (ii) a mid-range peak viscosity of from about 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

Clause 37. The composite gypsum board of any one of clauses 28-36, wherein the skim coat starch includes a pregelatinized starch having a viscosity of from about 20 centipoise to about 700 (such as from about 20 centipoise to about 300 centipoise or from about 30 centipoise to about 200 centipoise) when the viscosity is measured while the starch is subjected to conditions according to the VMA method.

Clause 38. A gypsum board comprising a set gypsum core disposed between a face cover sheet and a back cover sheet, the set gypsum core formed from a slurry comprising water, stucco, and a high salt impurity content, at least one of the cover sheets being high absorption paper.

Clause 39. The gypsum board of clause 38, further comprising a face skim coat disposed between the face cover sheet and the set gypsum core.

Clause 40. The gypsum board of clauses 38 or 39, further comprising a back skim coat disposed between the back cover sheet and the set gypsum core.

Clause 41. The gypsum board of any one of clauses 39-40, wherein the back cover sheet is high absorption paper.

Clause 42. The gypsum board of any one of clauses 39-41, wherein the face and/or back skim coat has a dry thickness of from about 0.125 inches (⅛ inch) to about 0.016 inches ( 1/64 inch), such as from about 0.08 inches ( 1/12 inch) to about 0.03 inches ( 1/32 inch).

Clause 43. The gypsum board of any one of clauses 39-42, wherein the high salt impurity comprises at least about 150 ppm chloride anion per 1,000,000 parts by weight of said stucco.

Clause 44. The gypsum board of any one of clauses 39-43, wherein the salt impurity comprises a chloride salt, such as sodium chloride, potassium chloride, magnesium chloride, or calcium chloride.

Clause 45. The gypsum board of any one of clauses 39-44, wherein the high absorption paper has a bond side Cobb value of at least about 2.1 g/100 cm² according to the Cobb test.

Clause 46. The gypsum board of any one of clauses 39-45, wherein the high absorption paper has a bond side Cobb value of from about 2.1 g/100 cm² to about 3.1 g/100 cm² according to the Cobb test.

Clause 47. The gypsum board of any one of clauses 39-46, wherein the high absorption paper has a basis weight of from about 35 lb/MSF to about 65 lb/MSF, such as from about 38 lb/MSF to about 60 lb/MSF, e.g., from about 42 lb/MSF to about 55 lb/MSF.

Clause 48. The gypsum board of any one of clauses 39-47, wherein the high absorption paper has a caliper of from about 10 mils to about 15 mils.

Clause 49. A gypsum board comprising a set gypsum core disposed between a face cover sheet and a back cover sheet, the set gypsum core formed from a slurry comprising water, stucco, and a high salt impurity content, the board comprising at least one of the following: (a) at least one of the cover sheets, preferably the back cover sheet, being perforated; (b) at least one of the cover sheets, preferably the back cover sheet, being in the form of high absorption paper; (c) starch included between the set gypsum core and at least one of the cover sheets, preferably between at least the back cover sheet and the set gypsum core; and (d) (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 50. The board of clause 49, wherein the high salt impurity comprises at least about 150 ppm chloride anion per 1,000,000 parts by weight of said stucco.

Clause 51. The board of clauses 49 or 50, wherein the salt impurity comprises a chloride salt, such as sodium chloride, potassium chloride, magnesium chloride, or calcium chloride.

Clause 52. The board of any one of clauses 49-51, wherein at least one of the first slurry, the second slurry, and/or third slurry contains boric acid.

Clause 53. The board of clause 52, wherein the boric acid is in an amount of from about 0.01% to about 0.5% by weight of the stucco, e.g., from about 0.05% to about 0.3% by weight of the stucco.

Clause 54. The board of any of clauses 49-53, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 55. The board of any one of clauses 49-54, wherein at least one of the first slurry, the second slurry, and/or third slurry contains polyphosphate.

Clause 56. The board of clause 55, wherein the polyphosphate is sodium trimetaphosphate.

Clause 57. The board of any one of clauses 49-56, wherein at least one of the first slurry, the second slurry, and/or third slurry contains retarder.

Clause 58. The gypsum board of any one of clauses 49-57, wherein the board comprises perforations in the back cover sheet; and the back cover sheet in the form of high absorption paper.

Clause 59. The gypsum board of any one of clauses 49-58, wherein the board comprises perforations in the back cover sheet; and starch included between the set gypsum core and at least one of the cover sheets, preferably between at least the back cover sheet and the set gypsum core.

Clause 60. The gypsum board of any one of clauses 49-59, wherein the board comprises perforations in the back cover sheet; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 61. The gypsum board of any one of clauses 49-59, wherein the board comprises the back cover sheet in the form of high absorption paper; and starch included between the set gypsum core and at least one of the cover sheets, preferably between at least the back cover sheet and the set gypsum core.

Clause 62. The gypsum board of any one of clauses 49-59, wherein the board comprises the back cover sheet in the form of high absorption paper; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 63. The gypsum board of any one of clauses 49-59, wherein the board comprises starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 64. The gypsum board of any one of clauses 49-59, wherein the board comprises perforations in the back cover sheet; the back cover sheet in the form of high absorption paper; and starch included between the set gypsum core and at least one of the cover sheets, preferably between at least the back cover sheet and the set gypsum core.

Clause 65. The gypsum board of any one of clauses 49-59, wherein the board comprises perforations in the back cover sheet; the back cover sheet is the form of absorption paper; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 66. The gypsum board of any one of clauses 49-59, wherein the board comprises perforations in the back cover sheet; starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 67. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 68. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 69. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 70. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 71. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 72. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 73. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 74. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 75. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 76. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 77. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 78. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 79. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 80. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 81. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 82. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 83. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, the second slurry, and/or third slurry contains polyphosphate.

Clause 84. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 85. The gypsum board of any one of clauses 49-59, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, the second slurry, and/or third slurry contains retarder.

Clause 86. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 87. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 88. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 89. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 90. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 91. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 92. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 93. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 94. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 95. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 96. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 97. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 98. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 99. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 100. The gypsum board of any one of clauses 49-59, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 101. The gypsum board of any one of clauses 49-59, wherein the board comprises perforations in the back cover sheet; the back cover sheet in the form of high absorption paper; and boric acid in an amount of, for example, from about 0.01% to about 0.5% by weight of the stucco, e.g., from about 0.05% to about 0.3% by weight of the stucco.

Clause 102. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 103. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 104. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 105. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 106. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 107. The gypsum board of any one of clauses 49-59, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 108. The gypsum board of any one of clauses 49-59, wherein the board comprises perforations in the back cover sheet; the back cover sheet in the form of high absorption paper; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 109. The gypsum board of any one of clauses 49-59, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 110. The gypsum board of any one of clauses 49-59, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 111. The gypsum board of any one of clauses 49-59, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 112. The gypsum board of any one of clauses 49-59, wherein the board comprises perforations in the back cover sheet; the back cover sheet in the form of high absorption paper; and at least one of the first slurry, the second slurry, and/or third slurry contains polyphosphate.

Clause 113. The gypsum board of any one of clauses 49-59, wherein the board comprises perforations in the back cover sheet; the back cover sheet in the form of high absorption paper; at least one of the first slurry, the second slurry, and/or third slurry contains polyphosphate; and at least one of the first slurry, the second slurry, and/or third slurry contains retarder.

Clause 114. The gypsum board of any one of clauses 49-59, wherein the board comprises perforations in the back cover sheet; the back cover sheet in the form of high absorption paper; and at least one of the first slurry, the second slurry, and/or third slurry contains retarder.

Clause 115. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 116. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 117. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 118. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 119. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 120. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 121. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder

Clause 122. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 123. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 124. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 125. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 126. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 127. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 128. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 129. The gypsum board of any one of clauses 49-59, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 130. The gypsum board of any one of clauses 49-59, wherein the board comprises perforations in the back cover sheet; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 131. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 132. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 133. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 134. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 135. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 136. The gypsum board of any one of clauses 49-59, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 137. The gypsum board of any one of clauses 49-59, wherein the board comprises perforations in the back cover sheet; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 138. The gypsum board of any one of clauses 49-59, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 139. The gypsum board of any one of clauses 49-59, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 140. The gypsum board of any one of clauses 49-59, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 141. The gypsum board of any one of clauses 49-59, wherein the board comprises perforations in the back cover sheet; starch included between the set gypsum core and at least one of the cover sheets, preferably between at least the back cover sheet and the set gypsum core; and at least one of the first slurry, the second slurry, and/or third slurry contains polyphosphate.

Clause 142. The gypsum board of any one of clauses 49-59, wherein the board comprises perforations in the back cover sheet; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 143. The gypsum board of any one of clauses 49-59, wherein the board comprises perforations in the back cover sheet; starch included between the set gypsum core and at least one of the cover sheets, preferably between at least the back cover sheet and the set gypsum core; and at least one of the first slurry, the second slurry, and/or third slurry contains retarder.

Clause 144. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 145. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 146. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 147. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 148. The gypsum board of any one of clauses 49-597, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 149. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 50. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 152. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 152. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 153. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 154. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 155. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 156. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 157. The gypsum board of any one of clauses 49-59, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 158. The gypsum board of any one of clauses 49-59, wherein the board comprises perforations in the back cover sheet; and boric acid in an amount of, for example, from about 0.01% to about 0.5% by weight of the stucco, e.g., from about 0.05% to about 0.3% by weight of the stucco.

Clause 159. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 160. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 161. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 162. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 163. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 164. The gypsum board of any one of clauses 49-59, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 165. The gypsum board of any one of clauses 49-59, wherein the board comprises perforations in the back cover sheet; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 166. The gypsum board of any one of clauses 49-59, wherein the board comprises perforations in the back cover sheet; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 167. The gypsum board of any one of clauses 49-59, wherein the board comprises perforations in the back cover sheet; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 168. The gypsum board of any one of clauses 49-59, wherein the board comprises perforations in the back cover sheet; and at least one of the first slurry, the second slurry, and/or third slurry contains polyphosphate.

Clause 169. The gypsum board of any one of clauses 49-59, wherein the board comprises perforations in the back cover sheet; at least one of the first slurry, the second slurry, and/or third slurry contains polyphosphate; and at least one of the first slurry, the second slurry, and/or third slurry contains retarder.

Clause 170. The gypsum board of any one of clauses 49-59, wherein the board comprises perforations in the back cover sheet; and at least one of the first slurry, the second slurry, and/or third slurry contains retarder.

Clause 171. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 172. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 173. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 174. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 175. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 176. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 177. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 178. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 179. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 180. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 181. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 182. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 183. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 184. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 185. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 186. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 187. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 188. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 189. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 190. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 191. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 192. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 193. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 194. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 195. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 196. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; and at least one of the first slurry, the second slurry, and/or third slurry contains polyphosphate.

Clause 197. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 198. The gypsum board of any one of clauses 49-59, wherein the board comprises the back cover sheet in the form of high absorption paper; starch included between the set gypsum core and at least one of the cover sheets, preferably between at least the back cover sheet and the set gypsum core; and at least one of the first slurry, the second slurry, and/or third slurry contains retarder.

Clause 199. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 200. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 201. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 202. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 203. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 204. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 205. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 206. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 207. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 208. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 209. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 210. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 211. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 212. The gypsum board of any one of clauses 49-59, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 213. The gypsum board of any one of clauses 49-59, wherein the board comprises the back cover sheet in the form of high absorption paper; and boric acid in an amount of, for example, from about 0.01% to about 0.5% by weight of the stucco, e.g., from about 0.05% to about 0.3% by weight of the stucco.

Clause 214. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 215. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 216. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 217. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 218. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 219. The gypsum board of any one of clauses 49-59, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 220. The gypsum board of any one of clauses 49-59, wherein the board comprises the back cover sheet in the form of high absorption paper; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 221. The gypsum board of any one of clauses 49-59, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 222. The gypsum board of any one of clauses 49-59, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 223. The gypsum board of any one of clauses 49-59, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 224. The gypsum board of any one of clauses 49-59, wherein the board comprises the back cover sheet in the form of high absorption paper; and at least one of the first slurry, the second slurry, and/or third slurry contains polyphosphate.

Clause 225. The gypsum board of any one of clauses 49-59, wherein the board comprises the back cover sheet in the form of high absorption paper; at least one of the first slurry, the second slurry, and/or third slurry contains polyphosphate; and at least one of the first slurry, the second slurry, and/or third slurry contains retarder.

Clause 226. The gypsum board of any one of clauses 49-59, wherein the board comprises the back cover sheet in the form of high absorption paper; and at least one of the first slurry, the second slurry, and/or third slurry contains retarder.

Clause 227. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 228. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 229. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 230. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 231. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 232. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 233. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 234. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 235. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 236. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 237. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 238. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 239. The gypsum board of any one of clauses 49-59, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 240. The gypsum board of any one of clauses 49-59, wherein the board comprises starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 241. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 242. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 243. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 244. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 245. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 246. The gypsum board of any one of clauses 49-59, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 247. The gypsum board of any one of clauses 49-59, wherein the board comprises starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 248. The gypsum board of any one of clauses 49-59, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 249. The gypsum board of any one of clauses 49-59, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 250. The gypsum board of any one of clauses 49-59, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 251. The gypsum board of any one of clauses 49-59, wherein the board comprises starch included between the set gypsum core and at least one of the cover sheets, preferably between at least the back cover sheet and the set gypsum core; and at least one of the first slurry, the second slurry, and/or third slurry contains polyphosphate.

Clause 252. The gypsum board of any one of clauses 49-59, wherein the board comprises starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 253. The gypsum board of any one of clauses 49-59, wherein the board comprises starch included between the set gypsum core and at least one of the cover sheets, preferably between at least the back cover sheet and the set gypsum core; and at least one of the first slurry, the second slurry, and/or third slurry contains retarder.

Clause 254. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 255. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 256. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 257. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 258. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 259. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 260. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 261. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 262. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 263. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 264. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 265. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 266. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 267. The gypsum board of any one of clauses 49-59, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 268. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 269. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 270. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 271. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 272. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 273. The gypsum board of any one of clauses 49-59, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 274. The gypsum board of any one of clauses 49-59, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 275. The gypsum board of any one of clauses 49-59, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 276. The gypsum board of any one of clauses 49-59, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 277. The gypsum board of any one of clauses 49-59, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 278. The gypsum board of any one of clauses 49-59, wherein at least one of the first slurry, the second slurry, and/or third slurry contains polyphosphate; and at least one of the first slurry, the second slurry, and/or third slurry contains retarder.

Clause 279. A method of making a gypsum board, comprising: preparing an aqueous slurry comprising a mixture of water and stucco, wherein the stucco comprises calcium sulfate hemihydrate and the aqueous slurry comprises a mixture of: at least 60 weight percent of said calcium sulfate hemihydrate on a dry basis, about 500 ppm to about 3000 ppm chloride anion per 1,000,000 parts by weight of said calcium sulfate hemihydrate, and the water at a weight ratio of water to the calcium sulfate hemihydrate of 0.2:1 to 1.2:1; disposing the aqueous slurry between a front cover sheet and a back cover sheet, each cover sheet having an inner surface and an outer surface; wherein the back cover sheet comprises a plurality of perforations extending therethrough, and the aqueous slurry contacts the inner surfaces of the front cover sheet and the back cover sheet; setting the calcium sulfate hemihydrate to form a panel comprising a board core layer comprising calcium sulfate dihydrate; drying the panel and cutting the panel into a gypsum board having one or more pre-determined dimensions.

Clause 280. The method of clause 279, further comprising: introducing the plurality of perforations to the back cover sheet with a wallboard perforating apparatus.

Clause 281. The method of clauses 279 or 280, wherein the plurality of perforations are present in the back cover sheet before the back cover sheet contacts the aqueous slurry.

Clause 282. The method of any one of clauses 279-281, wherein the paper for the back paper cover sheet is fed from a roller with the plurality of perforations present in the back cover sheet before the back cover sheet contacts the aqueous slurry.

Clause 283. The method of any one of clauses 279-282, wherein at least a portion of the aqueous slurry is in a foamed state while being disposed between the front cover sheet and the back cover sheet.

Clause 284. The method of any one of clauses 279-283, wherein the calcium sulfate hemihydrate comprises synthetic gypsum comprising one or more chloride salts, and said one or more chloride salts provide at least a portion of said chloride anions.

Clause 285. A method of making a gypsum board, comprising: preparing an aqueous slurry comprising a mixture of water and stucco, wherein the stucco comprises calcium sulfate hemihydrate, wherein the aqueous slurry comprises a mixture of: at least 60 weight percent said calcium sulfate hemihydrate on a dry basis, about 500 ppm to about 3000 ppm chloride anion per 1,000,000 parts by weight (pbw) said calcium sulfate hemihydrate, and the water at a weight ratio of water to the calcium sulfate hemihydrate of 0.2:1 to 1.2:1; and disposing the aqueous slurry between a front paper cover sheet and a back cover sheet, each cover sheet having an inner surface and an outer surface; wherein the inner surface of at least one of the front paper cover sheet and the back paper cover sheet is coated with a starch layer, wherein the aqueous slurry contacts the starch layer; setting the calcium sulfate hemihydrate to form a panel comprising a gypsum core comprising calcium sulfate dihydrate; and drying the panel and cutting the panel into a gypsum board having one or more pre-determined dimensions.

Clause 286. The method of clause 285, further comprising: applying the starch layer to the inner surface of at least one of the front paper cover sheet and the back paper cover sheet as a continuous starch layer covering the entire inner surface.

Clause 287. The method of clauses 285 or 286, further comprising: applying the starch layer to the inner surface of at least one of the front paper cover sheet and the back paper cover sheet as a continuous starch layer covering the entire inner surface, wherein the back paper cover sheet has perforations.

Clause 288. The method of any one of clauses 285-287, wherein at least a portion of the gypsum slurry is in a foamed state while being disposed between the front paper cover sheet and the back cover sheet.

Clause 289. The method of any one of clauses 285-288, wherein a first portion of the gypsum slurry is disposed in an unfoamed state as a first high-density region in layer form contacting the front paper cover sheet or a starch layer thereon and a second portion of the gypsum slurry is disposed in a foamed state as a low-density region contacting the first high-density region.

Clause 290. The method of any one of clauses 285-289 wherein the calcium sulfate hemihydrate comprises synthetic gypsum comprising the one or more chloride salts.

Clause 291. A method of making composite gypsum board, the method comprising: (a) mixing at least water and stucco containing a high salt impurity content to form a core slurry; (b) mixing at least water, stucco, and, optionally a skim coat starch to form a face skim coat slurry; (c) disposing the face skim coat slurry in a bonding relation to a face cover sheet to form a face composite having a slurry surface and a cover sheet surface; (d) disposing the core slurry in a bonding relation to the face composite to form a core composite, the core slurry forming a board core having first and second faces, the first face facing the slurry surface of the face composite; (e) mixing water, stucco, and skim coat starch to form a back skim coat slurry, wherein the face and back skim coat slurries can be the same or different; (f) disposing the back skim slurry in bonding relation to a back cover sheet to form a back composite having a slurry surface and a cover sheet surface; (g) disposing the back composite in a bonding relation to the core composite to form a board precursor, wherein the slurry surface of the back composite faces the second face of the core; and (h) drying the board precursor to form a board, wherein the skim coat starch enhances the bond between the board core and the back cover sheet, and optionally between the board core and the first cover sheet.

Clause 292. The method of clause 291, wherein the core starch is pregelatinized starch in an amount of from about 0.5% to about 1.5% by weight of the stucco, and the skim coat starch is uncooked starch in an amount of from about 1.5% to about 5% by weight of the stucco.

Clause 293. The method of clauses 291 or 292, wherein the first and/or second skim coat layer has a dry thickness of from about 0.125 inches (⅛ inch) to about 0.016 inches ( 1/64 inches), such as from about 0.083 inches ( 1/12 inch) to about 0.031 inches ( 1/32 inch).

Clause 294. The method of any one of clauses 291-293, wherein the skim coat starch is present in an amount of from about 0.3% to about 8.0% by weight of the stucco, e.g., from about 1.0% to about 4.0% by weight of the stucco, in the second and/or third slurries.

Clause 295. The method of any one of clauses 291-294, wherein the first slurry comprises at least about 150 ppm chloride anions per 1,000,000 parts by weight of said calcium sulfate hemihydrate.

Clause 296. The method of any one of clauses 291-295, wherein the salt impurity is a chloride salt, such as sodium chloride, magnesium chloride, or calcium chloride.

Clause 297. The method of any one of clauses 291-296, wherein the core starch includes a pregelatinized starch and/or a migrating starch having a molecular weight of about 6,000 Daltons or less.

Clause 298. The method of any one of clauses 291-297, wherein the skim coat starch includes an uncooked starch having (i) a hot water viscosity of from about 20 BU to about 300 BU according to the hot water viscosity assay (HWVA method), and/or (ii) a mid-range peak viscosity of from about 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for ten minutes, and the starch is cooled to 50° C. at a rate of −3° C./minute.

Clause 299. The method of any one of clauses 291-298, wherein the skim coat starch includes a pregelatinized starch having a viscosity of from about 20 centipoise to about 700 centipoise (such as from about 20 centipoise to about 300 centipoise or from about 30 centipoise to about 200 centipoise) when the viscosity is measured while the starch is subjected to conditions according to the VMA method.

Clause 300. A method of making gypsum board, the method comprising: (a) mixing at least water and stucco containing a high salt impurity content to form a core slurry; (b) disposing the core slurry to form a board core in a bonding relation to a face cover sheet, the board core having a first face and a second face, the first face facing the face cover sheet; (c) applying a back cover sheet in bonding relation to the second face of the board core to form a board precursor, at least one of the cover sheets being high absorption paper; (d) drying the board precursor to form a board.

Clause 301. The method of clause 300, further comprising applying a second slurry comprising at least stucco and water to the face paper to form a face skim coat disposed between the face cover sheet and the board core.

Clause 302. The method of clauses 300 or 301, further comprising applying a third slurry comprising at least stucco and water to the back paper to form a back skim coat disposed between the back cover sheet and the board core, the second and third slurries being the same or different.

Clause 303. The method of any one of clauses 300-302, wherein the back cover sheet is high absorption paper.

Clause 304. The method of any one of clauses 300-303, wherein the face and/or back skim coat has a dry thickness of from about 0.125 inches (⅛ inch) to about 0.016 inches ( 1/64 inch), such as from about 0.08 inches ( 1/12 inch) to about 0.03 inches ( 1/32 inch).

Clause 305. The method of any one of clauses 300-304, wherein the high salt impurity comprises at least about 150 ppm chloride anion per 1,000,000 parts by weight of said stucco.

Clause 306. The method of any one of clauses 300-305, wherein the salt impurity comprises a chloride salt, such as sodium chloride, potassium chloride, magnesium chloride, or calcium chloride.

Clause 307. The method of any one of clauses 300-306, wherein the high absorption paper has a bond side Cobb value of at least about 2.1 g/100 cm² according to the Cobb test.

Clause 308. The method of any one of clauses 300-307, wherein the high absorption paper has a bond side Cobb value of from about 2.1 g/100 cm² to about 3.1 g/100 cm² according to the Cobb test.

Clause 309. The method of any one of clauses 300-308, wherein the high absorption paper has a basis weight of from about 40 lb/MSF to about 65 lb/MSF, such as from about 42 lb/MSF to about 60 lb/MSF, e.g., from about 45 lb/MSF to about 55 lb/MSF.

Clause 310. The method of any one of clauses 300-309, wherein the high absorption paper has a caliper of from about 10 mils to about 15 mils.

Clause 311. A method of making a gypsum board comprising: (a) mixing at least water and stucco containing a high salt impurity content to form a core slurry; (b) mixing at least water, stucco, and, optionally, a skim coat starch to form a face skim coat slurry; (c) disposing the face skim coat slurry in a bonding relation to a face cover sheet to form a face composite having a slurry surface and a cover sheet surface; (d) disposing the core slurry in a bonding relation to the face composite to form a core composite, the core slurry forming a board core having first and second faces, the first face facing the slurry surface of the face composite; (e) mixing water, stucco, and optionally skim coat starch to form a back skim coat slurry, wherein the face and back skim coat slurries can be the same or different; (f) disposing the back skim slurry in bonding relation to a back cover sheet to form a back composite having a slurry surface and a cover sheet surface; (g) disposing the back composite in a bonding relation to the core composite to form a board precursor, wherein the slurry surface of the back composite faces the second face of the core; (h) drying the board precursor in a kiln to form a board; and the method further comprising at least one of the following: (i) perforating at least one of the cover sheets, preferably the back cover sheet; (j) at least one of the cover sheets, preferably the back cover sheet is in the form of high absorption paper; (k) applying starch between the set gypsum core and at least one of the cover sheets, preferably between at least the back cover sheet and the set gypsum core; (1) including skim coat starch in the second and/or third slurries to enhance the bond between the board core and the face and/or back cover sheet respectively, the skim coat starch enhancing the bond between the board core and the face and/or back cover sheets, respectively; and (m) the drying uses a kiln containing at least one in-kiln radio-frequency moisture sensor therein, the in-kiln moisture sensor in communication with a controller outside of the kiln to produce an in-kiln moisture reading, the drying further comprising: (i) measuring moisture content in the board upstream of the kiln using an upstream radio-frequency moisture sensor and an upstream sensor that is less influenced by high salt concentration in the slurry as compared with the radio-frequency moisture sensor, the upstream sensors in communication with the controller to produce a first upstream moisture reading and a second upstream moisture reading, respectively; (ii) correlating the moisture readings from the upstream radio-frequency moisture sensor and the upstream sensor that is less influenced by high salt concentration in the slurry as compared with the radio-frequency moisture sensor; and (iii) biasing the in-kiln radio-frequency moisture sensor when a delta exists between the first and second moisture readings to correct for any errors in the in-kiln moisture reading.

Clause 312. The method of clause 311, wherein the high salt impurity comprises at least about 150 ppm chloride anion per 1,000,000 parts by weight of said stucco.

Clause 313. The method of clauses 311 or 312, wherein the salt impurity comprises a chloride salt, such as sodium chloride, potassium chloride, magnesium chloride, or calcium chloride.

Clause 314. The method of any one of clauses 311-313, wherein at least one of the first slurry, the second slurry, and/or third slurry contains boric acid.

Clause 315. The method of any one clauses 311-314, wherein the boric acid is in an amount of from about 0.01% to about 0.5% by weight of the stucco, e.g., from about 0.05% to about 0.3% by weight of the stucco.

Clause 316. The method of any of clauses 311-315, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 317. The method of any one of clauses 311-316, wherein at least one of the first slurry, the second slurry, and/or third slurry contains polyphosphate.

Clause 318. The method of clause 96, wherein the polyphosphate is sodium trimetaphosphate.

Clause 319. The method of any one of clauses 311-318, wherein at least one of the first slurry, the second slurry, and/or third slurry contains retarder.

Clause 320. The method of any one of clauses 311-319, the drying further comprising: (a) measuring moisture content in the board downstream of the kiln using a downstream radio-frequency moisture sensor and a downstream sensor that is less influenced by high salt concentration in the slurry as compared with the radio-frequency moisture sensor, the downstream radio-frequency and microwave sensors in communication with the controller to produce a first downstream moisture reading and used to bias a second upstream moisture reading; (b) correlating the moisture readings from the downstream radio-frequency moisture sensor and the downstream sensor that is less influenced by high salt concentration in the slurry as compared with the radio-frequency moisture sensor; and (c) adjusting the burner output and/or air apparatus to adjust the temperature in the kiln to reduce heating therein.

Clause 321. The method of clause 320, wherein the set point controls the burner output/temperature and/or air flow in the kiln.

Clause 322. The method of any one of clauses 311-321, wherein at least one of the sensors that is less influenced by high salt concentration in the slurry as compared with the radio-frequency moisture sensor is a microwave sensor.

Clause 323. The method of any one of clauses 311-322, wherein at least one of the radio-frequency sensors is a dielectric sensor.

Clause 324. The method of any one of clauses 311-323, wherein the controller is a programmable logic controller.

Clause 325. The method of any one of clauses 311-324, wherein the kiln has one zone.

Clause 326. The method of any one of clauses 311-325, wherein the kiln has at least two zones.

Clause 327. The method of any one of clauses 311-326, wherein the kiln contains at least two in-kiln moisture sensors.

Clause 328. A method of making a gypsum board comprising: (a) mixing at least water, stucco, and foam to form a first slurry; (b) disposing the first slurry between a face cover sheet and a back cover sheet to form a board precursor; (c) cutting the board precursor into a board; (d) drying the board in a kiln containing at least one in-kiln radio-frequency moisture sensor therein, the in-kiln moisture sensor in communication with a controller outside of the kiln to produce an in-kiln moisture reading; (e) measuring moisture content in the board upstream of the kiln using an upstream radio-frequency moisture sensor and an upstream sensor that is less influenced by high salt concentration in the slurry as compared with the radio-frequency moisture sensor, the upstream sensors in communication with the controller to produce a first upstream moisture reading and a second upstream moisture reading, respectively; (f) correlating the moisture readings from the upstream radio-frequency moisture sensor and the upstream sensor that is less influenced by high salt concentration in the slurry as compared with the radio-frequency moisture sensor; and (g) biasing the in-kiln radio-frequency moisture sensor when a delta exists between the first and second moisture readings to correct for any errors in the in-kiln moisture reading.

Clause 329. The method of clause 328, the kiln having a burner output and/or air extraction associated with it, the method further comprising: (a) measuring moisture content in the board downstream of the kiln using a downstream radio-frequency moisture sensor and a downstream sensor that is less influenced by high salt concentration in the slurry as compared with the radio-frequency moisture sensor, the downstream radio-frequency and microwave sensors in communication with the controller to produce a first downstream moisture reading and a second downstream moisture reading, respectively; (b) correlating the moisture readings from the downstream radio-frequency moisture sensor and the downstream sensor that is less influenced by high salt concentration in the slurry as compared with the radio-frequency moisture sensor; and (c) adjusting the burner output and/or air apparatus to adjust the temperature in the kiln to reduce heating therein.

Clause 330. The method of clause 329, wherein the set point controls the burner output, temperature, and/or air flow in the kiln.

Clause 331. The method of any one of clauses 328-330, wherein at least one of the sensors that is less influenced by high salt concentration in the slurry as compared with the radio-frequency moisture sensor is a microwave sensor.

Clause 332. The method of any one of clauses 328-331, wherein at least one of the radio-frequency sensors creates a dielectric reading.

Clause 333. The method of any one of clauses 328-332, wherein the controller is a programmable logic controller.

Clause 334. The method of any one of clauses 328-333, wherein the kiln has one zone.

Clause 335. The method of any one of clauses 328-334, wherein the kiln has at least two zones.

Clause 336. The method of any one of clauses 328-335, wherein the kiln contains at least two in-kiln moisture sensors.

Clause 337. The method of any one of clauses 328-336, wherein the high salt impurity comprises at least about 150 ppm chloride anion per 1,000,000 parts by weight of said stucco.

Clause 338. The method of any one of clauses 328-337, wherein the salt impurity comprises a chloride salt, such as sodium chloride, potassium chloride, magnesium chloride, or calcium chloride.

Clause 339. The method of any one of clauses 328-338, further comprising applying a second slurry comprising at least stucco and water to the face paper to form a face skim coat disposed between the face cover sheet and the board core.

Clause 340. The method of clauses 338 or 339, further comprising applying a third slurry comprising at least stucco and water to the back paper to form a back skim coat disposed between the back cover sheet and the board core, the second and third slurries being the same or different.

Clause 341. The method of any one of clauses 328-340, wherein at least one of the first slurry, the second slurry, and/or third slurry contains boric acid.

Clause 342. The method of clause 341, wherein the boric acid is in an amount of from about 0.01% to about 0.5% by weight of the stucco, e.g., from about 0.05% to about 0.3% by weight of the stucco.

Clause 343. The method of any of clauses 328-342, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 344. The method of any one of clauses 311-343, wherein the board comprises perforations in the back cover sheet; and the back cover sheet in the form of high absorption paper.

Clause 345. The method of any one of clauses 311-343, wherein the board comprises perforations in the back cover sheet; and starch included between the set gypsum core and at least one of the cover sheets, preferably between at least the back cover sheet and the set gypsum core.

Clause 346. The method of any one of clauses 311-343, wherein the board comprises perforations in the back cover sheet; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 347. The method of any one of clauses 311-343, wherein the board comprises the back cover sheet in the form of high absorption paper; and starch included between the set gypsum core and at least one of the cover sheets, preferably between at least the back cover sheet and the set gypsum core.

Clause 348. The method of any one of clauses 311-343, wherein the board comprises the back cover sheet in the form of high absorption paper; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 349. The method of any one of clauses 311-343, wherein the board comprises starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 350. The method of any one of clauses 311-343, wherein the board comprises perforations in the back cover sheet; the back cover sheet in the form of high absorption paper; and starch included between the set gypsum core and at least one of the cover sheets, preferably between at least the back cover sheet and the set gypsum core.

Clause 351. The method of any one of clauses 311-343, wherein the board comprises perforations in the back cover sheet; the back cover sheet is the form of absorption paper; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 352. The method of any one of clauses 311-343, wherein the board comprises perforations in the back cover sheet; starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 353. The method of any one of clauses 311-343, wherein the board comprises the back cover sheet in the form of high absorption paper; starch included between the set gypsum core and at least one of the cover sheets, preferably between at least the back cover sheet and the set gypsum core; and (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

Clause 354. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 355. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 356. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 357. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 358. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 359. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 360. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 361. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 362. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 363. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 364. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 365. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 366. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 367. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 368. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 369. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, the second slurry, and/or third slurry contains polyphosphate.

Clause 370. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 371. The method of any one of clauses 311-343, wherein the board comprises perforations in the back cover sheet; the back cover sheet in the form of high absorption paper; starch included between the set gypsum core and at least one of the cover sheets, preferably between at least the back cover sheet and the set gypsum core; and at least one of the first slurry, the second slurry, and/or third slurry contains retarder.

Clause 372. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 373. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 374. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 375. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 376. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 377. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 378. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 379. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 380. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 381. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 382. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 383. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 384. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 385. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 386. The method of any one of clauses 311-343, wherein the board comprises perforations in the back cover sheet; the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 387. The method of any one of clauses 311-343, wherein the board comprises perforations in the back cover sheet; the back cover sheet in the form of high absorption paper; and boric acid in an amount of, for example, from about 0.01% to about 0.5% by weight of the stucco, e.g., from about 0.05% to about 0.3% by weight of the stucco.

Clause 388. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 389. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 390. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 391. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 392. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 393. The method of any one of clauses 311-343, wherein the board comprises perforations in the back cover sheet; the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 394. The method of any one of clauses 311-343, wherein the board comprises perforations in the back cover sheet; the back cover sheet in the form of high absorption paper; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 395. The method of any one of clauses 311-343, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 396. The method of any one of clauses 311-343, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 397. The method of any one of clauses 311-343, wherein the board comprises perforations in the back cover sheet; the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 398. The method of any one of clauses 311-343, wherein the board comprises perforations in the back cover sheet; the back cover sheet in the form of high absorption paper; and at least one of the first slurry, the second slurry, and/or third slurry contains polyphosphate.

Clause 399. The method of any one of clauses 311-343, wherein the board comprises perforations in the back cover sheet; the back cover sheet in the form of high absorption paper; at least one of the first slurry, the second slurry, and/or third slurry contains polyphosphate; and at least one of the first slurry, the second slurry, and/or third slurry contains retarder.

Clause 400. The method of any one of clauses 311-343, wherein the board comprises perforations in the back cover sheet; the back cover sheet in the form of high absorption paper; and at least one of the first slurry, the second slurry, and/or third slurry contains retarder.

Clause 401. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 402. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 403. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 404. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 405. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 406. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 407. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder

Clause 408. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 409. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 410. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 411. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 412. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 413. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 414. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 415. The method of any one of clauses 311-343, wherein the board comprises perforations in the back cover sheet; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 416. The method of any one of clauses 311-343, wherein the board comprises perforations in the back cover sheet; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 417. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 418. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 419. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 420. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 421. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 422. The method of any one of clauses 311-343, wherein the board comprises perforations in the back cover sheet; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 423. The method of any one of clauses 311-343, wherein the board comprises perforations in the back cover sheet; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 424. The method of any one of clauses 311-343, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 425. The method of any one of clauses 311-343, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 426. The method of any one of clauses 311-343, wherein the board comprises perforations in the back cover sheet; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 427. The method of any one of clauses 311-343, wherein the board comprises perforations in the back cover sheet; starch included between the set gypsum core and at least one of the cover sheets, preferably between at least the back cover sheet and the set gypsum core; and at least one of the first slurry, the second slurry, and/or third slurry contains polyphosphate.

Clause 428. The method of any one of clauses 311-343, wherein the board comprises perforations in the back cover sheet; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 429. The method of any one of clauses 311-343, wherein the board comprises perforations in the back cover sheet; starch included between the set gypsum core and at least one of the cover sheets, preferably between at least the back cover sheet and the set gypsum core; and at least one of the first slurry, the second slurry, and/or third slurry contains retarder.

Clause 430. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 431. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 432. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 433. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 434. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 435. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 436. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 437. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 438. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 439. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 440. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 441. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 442. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 443. The method of any one of clauses 311-343, wherein the board comprises perforations in the back cover sheet; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 444. The method of any one of clauses 311-343, wherein the board comprises perforations in the back cover sheet; and boric acid in an amount of, for example, from about 0.01% to about 0.5% by weight of the stucco, e.g., from about 0.05% to about 0.3% by weight of the stucco.

Clause 445. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 446. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 447. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 448. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 449. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 450. The method of any one of clauses 311-343, wherein the board comprises perforations in the back cover sheet; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 451. The method of any one of clauses 311-343, wherein the board comprises perforations in the back cover sheet; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 452. The method of any one of clauses 311-343, wherein the board comprises perforations in the back cover sheet; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 453. The method of any one of clauses 311-343, wherein the board comprises perforations in the back cover sheet; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 454. The method of any one of clauses 311-343, wherein the board comprises perforations in the back cover sheet; and at least one of the first slurry, the second slurry, and/or third slurry contains polyphosphate.

Clause 455. The method of any one of clauses 311-343, wherein the board comprises perforations in the back cover sheet; at least one of the first slurry, the second slurry, and/or third slurry contains polyphosphate; and at least one of the first slurry, the second slurry, and/or third slurry contains retarder.

Clause 456. The method of any one of clauses 311-343, wherein the board comprises perforations in the back cover sheet; and at least one of the first slurry, the second slurry, and/or third slurry contains retarder.

Clause 457. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 458. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 459. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 460. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 461. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 462. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 463. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 464. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 465. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 466. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 467. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 468. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 469. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 470. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 471. The method of any one of clauses 311-343, wherein the board comprises the back cover sheet in the form of high absorption paper; starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 472. The method of any one of clauses 311-343, wherein the board comprises the back cover sheet in the form of high absorption paper; starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 473. The method of any one of clauses 311-343, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 474. The method of any one of clauses 311-343, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 475. The method of any one of clauses 311-343, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 476. The method of any one of clauses 311-343, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 477. The method of any one of clauses 311-343, wherein the board comprises the back cover sheet in the form of high absorption paper; starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 478. The method of any one of clauses 311-343, wherein the board comprises the back cover sheet in the form of high absorption paper; starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 479. The method of any one of clauses 311-343, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 480. The method of any one of clauses 311-343, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 481. The method of any one of clauses 311-343, wherein the board comprises the back cover sheet in the form of high absorption paper; starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 482. The method of any one of clauses 311-343, wherein the board comprises the back cover sheet in the form of high absorption paper; starch included between the set gypsum core and at least one of the cover sheets, preferably between at least the back cover sheet and the set gypsum core; and at least one of the first slurry, the second slurry, and/or third slurry contains polyphosphate.

Clause 483. The method of any one of clauses 311-343, wherein the board comprises the back cover sheet in the form of high absorption paper; starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 484. The method of any one of clauses 311-343, wherein the board comprises the back cover sheet in the form of high absorption paper; starch included between the set gypsum core and at least one of the cover sheets, preferably between at least the back cover sheet and the set gypsum core; and at least one of the first slurry, the second slurry, and/or third slurry contains retarder.

Clause 485. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 486. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 487. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 488. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 489. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 490. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 491. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 492. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 493. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 494. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 495. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 496. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 497. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 498. The method of any one of clauses 311-343, wherein the board comprises the back cover sheet in the form of high absorption paper; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 499. The method of any one of clauses 311-343, wherein the board comprises the back cover sheet in the form of high absorption paper; and boric acid in an amount of, for example, from about 0.01% to about 0.5% by weight of the stucco, e.g., from about 0.05% to about 0.3% by weight of the stucco.

Clause 500. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 501. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 502. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 503. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 504. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 505. The method of any one of clauses 311-343, wherein the board comprises the back cover sheet in the form of high absorption paper; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 506. The method of any one of clauses 311-343, wherein the board comprises the back cover sheet in the form of high absorption paper; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 507. The method of any one of clauses 311-343, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 508. The method of any one of clauses 311-343, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 509. The method of any one of clauses 311-343, wherein the board comprises the back cover sheet in the form of high absorption paper; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 510. The method of any one of clauses 311-343, wherein the board comprises the back cover sheet in the form of high absorption paper; and at least one of the first slurry, the second slurry, and/or third slurry contains polyphosphate.

Clause 511. The method of any one of clauses 311-343, wherein the board comprises the back cover sheet in the form of high absorption paper; at least one of the first slurry, the second slurry, and/or third slurry contains polyphosphate; and at least one of the first slurry, the second slurry, and/or third slurry contains retarder.

Clause 512. The method of any one of clauses 311-343, wherein the board comprises the back cover sheet in the form of high absorption paper; and at least one of the first slurry, the second slurry, and/or third slurry contains retarder.

Clause 513. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 514. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 515. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 516. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 517. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 518. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 519. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 520. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 521. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 522. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 523. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 524. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 525. The method of any one of clauses 311-343, wherein the board comprises starch included between the set gypsum core and at least one of the cover sheets, preferably between at least the back cover sheet and the set gypsum core; (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 526. The method of any one of clauses 311-343, wherein the board comprises starch included between the set gypsum core and at least one of the cover sheets, preferably between at least the back cover sheet and the set gypsum core; and boric acid in an amount of, for example, from about 0.01% to about 0.5% by weight of the stucco, e.g., from about 0.05% to about 0.3% by weight of the stucco.

Clause 527. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 528. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 529. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 530. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 531. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 532. The method of any one of clauses 311-343, wherein the board comprises starch included between the set gypsum core and at least one of the cover sheets, preferably between at least the back cover sheet and the set gypsum core; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 533. The method of any one of clauses 311-343, wherein the board comprises starch included between the set gypsum core and at least one of the cover sheets, preferably between at least the back cover sheet and the set gypsum core; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 534. The method of any one of clauses 311-343, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 535. The method of any one of clauses 311-343, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 536. The method of any one of clauses 311-343, wherein the board comprises starch included between the set gypsum core and at least one of the cover sheets, preferably between at least the back cover sheet and the set gypsum core; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 537. The method of any one of clauses 311-343, wherein the board comprises starch included between the set gypsum core and at least one of the cover sheets, preferably between at least the back cover sheet and the set gypsum core; and at least one of the first slurry, the second slurry, and/or third slurry contains polyphosphate.

Clause 538. The method of any one of clauses 311-343, wherein the board comprises starch included between the set gypsum core and at least one of the cover sheets, preferably between at least the back cover sheet and the set gypsum core; at least one of the first slurry, the second slurry, and/or third slurry contains polyphosphate; and at least one of the first slurry, the second slurry, and/or third slurry contains retarder.

Clause 539. The method of any one of clauses 311-343, wherein the board comprises starch included between the set gypsum core and at least one of the cover sheets, preferably between at least the back cover sheet and the set gypsum core; and at least one of the first slurry, the second slurry, and/or third slurry contains retarder.

Clause 540. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and boric acid in an amount of, for example, from about 0.01% to about 0.5% by weight of the stucco, e.g., from about 0.05% to about 0.3% by weight of the stucco.

Clause 541. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 542. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 543. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 544. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 545. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 546. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 547. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 548. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 549. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 550. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 551. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains polyphosphate.

Clause 552. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; at least one of the first slurry, the second slurry, and/or third slurry contains polyphosphate; and at least one of the first slurry, the second slurry, and/or third slurry contains retarder.

Clause 553. The method of any one of clauses 311-343, wherein the board comprises (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different; and at least one of the first slurry, the second slurry, and/or third slurry contains retarder.

Clause 554. The method of any one of clauses 311-343, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, second slurry, and/or third slurry contains clay, e.g., kaolin clay, such as in an amount of from about 1 to about 10% by weight of the stucco, e.g., from about 1% to about 5% by weight of the stucco.

Clause 555. The method of any one of clauses 311-343, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 556. The method of any one of clauses 311-343, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 557. The method of any one of clauses 311-343, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, the second slurry, and/or third slurry contains polyphosphate.

Clause 558. The method of any one of clauses 311-343, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; at least one of the first slurry, the second slurry, and/or third slurry contains polyphosphate; and at least one of the first slurry, the second slurry, and/or third slurry contains retarder.

Clause 559. The method of any one of clauses 279-558, wherein at least one of the first slurry, second slurry, and/or third slurry comprises boric acid in an amount of, for example, from about 0.01% to about 0.5% by weight of the stucco, e.g., from about 0.05% to about 0.3% by weight of the stucco; and at least one of the first slurry, the second slurry, and/or third slurry contains retarder.

Clause 560. The method of any one of clauses 311-343, wherein at least one of the first slurry, second slurry, and/or third slurry comprises at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains polyphosphate.

Clause 561. The method of any one of clauses 311-343, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 562. The method of any one of clauses 311-343, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; at least one of the first slurry, the second slurry, and/or third slurry contains polyphosphate; and at least one of the first slurry, the second slurry, and/or third slurry contains retarder.

Clause 563. The method of any one of clauses 311-343, wherein at least one of the first slurry, second slurry, and/or third slurry contains clay, e.g., kaolin clay, such as in an amount of from about 1 to about 10% by weight of the stucco, e.g., from about 1% to about 5% by weight of the stucco; and at least one of the first slurry, the second slurry, and/or third slurry contains retarder.

Clause 564. The method of any one of clauses 311-343, wherein at least one of the first slurry, the second slurry, and/or third slurry contains polyphosphate; and at least one of the first slurry, the second slurry, and/or third slurry contains retarder.

Clause 565. A wall system comprising framing to which is attached at least one gypsum board of any of clauses 2-278, wherein the outer surface of the front cover sheet faces away from the framing.

Clause 566. A system for drying a board comprising; (a) a kiln containing at least one heat source and at least one in-kiln radio-frequency moisture sensor therein, (b) a controller outside of the kiln; and (c) an upstream radio-frequency moisture sensor and an upstream sensor that is less influenced by high salt concentration in the slurry as compared with the radio-frequency moisture sensor, the upstream dielectric and microwave sensors in communication with the controller to produce a first upstream moisture reading and a second upstream moisture reading, respectively.

Clause 567. The system of clause 566, further comprising a burner output and/or air extraction apparatus associated with the kiln, the burner output and/or air extraction apparatus in communication with the controller.

Clause 568. The system of clause 566 or 567, further comprising: (a) a downstream radio-frequency moisture sensor and a downstream sensor that is less influenced by high salt concentration in the slurry as compared with the radio-frequency moisture sensor, the downstream radio-frequency and microwave sensors in communication with the controller to produce a first downstream moisture reading and used to bias a second upstream moisture reading; wherein the (b) the burner output and/or air apparatus can be used to adjust the temperature in the kiln to reduce heating therein.

Clause 569. The system of any one of clauses 566-568, wherein at least one of the sensors that is less influenced by high salt concentration in the slurry as compared with the radio-frequency moisture sensor is a microwave sensor.

Clause 570. The system of any one of clauses 566-569, wherein at least one of the radio-frequency sensors produces a dielectric measurement of moisture dielectric sensor.

Clause 571. The system of any one of clauses 566-570, wherein the controller is a programmable logic controller.

Clause 572. The system of any one of clauses 566-571, wherein the kiln has one zone.

Clause 573. The system of any one of clauses 566-572, wherein the kiln has at least two zones.

Clause 574. The system of any one of clauses 566-573, wherein the kiln contains at least two in-kiln moisture sensors.

It shall be noted that the preceding clauses are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the invention but, of course, should not be construed as in any way limiting its scope.

### Example 1

Gypsum core (slurry) formulations with a high concentration of various salts were prepared as specified in Table 1. The source of chloride anions (samples 1A-1D) was sodium chloride (NaCl), magnesium chloride (MgCl₂) or calcium chloride (CaCl₂). Each of samples #1A-1D also contained sodium trimetaphosphate (TMP). To test the effects of TMP in insolation of the other salts, samples 1E and 1F only contained TMP.

TABLE 1

| | CORE | | | | | |
|---|---|---|---|---|---|---|
| | | | | | 30 ppm Cl | 30 ppm Cl |
| | | | | | (NaCl) | (NaCl)Non- |
| | 600 ppm Cl | 800 ppm Cl | 800 ppm Cl | 800 ppm Cl | Perforated | perforated |
| | (NaCl) | (NaCl) | (CaCl₂) | (MgCl₂) | paper | paper |
| | Sample ID | | | | | |
| | 1A | 1B | 1C | 1D | 1E | 1F |
| Thickness | ½″ | ½″ | ½″ | ½″ | ½″ | ½″ |
| Stucco (g) | 900 | 900 | 900 | 900 | 900 | 900 |
| HRA (g)¹ | 3.6 | 3.6 | 3.6 | 3.6 | 3.6 | 3.6 |
| cooked (also | 2.7 | 2.7 | 2.7 | 2.7 | 2.7 | 2.7 |
| known as pre- | | | | | | |
| gelled) corn | | | | | | |
| starch (g) | | | | | | |
| Fiberglass (g) | 2.5 | 2.5 | 2.5 | 2.5 | 2.5 | 2.5 |
| NaCl (g) | 0.89 | 1.19 | — | — | 0.045 | 0.045 |
| MgCl₂ (g) | — | — | — | 0.97 | — | — |
| CaCl₂ (g) | — | — | 1.18 | — | — | — |
| 10% Sodium | 5.4 | 5.4 | 5.4 | 5.4 | 32 | 44 |
| Trimetaphosphate | | | | | | |
| Solution² (g) | | | | | | |
| 1% Retarder² (g) | 9 | 9 | 9 | 9 | 9 | 9 |
| Dispersant (g) | 0.9 | 0.9 | 0.9 | 0.9 | 0.9 | 0.9 |
| Gauge water (g) | 836 | 836 | 836 | 836 | 836 | 836 |

¹HRA = heat resistant accelerator
²grams of solution, % is wt. %

For the perforated paper sheet tested in these Examples, the distance between adjacent perforations was ¼ inch. The diameter of the perforations was about 0.01 to 0.02 inch.

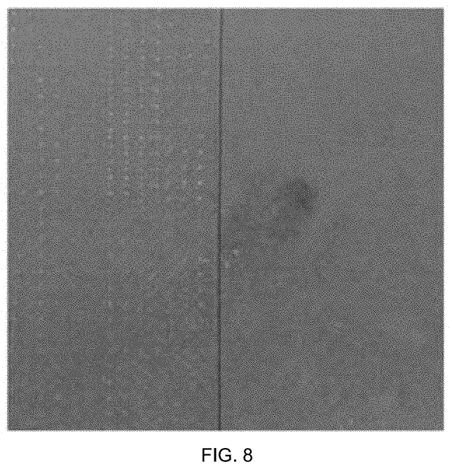

12 inch×12 inch×1 inch envelopes were made by using Manila paper (48#/MSF) as a front cover sheet and Newsline paper (42 lb/MSF) as a back cover sheet. Prior to pouring the slurry formulations (Table 1) into the envelope, half of the Newsline paper (6 inch×12 inch) was perforated using a wallboard perforator as shown in FIG. 8. The distance between adjacent perforations was ¼″. The diameter of the perforations was about 0.01 to 0.02 inch.

The slurry formulations (Table 1) were prepared by soaking dry powders in solution for 10 seconds and mixing for 10 seconds in a Hobart mixer, followed by injecting the resulting foam for 8 seconds and mixing another 2 seconds. The slurry thus obtained was poured into each of the envelopes. After the slurry had set and hardened, the envelope was sealed using a paper tape. The sealed board was dried at 450° F. for 20 minutes and then moved to a 350° F. oven. After drying at 350° F. for 15 minutes, the board was further dried at 110° F. overnight.

The effects of perforation of the back cover sheet were evaluated by an “X” cut method to test the paper-to-core bond. Several “X”-shaped cuts were made on the back paper of the finished wallboard samples, at least two “X”-shaped cuts being made in the perforated section of the back paper and at least two “X”-shaped cuts being made in the unperforated section (FIG. 8). The size of the “X”-shaped cut was about 2 inches×2 inches. The paper was peeled from the center of the cut. The samples were evaluated qualitatively in comparison to one another by evaluating the amount of paper remaining on the gypsum core on one side of the back paper versus to the other (i.e., perforated versus unperforated sections). If there is good adhesion to the gypsum core, a thin layer of paper remains on the core. In contrast, if there is poor adhesion to the core, the paper peels off from the core and leaves more of the core exposed.

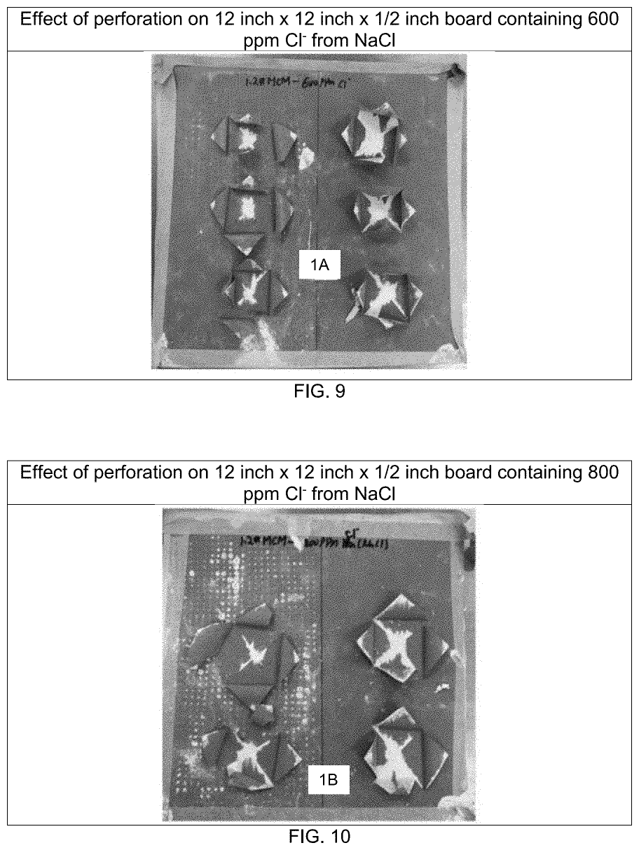

FIGS. 9-13 show photographs demonstrating the effect of various salts upon adhesion within gypsum boards of the invention having and lacking perforation within the back cover sheet.

FIGS. 9-12 respectively show photographs of sample boards 1A-1D.

FIG. 9 shows the effect of perforation on 12 inch×12 inch×½ inch sample board 1A containing 600 ppm Cl⁻ from NaCl.

FIG. 10 shows the effect of perforation on 12 inch×12 inch×½ inch sample board 1B containing 800 ppm Cl⁻ from NaCl.

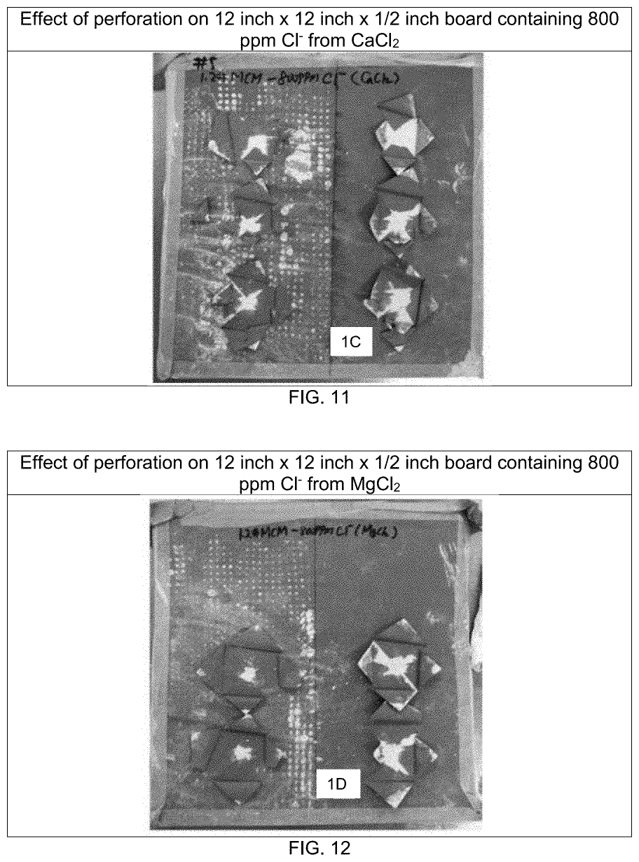

FIG. 11 shows the effect of perforation on 12 inch×12 inch×½ inch sample board 1C containing 800 ppm Cl⁻ from CaCl₂.

FIG. 12 shows the effect of perforation on 12 inch×12 inch×½ inch sample board 1D containing 800 ppm Cl⁻ from MgCl₂.

FIGS. 9-12 show for sample boards 1A-1D less paper separation occurred in the perforated section of the back cover sheet compared to the unperforated section. Less exposed gypsum was present in the perforated section due to having less paper separation. Thus, improved board core layer adhesion was realized in the perforated section of the back cover sheet at each concentration of all salts tested.

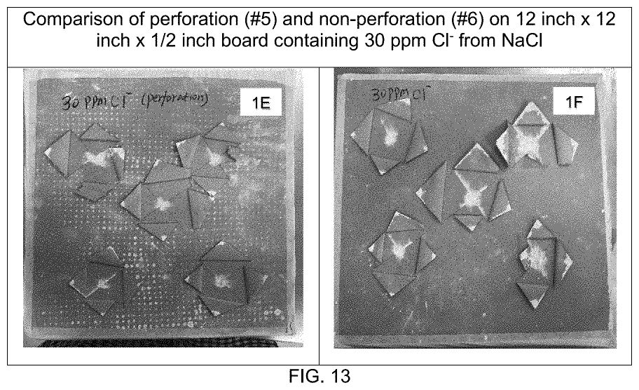

FIG. 13 shows the effect of perforation and non-perforation on 12 inch×12 inch×½ inch board having a gypsum core made from stucco containing 30 ppm Cl⁻ from NaCl per million parts calcium sulfate hemihydrate. This stucco represents conventional low chloride salt stucco. FIG. 13 experimental sample board 1E used a cover sheet having perforations. FIG. 13 control sample board 1F used a cover sheet having no perforations.

Comparing FIG. 13 experimental sample board 1E and FIG. 13 Sample Board 1F shows when low chloride was used the perforations did not improve adhesion as much as for high chloride samples.

### Example 2

Gypsum core (slurry) formulations with a high chloride concentration in the form of NaCl or MgCl₂ were prepared as specified in Table 2. Samples indicated as containing MgCl₂ or NaCl plus starch refer to testing of those samples with a starch layer upon the back paper cover sheet (see Table 3 below). Thus, the board cores defined by Samples 1A and 2B are compositionally identical to one another, as are Samples 2C and 2D. All of the gypsum core formulations contained a small amount of cooked corn starch.

TABLE 2
Gypsum core formulations

| | CORE | | | | | |
|---|---|---|---|---|---|---|
| | 1200 ppm | 1200 ppm | 2100 ppm | 2100 ppm | 2000 ppm | 30 ppm |
| | Cl⁻ from | Cl⁻ from | Cl⁻ from | Cl⁻ from | Cl⁻ from | Cl from |
| | MgCl₂ | MgCl₂ + starch | NaCl | NaCl + starch | NaCl | NaCl |
| | Sample ID | | | | | |
| | | | | | 2E (no starch + | |
| | | | | | perforation); | |
| | | | | | 2F (with starch + | 2G (no starch); |
| | 2A | 2B | 2C | 2D | perforation) | 2H (with starch) |
| Thickness | ½″ | ½″ | ½″ | ½″ | ½″ | ½″ |
| Stucco (g) | 900 | 900 | 900 | 900 | 900 | 900 |
| (calcium sulfate | | | | | | |
| hemihydrate) | | | | | | |
| HRA (g)¹ | 3.6 | 3.6 | 3.6 | 3.6 | 3.6 | 3.6 |
| cooked (also | 2.7 | 2.7 | 2.7 | 2.7 | 2.7 | 2.7 |
| known as pre- | | | | | | |
| gelled) corn | | | | | | |
| starch (g) | | | | | | |
| Fiberglass (g) | 2.5 | 2.5 | 2.5 | 2.5 | 2.5 | 2.5 |
| NaCl (g) | — | — | 3.46 | 3.46 | 3.30 | 0.049 |
| MgCl₂ (g) | 1.45 | 1.45 | — | — | — | — |
| 10% Sodium | 5.4 | 5.4 | 5.4 | 5.4 | 5.4 | 5.4 |
| Trimetaphosphate | | | | | | |
| Solution (g)² | | | | | | |
| 1% Retarder (g)² | 25 | 25 | 25 | 25 | 25 | 25 |
| Gauge water (g) | 861 | 861 | 861 | 861 | 861 | 861 |

¹HRA = heat resistant accelerator
²grams of solution, % is wt. %

12 inch×12 inch×½ inch envelopes were made by using Manila paper (46 pounds/MSF) as a front paper cover sheet and Newsline paper (40 pounds/MSF) as a back cover sheet. Prior to pouring the slurry formulations (Table 2) into the envelope, diluted starch solutions (Table 3) were brushed onto the core (inner) side of the back paper cover sheet used for Samples 2B and 2D.

TABLE 2
diluted starch concentration and usage

| Sample ID | 2A | 2B | 2C | 2D | 2E | 2F | 2G | 2H |
|---|---|---|---|---|---|---|---|---|
| Back paper | No | 4% uncooked | No | 8% uncooked | No | 5% uncooked | No | 5% uncooked |
| treatment | starch | starch + 4% | starch | starch | starch | starch on | starch | starch |
| solution | | cooked (also known | | | | perforated | | |
| | | as pre-gelled) | | | | back paper | | |
| | | corn starch | | | | | | |
| Change | 0 | 10 | 0 | 10 | 0 | 10 | 0 | 10 |
| in paper | | | | | | | | |
| weight (g) | | | | | | | | |
| Dry starch | 0 | 0.9 lbs uncooked | 0 | 1.8 lbs uncooked | 0 | 1.1 lbs uncooked | 0 | 1.1 lbs uncooked |
| weight | | starch + 0.9 lbs | | starch | | starch | | starch |
| (lbs/MSF) | | cooked (also known | | | | | | |
| | | as pre-gelled) | | | | | | |
| | | corn starch | | | | | | |

The slurry formulations (Table 2) were prepared by soaking dry powders in solution for 10 seconds and mixing for 10 seconds in a Hobart mixer, followed by injecting the resulting foam for 4.5 seconds and mixing another 2 seconds. The slurry thus obtained was poured into each of the envelopes. After the slurry had set and hardened, the envelope was sealed using a paper tape. The sealed board was dried at 450° F. for 20 minutes and then moved to a 350° F. oven. After drying at 350° F. for 15 minutes, the board was further dried at 110° F. overnight.

The effects of the starch treatment were evaluated by an “X” cut method to test the paper-to-core bond. Several “X”-shaped cuts were made on the back paper of the finished wallboard samples. The size of the “X”-shaped cut was about 2 inches×2 inches. The paper was peeled from the center of the cut. The samples were evaluated qualitatively in comparison to one another by evaluating the amount of paper remaining on the gypsum core of the wallboard following peeling. If there is good adhesion to the gypsum core, a thin layer of paper remains on the core. In contrast, if there is poor adhesion to the core, the paper peels off from the core and leaves more of the core exposed.

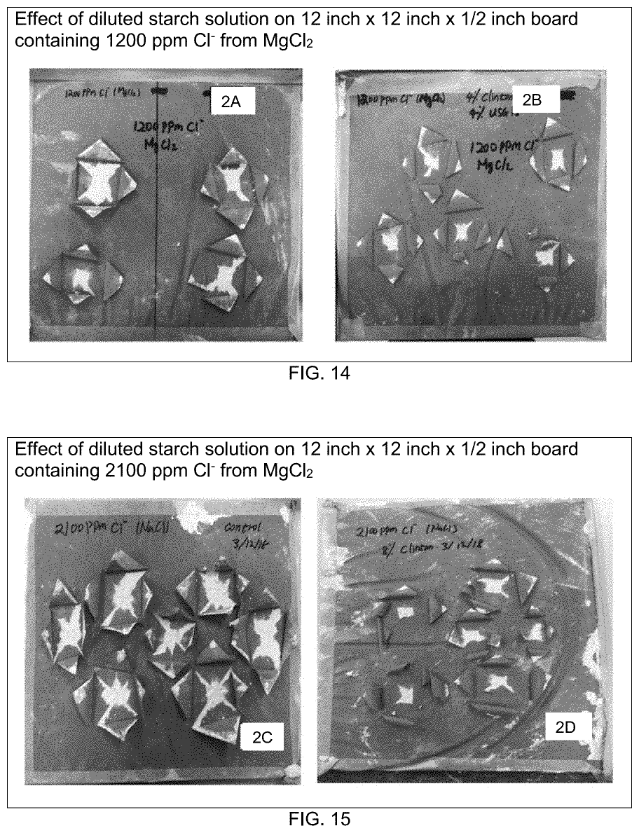

FIG. 14 shows photographs showing the effect of diluted starch solution on 12 inch×12 inch×½ inch board containing 1200 ppm Cl⁻ from MgCl₂ per million parts calcium sulfate hemihydrate. Control sample board 2A did not have a starch layer between its paper cover sheet and its gypsum core. Experimental sample board 2B had a starch layer between its paper cover sheet and its gypsum core.

FIG. 15 shows photographs showing the effect of diluted starch solution on 12 inch×12 inch×½ inch board containing 2100 ppm Cl⁻ from MgCl₂ per million parts calcium sulfate hemihydrate. Control sample board 2C did not have a starch layer between its paper cover sheet and its gypsum core. Experimental sample board 2D had a starch layer between its paper cover sheet and its gypsum core.

Comparing FIG. 14 sample boards 2A and 2B against one another, experimental sample board 2B with a starch layer had a smaller area of exposed gypsum at each “X” cut than did control sample board 2A lacking the starch layer. This indicates the starch layer significantly improved adhesion of the paper cover sheet to the gypsum core layer made from an aqueous gypsum slurry containing 1200 ppm Cl⁻ anion.

Similarly, comparing FIG. 15 samples 2C and 2D against one another, experimental sample board 2E with a starch layer had a smaller area of exposed gypsum at each “X” cut than did control sample board 2B lacking the starch layer. This indicates the starch layer significantly improved adhesion of the paper cover sheet to the gypsum core layer made from an aqueous gypsum slurry containing 2100 ppm Cl⁻ anion.

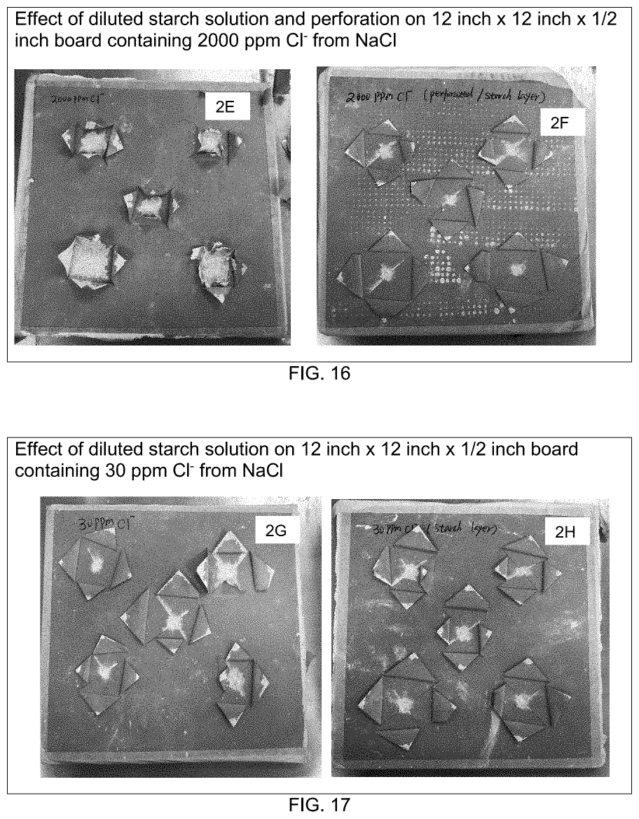

FIG. 16 shows photographs showing the effect of diluted starch solution of the same uncooked starch as used in the above examples and, in addition, perforations on 12 inch×12 inch×½ inch gypsum board having a gypsum core made from stucco containing 2000 ppm Cl⁻ from NaCl per million parts calcium sulfate hemihydrate. FIG. 16 compared a control sample board 2E with experimental sample board 2F of the present invention. The control board 2E had a back paper cover sheet having no perforations and no starch layer between the back paper cover sheet and gypsum core. The experimental sample board 2F of the present invention had a perforated paper cover sheet and a starch layer between the back paper cover sheet and gypsum core. For this perforated paper sheet, the distance between adjacent perforations was ¼ inch. The diameter of the perforations was about 0.01 to 0.02 inch.

On comparing sample boards 2E and 2F of FIG. 16 when the chloride anion is 2000 ppm, experimental sample board 2F with a starch layer and perforation treatment had a smaller area of exposed gypsum. Thus, the experimental sample board 2F had better adhesion than the control sample board 2E.

Also, comparing the experimental sample board 2F of FIG. 16 to the experimental sample board 2B of FIG. 15 with the same starch layer but no perforations showed the perforations further improved adhesion.

FIG. 17 shows photographs showing the effect of using diluted starch solution on 12 inch×12 inch×½ inch gypsum board having a gypsum core made from stucco containing 30 ppm Cl⁻ from NaCl per million parts calcium sulfate hemihydrate. This stucco represents conventional low chloride salt stucco. The diluted starch solution was the same as in the sample boards of FIG. 16. FIG. 17 shows a control sample board 2G with a back paper cover sheet having no starch layer between the back paper cover sheet and gypsum core. FIG. 17 also shows an experimental sample board 2H having a starch layer between the back paper cover sheet and gypsum core.

On comparing control sample board 2G and experimental sample board 2F when the chloride anion is 30 ppm, the exposed area of control board 2G is similar to that of experimental board 2F. This indicates the starch layer did not significantly improve the paper-to-core bond for these samples where low levels of chloride salts were present.

### Example 3

This example demonstrates the effect of the presence of starch in a gypsum layer on the bond between a cover sheet and the gypsum layer in gypsum wallboard prepared using a stucco slurry containing a high salt content.

Sixteen gypsum wallboard samples having the dimensions of 12 inches×12 inches were prepared in accordance with the formulations set forth in Tables 3-6. The thickness of the sample boards was ½ inch. Control boards (without high salt content in the stucco slurry) were used as comparatives. Boards prepared from high salt (chloride) stucco were tested both with and without starch in the gypsum layer. The source of the chloride anion (Cl⁻) is one of sodium chloride (NaCl), magnesium chloride (MgCl₂), and calcium chloride (CaCl₂), as identified in the tables.

In the tables, “HRA” is heat resistant accelerator. “Pregelatinized starch” refers to a pregelatinized corn flour starch with a cold water viscosity of 90 centipoise. “Uncooked starch” refers to an uncooked acid-modified corn starch having a hot water viscosity of 180 BU. “Migrating starch” refers to a small chain starch, LC211, commercially available from ADM. All amounts are in grams unless otherwise indicated.

TABLE 3
Formulation for gypsum layer (with NaCl)

| | | Board |
|---|---|---|
| | Board | Sample 3B |
| Ingredients | Sample 3A | (Control- 10 lb |
| (g) | (Control) | Uncooked Starch) |
| Stucco | 900 | 900 |
| HRA | 3.6 | 3.6 |
| Pregelatinized | 2.7 | 2.7 |
| Starch | | |
| Uncooked | — | 9 |
| Starch | | |
| Fiberglass | 2.5 | 2.5 |
| NaCl | 0 | 0 |

TABLE 4
Formulation for gypsum layer (with NaCl)

| | | | Board |
|---|---|---|---|
| | | Board | Sample 4C |
| | Board | Sample 4B | (2000 ppm |
| Ingredients | Sample 4A | (2000 ppm | NaCl- 20 lb |
| (g) | (Control) | NaCl) | Uncooked Starch) |
| Stucco | 900 | 900 | 900 |
| HRA | 3.6 | 3.6 | 3.6 |
| Pregelatinized | 2.7 | 2.7 | 2.7 |
| Starch | | | |
| Uncooked | — | — | 18 |
| Starch | | | |
| Fiberglass | 2.5 | 2.5 | 2.5 |
| NaCl | 0 | 3.3 | 3.3 |

TABLE 5
Formulation for gypsum layer (with NaCl (salt));
Uncooked Starch vs. Migrating Starch (LC211))

| | | | Board | Board | Board |
|---|---|---|---|---|---|
| | Board | Board | Sample 5C | Sample 5D | Sample 5E |
| | Sample 5A | Sample 5B | (600 ppm | (600 ppm | (600 ppm |
| Ingredients | (0 ppm | (600 ppm | NaCl- 10 lb | NaCl- 20 lb | NaCl- 20 lb |
| (g) | NaCl) | NaCl) | Uncooked Starch) | Uncooked Starch) | Migrating Starch) |
| Stucco | 800 | 800 | 800 | 800 | 800 |
| HRA | 11 | 11 | 11 | 11 | 11 |
| Pregelatinized | 5.5 | 5.5 | 5.5 | 5.5 | 5.5 |
| Starch | | | | | |
| Uncooked | — | — | 8 | 16 | — |
| Starch | | | | | |
| Migrating | — | — | — | — | 16 |
| Starch (LC211) | | | | | |
| NaCl | — | 0.79 | 0.79 | 0.79 | 0.79 |

TABLE 6
Formulation for gypsum layer (NaCl vs MgC1₂ vs CaC1₂)

| | | Sample | | Sample | | Sample |
|---|---|---|---|---|---|---|
| | Sample | Board 6B | Sample | Board 6D | Sample | Board 6F |
| | Board 6A | (NaCl- | Board 6C | (CaC1₂- | Board 6E | (MgCl₂- |
| Ingredients | (NaCl- | 1500 ppm- 10 lb | (CaC1₂- | 800 ppm- 10 lb | (MgC1₂- | 3000 ppm- 20 lb |
| (g) | 1500 ppm) | Uncooked | 800 ppm) | Migrating Starch) | 3000 ppm) | Migrating Starch) |
| Stucco | 800 | 800 | 800 | 800 | 800 | 800 |
| HRA | 11 | 11 | 11 | 11 | 11 | 11 |
| Pregelatinized | 5.5 | 5.5 | 5.5 | 5.5 | 5.5 | 5.5 |
| Starch | | | | | | |
| Uncooked | 0 | 8 | — | — | — | — |
| Starch | | | | | | |
| Migrating | — | — | 0 | 8 | 0 | 16 |
| Starch (LC211) | | | | | | |
| CaCl₂•2H₂0 | — | — | 1.33 | 1.33 | — | — |
| MgC1₂ | — | — | — | — | 3.23 | 3.23 |
| NaCl | 1.99 | 1.99 | — | — | — | — |

12 inches×12 inches×½ inch envelopes were made by using Manila paper (46 lb/msf) as a face paper and Newsline paper (40 lb/msf) as a back paper. The slurry was prepared by soaking dry powders in the solution for 10 seconds and mixing for 10 seconds in a Hobart mixer, followed by injecting the foam for 5.5 seconds and mixing another 2 seconds. The slurry was poured into the 12 inches×12 inches×½ inch envelopes. After the slurry was set and hardened, the envelope was sealed by using a paper tape. The sealed board was dried at 450° F. for 15 minutes, then moved to 350° F. oven. After being dried at 350° F. for 20 minutes, the board was further dried at 110° F. for 16 hours.

The dried 12 inches×12 inches×½ inch boards were cut into 4 of 6 inches×5 inches×½ inch small pieces (the 5 inches being in the production line direction). A one eight inch-deep straight score was made in the face surface of the board sample 2.5 inch from and parallel to one of the 6 inch edges. The boards were then conditioned at 75° F. with 50% relative humidity (RH) for 24 hours, then placed in a room at 90° F. with 90% relative humidity (RH). The humidified bonds were tested after 3 hours and 16 hours, respectively according to the humidified board test as follows.

The humidified board was snapped along the score without breaking or stressing the paper on the back side of the board, and the larger (2.5 inch×6 inch) piece of the board sample was then rotated and forced downward with its face surface up, in an attempt to force the back paper on the back side of the board to peel away from the larger pieces. The force was increased until the two board pieces came completely apart. The back surface of the larger piece was then examined to determine the percentage of the surface of the back paper that had pulled completely away from the core (referred to as “% failure”).

For Samples 4A, 4B, and 4C, the wet bonds were measured. After the casted boards were dried at 450° F. for 15 minutes, the boards were cut into 4 of 6 inches×5 inches×½ inch small pieces. The wet bond of two of 6 inches×5 inches×½ inch small pieces were immediately measured, and the other two were further dried at 350° F. for 20 minutes and at 110° F. for 16 hours.

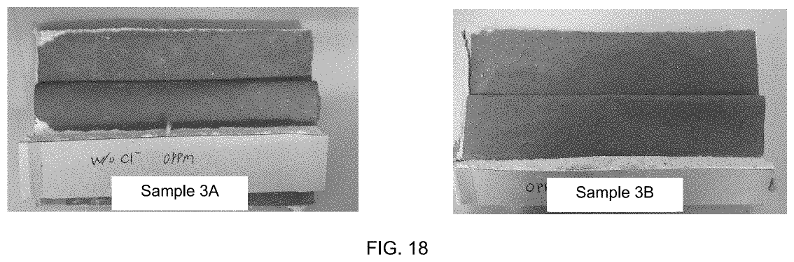

Table 7 shows the three hour humidified bond from Samples 3A and 3B. FIG. 18 are images showing the bonds after the test. As seen in FIG. 18, Samples 3A and 3B show good paper-to-gypsum layer bond, with no paper peeling observed, while Sample 3B had a higher humidified bond (18.6 lbs) than the Control Sample 3A (13.1 lbs), as shown in Table 7.

TABLE 7
Three Hour 90/90 Humidified Bond

| Board Sample | 3A | 3B |
|---|---|---|
| Load (lbs) - Back side | 13.1 | 18.6 |
| Failure (%) - Back side | 0 | 0 |

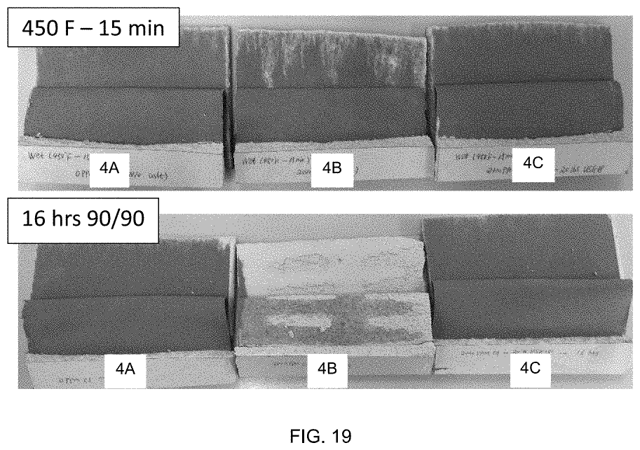

Tables 8A and 8B set forth the wet bond and 16 hour humidified bond results for Samples 4A, 4B, and 4C. FIG. 19 includes images showing the boards after the wet bond and 16 hour humidified bond tests. Sample 4B exhibited a poor wet bond and 16 hour humidified bonds due to a high concentration of the salt (2000 ppm Cl). Sample 4C exhibited a higher wet bond and 16 hour humidified bond as compared with Sample 4B, indicating that the addition of uncooked starch improved the bond between the paper and the gypsum layer. As seen in FIG. 19, no paper peeling is observed in Sample 4A and 4C, but 50% of paper failure is found in Sample 4B.

TABLE 8A
Wet Bond

| Sample Board | 4A | 4B | 4C |
|---|---|---|---|
| Load (lbs) - Back side | 5.2 | 4.6 | 9 |
| Failure (%) - Back side | 0 | 50 | 0 |

TABLE 8B
16 Hour 90/90 Humidified Bond

| Sample Board | 4A | 4B | 4C |
|---|---|---|---|
| Load (lbs) - Back side | 9.4 | 7.4 | 9.8 |
| Failure (%) - Back side | 0 | 100 | 0 |

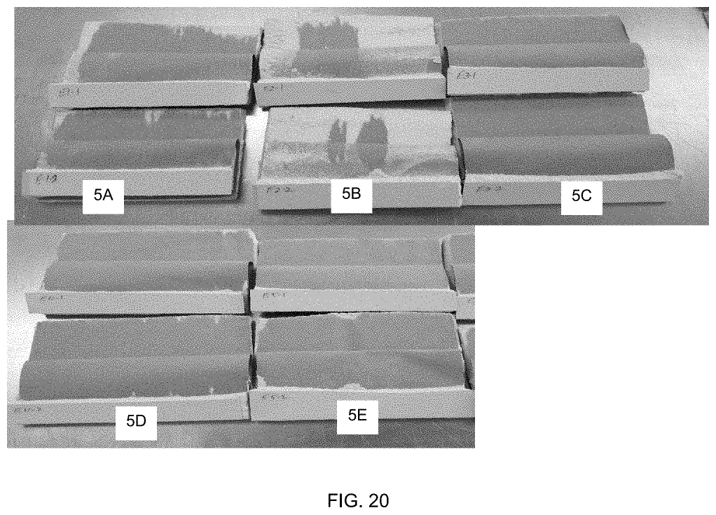

Table 9 shows the effect of different starch (uncooked starch vs migrating starch) on three hour humidified bonds from Samples 5A, 5B, 5C, 5D, and 5E. FIG. 20 includes images showing the boards after three hour humidified bond tests. Sample 5B demonstrated a poor three hour humidified bond due to a high concentration of salt (600 ppm Cl). Samples 5C, 5D, and 5E exhibited good bonding between the paper and the gypsum layer, indicating that the addition of either uncooked starch or migrating starch is able to improve the bond between paper and gypsum layer. As seen in FIG. 20, no paper peeling is observed from Samples 5A, 5C, 5D and 5E, while poor paper peeling is observed in Sample 5B.

TABLE 9
Three Hour 90/90 Humidified Bond

| Board Sample | 5A | 5B | 5C | 5D | 5E |
|---|---|---|---|---|---|
| Load (lbs) - Back side | 13.1 | 7.4 | 18.3 | 18.2 | 14.9 |
| Failure (%) - Back side | 0 | 70 | 0 | 0 | 5 |

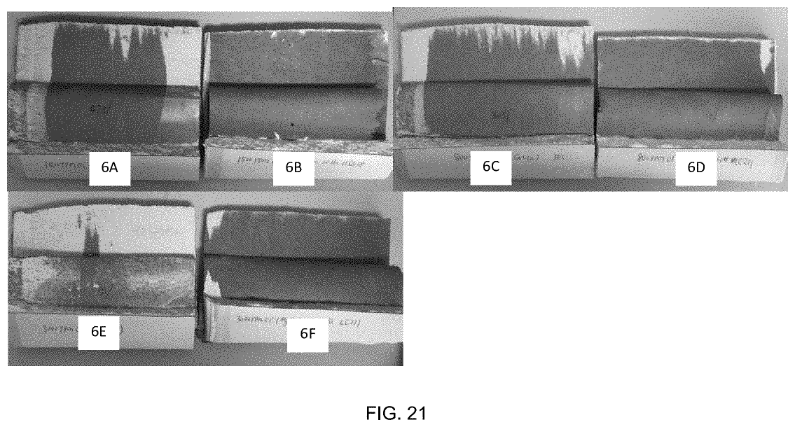

Table 10 shows the effect of different salts on three hour humidified bonds in Samples 6A, 6B, 6C, 6D, 6E, and 6F. FIG. 21 includes images illustrating the bonds after three hour humidified bond tests. Samples 6A, 6C, and 6E showed poor three hour humidified bonds due to the existence of different salts, NaCl, CaCl₂ and MgCl₂. Samples 6B, 6D, and 6F showed good bonds, indicating that the addition of either uncooked starch or migrating starch greatly improved the bond between paper and the gypsum layer. As seen in FIG. 21, by adding starch in Sample 6B, 6D and 6F, no obvious paper peeling is observed. However, Samples 6A, 6C and 6D show poor paper peeling.

TABLE 10
Three Hour 90/90 Humidified Bond

| Board Sample | 6A | 6B | 6C | 6D | 6E | 6F |
|---|---|---|---|---|---|---|
| Load (lbs) - Back side | 7.9 | 13.4 | 6.1 | 11.3 | 5.6 | 12.2 |
| Failure (%) - Back side | 47.5 | 0 | 32.5 | 5 | 95 | 5 |

In various embodiments, the starch can be native starch, pregelatinized starch, or the combination of native and pregelatinized starch. In some embodiments, it is preferable to add the starch in the top skim coat layer, and/or the bottom skim coat layer. However, the starch can be added into the core as well.

### Example 4

This example demonstrates the effect of using high absorption paper as a cover sheet in a wallboard containing a set gypsum layer prepared from stucco containing a high content of salt impurities. The high absorption paper enhances the bond between the paper and the set gypsum core when the set gypsum layer is formed from a slurry containing a high concentration of salt.

In particular, three ½″ thick boards (7A-7C) were prepared on a wallboard manufacturing production line. The boards contained a set gypsum layer prepared according to the formulation of Table 11, sandwiched between face and back cover sheets. Board 7A was a control board such that the set gypsum core was prepared without any high salt impurities. The set gypsum cores of Boards 7B and 7C, respectively, were prepared with the introduction of 600 ppm of chloride ions, via addition of a mixture of sodium chloride and magnesium chloride into the formulation listed in Table 11. The amounts for the ingredients in Table 11 are provided in lb/MSF.

TABLE 11
Formulation for Set Gypsum Layer of Boards 7A-7C

| | Board 7A | | |
|---|---|---|---|
| Ingredient | (control) | Board 7B | Board 7C |
| Stucco | 961 | 961 | 961 |
| HRA | 13 | 13 | 13 |
| Pregelatinized | 15 | 15 | 15 |
| Starch | | | |
| Uncooked | 20 | 20 | 20 |
| Starch | | | |
| NaCl | 0 | 0.48 | 0.48 |
| MgCl₂•6H₂O | 0 | 0.83 | 0.83 |
| Dispersant | 0.3 | 0.3 | 0.3 |
| Retarder | 0.48 | 0.48 | 0.48 |
| 10% STMP | 10 | 10 | 10 |
| Foam weight | 3.7 | 3.7 | 3.7 |
| Water | 811 | 820 | 820 |

In Table 11, HRA refers to heat resistant accelerator. The pregelatinized starch is a pregelatinized corn flour starch with a cold water viscosity of 90 centipoise. The uncooked starch is an uncooked acid-modified corn starch having a hot water viscosity of 180 BU. The dispersant is naphthalenesulfonic acids. The retarder is pentasodium diethylenetriaminepentaacetate. STMP refers to sodium trimetaphosphate. The foam was prepared using HYONIC line (e.g., 25AS) of soap products from GEO Specialty Chemicals, Ambler, Pa. and Polystep B25, from Stepan Company, Northfield, Ill.

The face cover sheet (Manila) for each of boards 7A-7C was paper having a 50 lb basis weight, and were of conventional (regular) composition without a high absorption property. The back cover sheet (Newsline) for Comparative Board 7A and Board 7B was paper having a 47 lb basis weight of conventional composition, while the back cover sheet for Board 7C was a high absorption paper having a basis weight of 47 lb. Comparative Board 7A had a weight of 1307 lb/MSF, while Boards 7B and 7C had a weight of 1305 lb/MSF.

A test was conducted to determine the effect on the bond between each cover sheet and the set gypsum layer in the respective boards. After the boards came out of the kiln of the manufacturing line, they were cut into 5.5 inch×5.875 inch samples. A one eighth inch-deep straight score was made in the face surface of each board 1.0 inch from and parallel to one of the 5.875 inch edges, and each board was conditioned in a 75° F./50% relative humidity (“RH”) room overnight. The conditioned samples were then placed in a 90° F./90% RH room. A humidified bond test was conducted on both the face and back side of the boards after three hours, sixteen hours, and one week in a 90° F./90% RH room, respectively. The humidified boards were tested according to the humidified board test as follows.

The humidified board was snapped along the score without breaking or stressing the paper on the back side of the board, and the larger (4.5 inch×5.875 inch) piece of the board sample was then rotated and forced downward with its face surface up, in an attempt to force the back paper on the back side of the board to peel away from the larger pieces. The force was increased until the two board pieces came completely apart. A higher humidified bond load indicates a better bond between the paper-to-core. The back surface of the larger piece was then examined to determine the percentage of the surface of the back paper that had pulled completely away from the core (referred to as “% failure”).

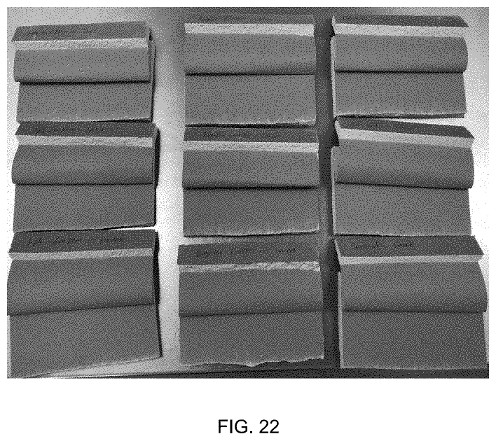

The face side of the boards from all three conditions showed a similar number of the humidified bond load and 0% of failure between the paper-to-core bond as shown in Table 12. FIG. 22 shows the pictures of all three conditions after the bond test. As seen in FIG. 22, a good bond between the paper-to-core was observed in each condition.

TABLE 12
Humidified Bond and Failure Percentage of Face
Side of Boards Under 90° F./90% RH Conditions

| | Three Hours | | Sixteen Hours | | One Week | |
|---|---|---|---|---|---|---|
| | Humid- | Fail- | Humid- | Fail- | Humid- | Fail- |
| | ified | ure | ified | ure | ified | ure |
| Board | Bond (lbs) | % | Bond (lbs) | % | Bond (lbs) | % |
| 7A | 19.5 | 0 | 16.6 | 0 | 15.4 | 0 |
| (control) | | | | | | |
| 7B | 22.8 | 0 | 16.6 | 0 | 15.9 | 0 |
| 7C | 18.9 | 0 | 16.4 | 0 | 15.2 | 0 |

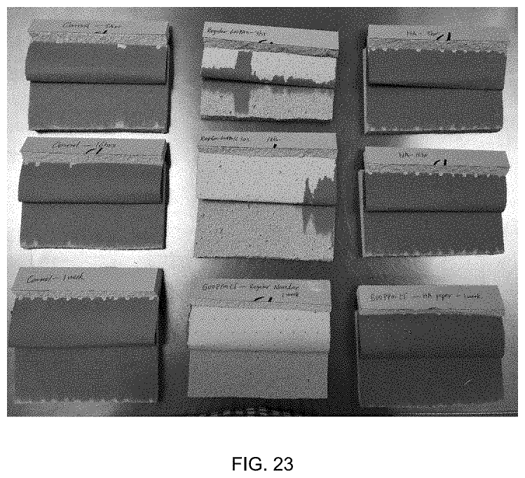

However, the humidified bond from the back side of the boards had different results as shown in Table 13. FIG. 23 shows pictures of all three conditions after the bond test. As seen in FIG. 23, conditioned Board 7B showed a poor bond between the paper-to-core, while conditioned Boards 7A and 7C showed good bond between the paper-to-core. Control Board 7A, without the addition of salt, had a high humidified bond load and 0% of failure between the regular back paper and the gypsum core. However, when 600 ppm of chloride was added into the gypsum slurry, Board 7B showed much lower humidified bond load and >60% failure between the regular Newsline back paper and the gypsum core.

TABLE 13
Humidified Bond and Failure Percentage of Back
Side of Boards Under 90° F./90% RH Conditions

| | Three Hours | | Sixteen Hours | | One Week | |
|---|---|---|---|---|---|---|
| | Humid- | Fail- | Humid- | Fail- | Humid- | Fail- |
| | ified | ure | ified | ure | ified | ure |
| Board | Bond (lbs) | (%) | Bond (lbs) | (%) | Bond (lbs) | (%) |
| 7A | 19 | 0 | 14.2 | 0 | 14.7 | 0 |
| (control) | | | | | | |
| 7B | 7.31 | 60% | 4.9 | 80% | 3.8 | 100% |
| 7C | 19.3 | 0 | 14.5 | 0 | 14.1 | 0 |

Unlike Board 7B, when high absorption paper was used as the back paper, Board 7C, which was formed from the same stucco slurry formulation as Board 7B, showed much higher humidified bond load and 0% failure between the paper-to-core bond. This indicates that high absorption paper increases the paper-to-core bond, in particular, when the wallboard contains high concentration of salt.

### Example 5

This example demonstrates the effect of high salt concentration on moisture sensor readings.

Samples resembling ½ inch wallboard were prepared in a laboratory environment. The samples contained a face paper, back paper and a gypsum slurry between the sheets. Different amounts of chlorides were used to make the slurries to assess the effect of high salt concentration. In particular, four conditions were represented, namely, 0 PPM chlorides, 300 PPM chlorides, 600 PPM chlorides, and 900 PPM chlorides.

All of the samples were dried to constant weight in a 110° F. oven, then were weighed with a precision scale to determine the bone dry weight. In addition, each sample was measured for moisture content using both a radio frequency based handheld sensor and a microwave based handheld sensor. Then all samples were conditioned in a 75° F./50% Relative humidity chamber for 24 hours and measured using the same radio frequency and microwave based sensors to determine the moisture content after conditioning. All samples were conditioned in a 90° F. and 90% relative humidity chamber for 24 hours and measured using the same radio frequency and microwave based sensors to determine the moisture content after conditioning at 90/90.

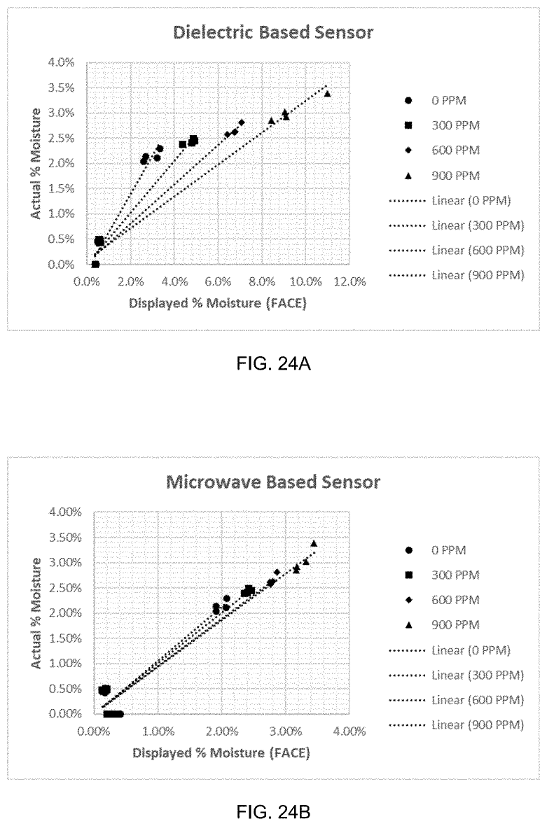

FIGS. 24A and 24B show use of the radio frequency dielectric based sensor results in increasing levels of error as the salt level in PPM increases. At the extreme 900 ppm level the dielectric readings range from approximately 8-11% moisture when actual moisture is only approximately 3%. The microwave based sensor is less influenced and roughly similar to the actual moisture reading. Moisture differences of as little as 1% could result in over-dried board, thereby decreasing bonding between the paper and gypsum core interfaces.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising a set gypsum core disposed between a face cover sheet and a back cover sheet, the set gypsum core formed from a slurry comprising water, stucco, and a high salt impurity content, the board comprising at least two of the following:
(a) perforations in the back cover sheet;
(b) the back cover sheet containing high absorption paper;
(c) starch included between the set gypsum core and at least one of the cover sheets; and
(d) (i) a back skim coat layer defining first and second skim coat faces, the back skim coat layer formed from a second slurry comprising water, stucco, and a skim coat starch, the first face of the back skim coat facing the back cover sheet and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

2. The board of claim 2, wherein the salt impurity comprises sodium chloride, potassium chloride, magnesium chloride, calcium chloride, or any combination thereof, and wherein the salt impurity comprises at least about 150 ppm chloride anion per 1,000,000 parts by weight of said stucco.

3. The board of one of claim 1, wherein at least one of the first slurry, the second slurry, and/or third slurry contains boric acid in an amount of from about 0.01% to about 0.5% by weight of the stucco.

4. The board of claim 1, wherein at least one of the first slurry, second slurry, and/or third slurry contains clay in an amount of from about 1 to about 10% by weight of the stucco.

5. The gypsum board of claim 1, wherein the back cover sheet is perforated and/or in the form of high absorption paper, and the board contains starch between the set gypsum core and the back cover sheet.

6. The gypsum board of claim 1, wherein the back cover sheet is perforated and/or in the form of high absorption paper, and the board contains (i) a back skim coat layer defining first and second skim coat faces, the back skim coat layer formed from a second slurry comprising water, stucco, and a skim coat starch, the first face of the back skim coat facing the back paper and the second face of the back skim coat facing the first core face, and (ii) a face skim coat layer defining first and second faces, the face skim coat layer formed from a third slurry comprising water, stucco, and optionally, the skim coat starch, the first face of the face skim coat layer facing a second face of the board core, and the second face of the face skim coat layer facing the face cover sheet, wherein the skim coat starch enhances the bond between the core and at least the back cover sheet, wherein the second and third slurries can be the same or different.

7. The board of claim 1, wherein the starch is included between the set gypsum core and the back cover sheet.

8. A method of making a gypsum board comprising:
(a) mixing at least water, stucco, and foam to form a first slurry;
(b) disposing the first slurry between a face cover sheet and a back cover sheet to form a board precursor;
(c) cutting the board precursor into a board;
(d) drying the board in a kiln containing at least one in-kiln radio-frequency moisture sensor therein, the in-kiln moisture sensor in communication with a controller outside of the kiln to produce an in-kiln moisture reading;
(e) measuring moisture content in the board upstream of the kiln using an upstream radio-frequency moisture sensor and an upstream sensor that is less influenced by high salt concentration in the slurry as compared with the radio-frequency moisture sensor, the upstream sensors in communication with the controller to produce a first upstream moisture reading and a second upstream moisture reading, respectively;
(f) correlating the moisture readings from the upstream radio-frequency moisture sensor and the upstream sensor that is less influenced by high salt concentration in the slurry as compared with the radio-frequency moisture sensor; and
(g) biasing the in-kiln radio-frequency moisture sensor when a delta exists between the first and second moisture readings to correct for any errors in the in-kiln moisture reading.

9. The method of claim 8, the kiln having a burner output and/or air extraction associated with it, the method further comprising:
(h) measuring moisture content in the board downstream of the kiln using a downstream radio-frequency moisture sensor and a downstream sensor that is less influenced by high salt concentration in the slurry as compared with the radio-frequency moisture sensor, the downstream radio-frequency and less influenced sensors in communication with the controller to produce a first downstream moisture reading and used to bias a second downstream moisture reading;
(i) correlating the moisture readings from the downstream radio-frequency moisture sensor and the downstream sensor that is less influenced by high salt concentration in the slurry as compared with the radio-frequency moisture sensor; and
(j) adjusting the burner output and/or air apparatus to adjust the temperature in the kiln to reduce heating therein.

10. The method of claim 8, further comprising set point controls for the burner output, temperature, and/or air flow in the kiln.

11. The method of claim 9, wherein at least one of the sensors that is less influenced by high salt concentration in the slurry as compared with the radio-frequency moisture sensor is a microwave sensor.

12. The method of claim 9, wherein the kiln has one zone.

13. The method of claim 9, wherein the kiln has at least two zones.

14. The method of claim 9, wherein the kiln contains at least two in-kiln moisture sensors.

15. The method of claim 9, wherein the salt impurity comprises sodium chloride, potassium chloride, magnesium chloride, calcium chloride, or any combination thereof, and wherein the salt impurity comprises at least about 150 ppm chloride anion per 1,000,000 parts by weight of said stucco.

16. A system for drying a board comprising;
(a) a kiln containing at least one heat source and at least one in-kiln radio-frequency moisture sensor therein,
(b) a controller outside of the kiln; and
(c) an upstream radio-frequency moisture sensor and an upstream sensor that is less influenced by high salt concentration in the slurry as compared with the radio-frequency moisture sensor, the upstream radio-frequency and less influenced sensors in communication with the controller to produce a first upstream moisture reading and a second upstream moisture reading, respectively.

17. The system of claim 16, further comprising a burner output and/or air extraction apparatus associated with the kiln, the burner output and/or air extraction apparatus in communication with the controller.

18. The system of claim 17, further comprising:
(d) a downstream radio-frequency moisture sensor and a downstream sensor that is less influenced by high salt concentration in the slurry as compared with the radio-frequency moisture sensor, the downstream radio-frequency and less influenced sensors in communication with the controller to produce a first downstream moisture reading and used to bias a second upstream moisture reading,
wherein the burner output and/or air apparatus can be used to selectively adjust the temperature in the kiln to reduce heating therein.

19. The system of claim 16, wherein at least one of the sensors that is less influenced by high salt concentration in the slurry as compared with the radio-frequency moisture sensor is a microwave sensor.

20. The system of claim 16, wherein the kiln contains at least two in-kiln moisture sensors.
